(19) United States
(12) Patent Application Publication
(10) Pub. No.: US 2009/0072647 A1
(43) Pub. Date: Mar. 19, 2009

(54) Electric Rotating Machine and Automobile Equipped with It

(75) Inventors: Noriaki HINO, Mito-shi (JP); Matahiro Komuro, Hitachi-shi (JP); Yuichi Satsu, Hitachi-shi (JP); Yutaka Matsunobu, Mito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/197,103

(22) Filed: Aug. 22, 2008

(30) Foreign Application Priority Data
Sep. 11, 2007 (JP) 2007-234864

(51) Int. Cl. H02K 21/14; H02K 7/116

(52) U.S. Cl. 310/156.15; 310/83; 903/906

(57) ABSTRACT

An electric rotating machine includes a stator having a stator core provided with a teeth unit and a coil wound around each tooth in the teeth unit in a concentrated fashion and a rotor rotatably supported with air gap against the teeth unit of the stator, the rotor having a rotor core and a plurality of permanent magnets held by the rotor core, wherein the permanent magnet is a rare earth magnet made of rare earth magnetic particles bound with SiO₂. Also disclosed is an automobile that includes the electric rotating machine in which the permanent magnet in the rotor is a rare earth magnet made of rare earth magnetic particles bound with SiO₂, and the stator in the electric rotating machine has a stator core provided with a teeth unit and a coil wound around each tooth in the teeth unit in a concentrated fashion.

### CROSS REFERENCE TO RELATED APPLICATIONS

This application contains related subject matter to Assignee's U.S. application Ser. No. 12/020,941, filed Jan. 28, 2008 and entitled “Rare Earth Magnet and Manufacturing Method Thereof”; and U.S. application Ser. No. 12/019,870, filed Jan. 25, 2008 and entitled “Treating Solution for Forming Fluoride Coating Film and Method for Forming Fluoride Coating Film”.

### INCORPORATION BY REFERENCE

The disclosure of the following priority application is herein incorporated by reference:

Japanese Patent Application No. 2007-234864 filed Sep. 11, 2007.

### BACKGROUND OF THE INVENTION

1. Field of the Invention

The present invention relates to an electric rotating machine and an automobile equipped with it.

2. Description of Related Art

Recently, development of a hybrid automobile in which the vehicle is driven by an engine and an electric rotating machine and an electric automobile in which the vehicle is driven by an electric rotating machine has been in progress in response to the request for the environmental protection and the like.

some of electric rotating machines used for driving/generating electric power of such automobiles use a permanent magnet for increasing efficiency. The characteristics of the permanent magnet have been considerably increased in recent years. A typical example of high performance permanent magnet is a sintered magnet produced by sintering a rare earth magnet material. The sintered magnet has excellent magnetic properties. However, to produce such a sintered magnet, a production step in which sintering is performed at high temperatures is necessary. This causes aggravation of productivity.

On the other hand, a so-called bond magnet produced by binding a magnet material with a thermosetting epoxy resin has been studied (see, for examples Patent Document 1 below). In the production of the bond magnet, no sintering step is required and it is possible to mold a more or less complicated shape. Since the epoxy resin has a low heat resistance, there has been a problem to be solved before it can be used in a high temperature environment such as in an electric rotating machine for driving an automobile.

Patent Document 1: Japanese Patent Laid-Open Application No. H11-238640.

### SUMMARY OF THE INVENTION

However, in the magnet that uses epoxy resin as a binding agent, the ratio of the epoxy resin material to the magnet material increases, and the proportion of the magnet material in the magnet decreases. Therefore, there has been a problem that the magnetic characteristics of the magnet worsen, and the characteristics of the electric rotating machine are remarkably decreased along with it.

On the other hand, the sintered magnet having a high energy density of the magnet has a high electroconductivity, so that it has a problem that there occurs eddy current when it rotates at high speeds and heat generated by the eddy current will demagnetize the magnet. In particular, when the stator has a concentrated winding structure, eddy current heat generation is remarkable.

Since an electric rotating machine for an automobile is required to be thin in the direction of its axis, the concentrated winding structure is suited therefor. However, in order to suppress eddy current upon rotation at high speeds, division of magnet is performed. This increases the production cost.

It is an object of the present invention to provide an electric rotating machine having good magnetic properties and an automobile equipped with it.

In the present invention, a magnet made of rare earth magnetic particles bound with SiO₂ is adopted as a magnet for use in a rotor of a concentrated winding electric rotating machine, which generates a large amount of heat due to eddy current.

For example, in an aspect, the present invention provides an electric rotating machine including: a stator having a stator core provided with a teeth unit and a coil wound around each tooth in the teeth unit in a concentrated fashion; and a rotor rotatably supported with air gap against the teeth unit of the stator, the rotor having a rotor core and a plurality of permanent magnets held by the rotor core wherein the permanent magnet is a rare earth magnet made of rare earth magnetic particles bound with SiO₂.

In another aspect, the present invention provides an automobile including an engine; an electric rotating machine having a stator and a rotor with a permanent magnet; a transmission that transmits rotating torque to an axle at a predetermined change gear ratio based on the engine and the electric rotating machine; a battery connected to the rotting electrical machine; and a power conversion system that converts power from the battery and transmits the converted power to the electric rotating machine, wherein the permanent magnet in the rotor is a rare earth magnet made of rare earth magnetic particles bound with SiO₂, and wherein the stator in the electric rotating machine has a stator core provided with a teeth unit and a coil wound around each tooth in the teeth unit in a concentrated fashion.

According to the present invention, an electric rotating machine having good magnetic properties and an automobile having mounted thereon such an electric rotating machine can be obtained.

### BRIEF DESCRIPTION OF THE DRAWINGS

FIGS. 1A to 1C are each a schematic configuration diagram showing a hybrid electric automobile according to an embodiment of the present invention which is equipped with a permanent magnet type electric rotating machine according to an embodiment of the present invention;

FIG. 2 is a circuit diagram of the power conversion system 600 shown in FIG. 1;

FIG. 3 is a cross-sectional view showing an electric rotating machine according to an embodiment of the present invention;

FIG. 4 is an outward appearance diagram showing a stator of a distributed winding structure;

FIG. 5 is a cross-sectional view showing the stator 230 and rotor 250 shown in FIG. 3 along the line A-A;

FIG. 6A is a schematic top view showing a bobbin of the concentrated winding stator shown in FIG. 3;

FIG. 6B is a cross-sectional view along the line A-A in FIG. 6A;

FIG. 7A illustrates how to wind a wire around the bobbin 236;

FIG. 7B is a schematic perspective view showing the configuration of the concentrated winding stator shown in FIG. 3;

FIG. 8 is a schematic diagram illustrating linkage of the concentrated winding stator shown in FIG. 3;

FIG. 9 is a schematic diagram illustrating winding of the concentrated winding distribution stator;

FIG. 10 is a diagram illustrating an example of a dual partitioned bobbin of the concentrated winding stator shown in FIG. 3;

FIG. 11 is a schematic diagram showing an example of the configuration of a concentrated partitioned stator core;

FIG. 12 is a schematic diagram illustrating how to fix and mold the concentrated winding stator;

FIG. 13 is a schematic diagram illustrating how to partition the concentrated winding stator;

FIG. 14 shows an example of the bobbin shown in FIG. 3;

FIG. 15A to 15F are each a cross-sectional view showing an electric rotating machine according to an embodiment of the present invention;

FIGS. 16A and 16B are each a graph showing harmonic components of magnetomotive force generated by the stator of a concentrated winding motor;

FIGS. 17A and 17B are each a graph showing harmonic components of magnetomotive force generated by the stator of a concentrated winding motor;

FIGS. 18A and 18B are each a graph showing harmonic components of magnetomotive force generated by the stator of a concentrated winding motor;

FIGS. 19A and 19B are each a graph showing harmonic components of magnetomotive force generated by the stator of a concentrated winding motor;

FIG. 20 is a schematic cross-sectional view showing an example of a motor for driving a hybrid vehicle incorporated in the rotor thereof a gear;

FIG. 21 is a block diagram showing a gear-incorporated driving mechanism;

FIG. 22 schematically shows a 20-pole 24-teech concentrated winding electric rotating machine;

FIG. 23 schematically shows a 10-pole 12-teech concentrated winding electric rotating machine;

FIG. 24 is a flowchart illustrating a process of fabricating a magnet without insulation film treatment;

FIG. 25 is a flowchart illustrating a process of fabricating a magnet with insulation film treatment;

FIG. 26A is a scanning electron micrograph showing a secondary electron image of a cross-section of a sample of a bond magnet sample fabricated as a binding agent by impregnation of SiO₂ and heat treatment of the magnet produced in the first embodiment;

FIG. 26B is a scanning electron micrograph showing an oxygen plane analysts image of a cross-section of a sample of a bond magnet sample fabricated as a binding agent by impregnation of SiO₂ and heat treatment of the magnet produced in the first embodiment;

FIG. 26C is a scanning electron micrograph showing a silicon plane analysis image of a cross-section of a sample of a bond magnet sample fabricated as a binding agent by impregnation of SiO₂ and heat treatment of the magnet produced in the first embodiment; and

FIG. 27 is a graph showing demagnetization curves plotting results of measurements of compression molded samples of 10 mm long, 10 mm wide, and 5 mm thick that were held in air at 225° C. for 1 hour and cooled and measured at 20° C. for SiO₂ precursor-impregnated bond magnet and a resin-containing bond magnet according to the present invention, with the magnetic field being applied in the direction of 10 mm, the magnets being first magnetized in a magnetic field of +20 kOe and then a positive magnetic field of +1 kOe to +10 kOe and a negative magnetic field of −1 kOe to −10 kOe being alternately applied.

### DETAILED DESCRIPTION OF THE INVENTION

Hereinafter, embodiments of the present invention are described with reference to the attached drawings.

A permanent magnet type electric rotating machine of an embodiment of the present invention includes a so-called concentrated winding stator, which has a stator core whose teeth are each wound by a conductor wire or coil in a concentrated fashion, and a rotor core having arranged therein permanent magnets made of magnetic particles bound with a SiO-based material.

The permanent magnet type electric rotating machine is produced by a method in which magnetic particles coated with an inorganic insulation film are pressure molded, the pressure molded article is infiltrated or impregnated with the SiO-based material to produce permanent magnets, and the permanent magnets thus produced are arranged in the rotor core.

An automobile equipped with the permanent type electric rotating machine includes a rotor that has arranged permanent magnets made of magnetic particles bound with a binding agent. The binding agent is prepared from its precursor that is constituted by a material having good wettability to the magnetic particles.

Therefore, respective particles of the magnetic powder are insulated with the SiO-based material and featured in that eddy current is difficult to flow therethrough. By using such a permanent magnet type electric rotating machine, a thin concentrated winding motor suitable for an automobile can be realized.

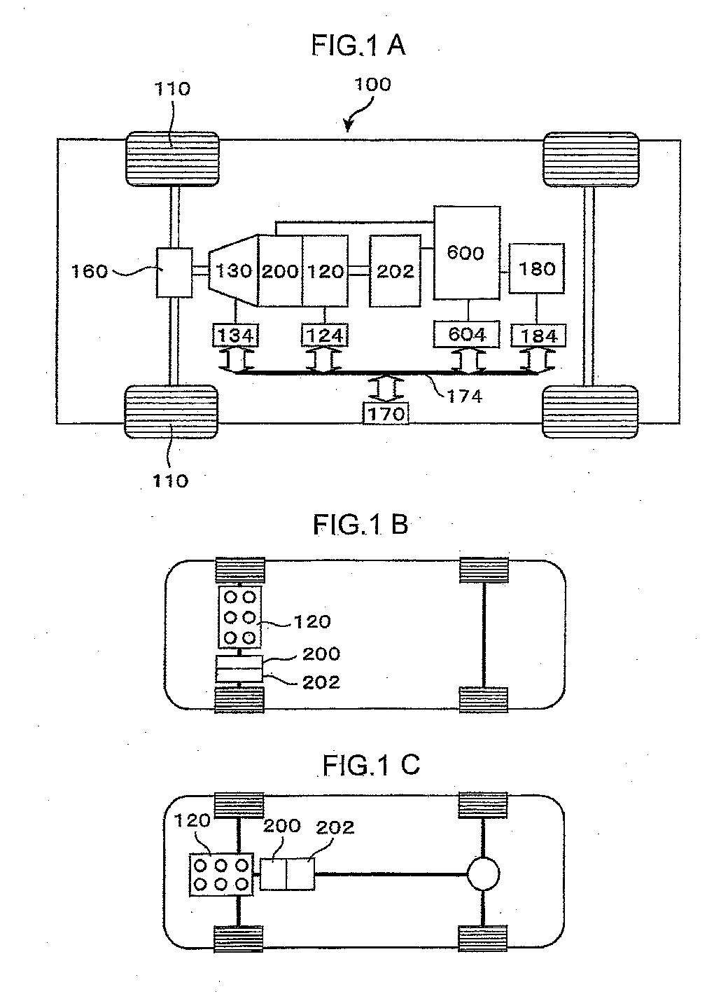

FIG. 1A is a configuration diagram showing a hybrid-excited electric automobile according to one embodiment of the present invention equipped with a permanent magnet type electric rotating machine of an example of the present invention. The electric rotating machine may be applied to a genuine electric automobile that is driven only by an electric rotating machine and to a hybrid-excited electric automobile driven by both an engine and an electric rotating machine. Hereinafter, a hybrid-excited electric automobile is described as a representative example.

A vehicle 100 includes an engine 120, a first electric rotating machine 200, a second electric rotating machine 202, and a battery 180 that supplies high voltage direct current to the first and second electric rotating machines 200 and 202 or receives high voltage direct current from the first and second electric rotating machines 200 and 202. In addition, the vehicle 100 includes a battery (not shown) that supplies low voltage power, i.e. 14V power to a control circuit described hereinbelow. Further, the vehicle 100 includes a power conversion system 600 that converts direct current from the battery 180 into alternating current and supplies it to the first and second electric rotating machines 200 and 202 and alternating current from the rotating machines 200 and 202 into direct current and supplies it to the battery 180.

Rotating torque afforded by the engine 120 and the first and second electric rotating machines 220 and 202 is transmitted to a transmission 130 and a differential gear 160 and then to front wheels 110.

A transmission control device 134 that controls the transmission 130, an engine control device 124 that controls the engine 120, a power conversion system control circuit 604 that controls the power conversion system 600, a battery control device 184 that controls a battery 180 such as a lithium ion battery, and an integration control device 170 are connected to each other through a communication line 174. Note that the power conversion system control circuit 604 may be built-in by the power conversion system 600.

The integration control device 170 receives information representing a state of each of control devices of a lower rank than or subordinate to the integration control device 170, i.e., the transmission control device 134, the engine control device 124, the power conversion system control circuit 604 (or the power conversion system 600), and the battery control device 184 through the communication line 174. Based on the various pieces of information thus received, the integration control device 170 calculates control demands for the respective control devices and transmits the calculated demands to the respective control devices through the communication line 174.

For example, the battery control device 184 outputs a discharge state of the battery 180, which is a lithium ion battery, and respective states of unit cell batteries that constitute the lithium ion battery as a state of the battery 180 to the integration control device 170 through the communication line 174.

The integration control device 170 sends an instruction to perform power generation operation to the power conversion system 600 when it is determined based on the output from the battery control device 184 that charging of the batter 180 is necessary. The integration control device 170 also controls output torques of the engine 120 and the first and second electric rotating machines 200 and 202, calculates a total torque of the output torques of the engine 120 and the first and second electric rotating machines 200 and 202 as well as a torque distribution ratio, and transmits the control commands according to the results of the calculation to the transmission control device 134, the engine control device 124, and the power conversion system 600. The power conversion system 600 transmits the torque commands to the power conversion system 600, which then controls the first and second electric rotating machines 200 and 202, so that either one of the electric rotating machines or both the electric rotating machines generate the commanded torque output or generated output.

The power conversion system 600 controls switching actions of power semiconductors that constitute an inverter for operating the first and second rotating machines 200 and 202 according to the commands from the integration control device 170. Based on the switching actions of the power semiconductors, the first electric rotating machine 200 and the second electric rotating machine 202 are operated as motors or generators.

When the first or second electric rotating machines 200 or 202 is used as a motor, direct current power is supplied from the high voltage battery 180 to a direct current terminal of an inverter of the power conversion system 600. Switching actions of the power semiconductors that constitute the inverter are controlled to convert the supplied direct current power into three-phase alternating current power, which is supplied to the first or second electric rotating machines 200 or 202. On the other hand, when the first or second electric rotating machine 200 or 202 is used as a generator, the rotor of the first or second electric rotating machines 200 or 202 is rotated by rotating torque applied from outside and three-phase alternating current is generated in the winding of the stator of the electric rotating machine based on the rotation torque. The generated three-phase alternating current power is converted into direct current power by the power conversion system 600. The direct current power is supplied to the battery 180 to recharge it.

The power conversion system 600 includes a plurality of smoothing capacitor modules for suppressing variation of voltage of a direct current power source, a power module having built-in a plurality of power semiconductors, and an electric rotating machine control circuit provided with a switching control circuit that controls switching actions of the power module and a circuit that generates a signal determining a time width of the switching actions, i.e., PWM signal for controlling pulse wide modulation.

The high voltage battery 180 is a secondary battery such as a lithium ion battery or a nickel hydride battery. Direct current power of high voltage, e.g., 250 V to 600 V, is charged to or output from the secondary battery.

FIG. 1B is shows positions of a transverse-mounted engine, an engine of a hybrid system for driving front wheels, and a motor. This is an example of the configuration in which the axis of the electric rotating machine is in the same direction as the direction of the axle as shown in FIG. 1A. The direction of the axle is the same as the direction of width of the vehicle. This limits the length of the electric rotating machine in the direction of the axis to some extent, so that a flatter thin motor is required. For such a hybrid automobile system, use is made of a concentrated winding motor to be detailed hereinbelow which can be decreased in thickness by reducing the thickness of the coil end. FIG. 1C shows positions of a longitudinal-mounted engine, an engine of hybrid system for driving rear wheels, and a motor.

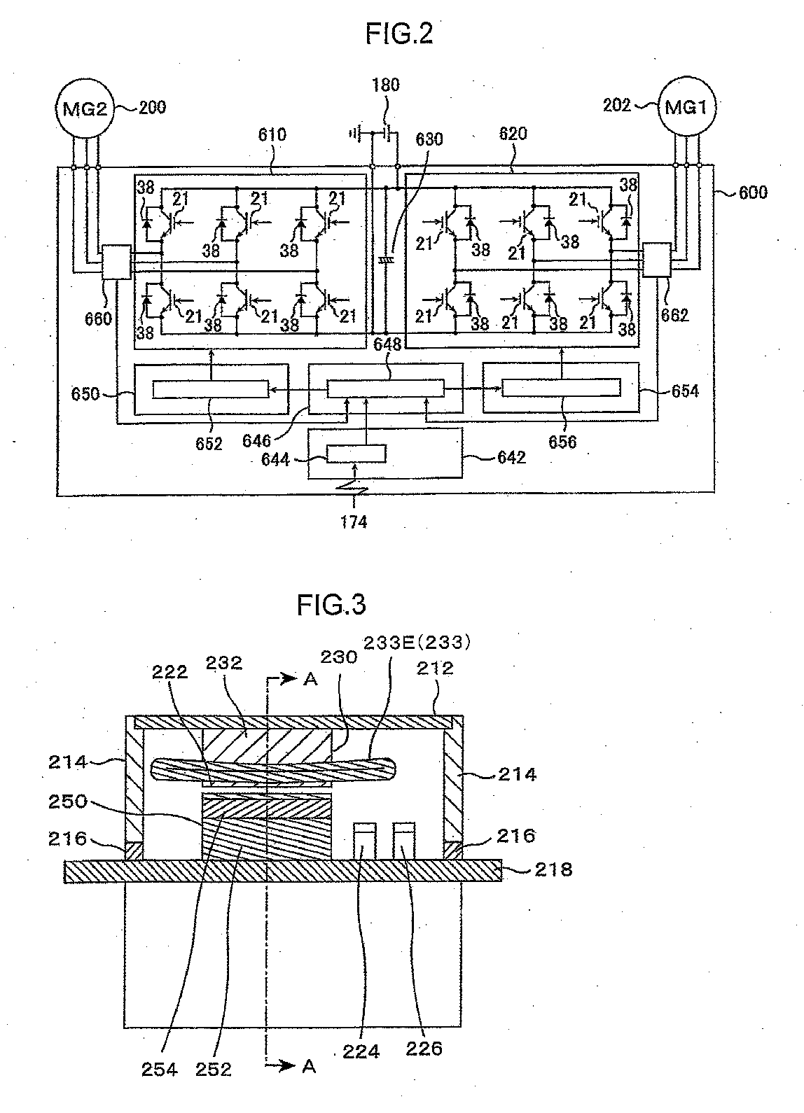

FIG. 2 shows circuitry of the power conversion system 600 shown in FIG. 1A. The power conversion system 600 includes a first inverter device for the first electric rotating machine 200 and a second inverter device for the second electric rotating machine 202. The first inverter device includes a first power module 610, a first drive circuit 652 that controls switching actions of each power semiconductor 21 in the first power module 610, a current sensor 660 that detects current in the electric rotating machine 200, a control circuit 648 used in common with the second inverter device to be described later on, a transmission-reception circuit 644 implemented on a connector board 642, and a capacitor module 630. The drive circuit 652 is provided on a drive circuit board 650. The control circuit 648 is provided on a control circuit board 646.

The second inverter device includes a second power module 620, a second drive circuit 656 that controls switching actions of each power semiconductor 21 in the second power module 620, a current sensor 662 that detects current in the electric rotating machine 202, a control circuit 648 used in common with the first inverter device, the transmission-reception circuit 644, and the capacitor module 630. The second drive circuit 656 is provided on a drive circuit board 654. The control circuit 648 is provided on the control circuit board 646. The transmission-reception circuit 644 is implemented on the connector board 642.

The first and second power modules 610 and 620 operate according to drive signals output from the first and second drive circuits 652 and 656, respectively, to convert DC power supplied from the high voltage battery 180 into three-phase alternating power and supply the AC power to corresponding armature windings of the electric rotating machines 200 and 202, respectively. On the other hand, the first and second power modules 610 and 620 convert AC power induced in the stator windings, i.e., armature windings of the electric rotating machines 200 and 202, respectively, into DC power and supply it to the high voltage battery.

As shown in FIG. 2, the first and second power modules 610 and 620 include each three-phase bridge circuits; series circuits corresponding to the three phases (U, V, and W phases) are electrically connected in parallel to between the positive terminal and the negative terminal of the battery 180. Each series circuit includes a power semiconductor that constitutes an upper arm and a power semiconductor that constitutes a lower arm. The power semiconductor 21 of the upper arm and the power semiconductor 21 of the lower arm are connected to each other in series.

The first and second power modules 610 and 620 have substantially the same circuit construction as shown in FIG. 2, and explanation is made on the first power module 610 as a representative. In this circuit, IGBTs (Insulated Gate Bipolar Transistors) 21 are used as switching power semiconductors. Each IGBT 21 has three electrodes, i.e., a collector electrode, an emitter electrode, and a gate electrode. A diode 38 is connected to between the collector electrode and the emitter electrode of each IGET 21. The diode 38 has two electrodes, i.e., a cathode and an anode. The cathode and the anode are electrically connected to the collector electrode and the emitter electrode of IGBT 21 such that the direction of from the emitter electrode to the collector electrode of IGBT 21 is a forward direction.

The switching power semiconductor element may be a MOSFET (Metal Oxide Semiconductor Field Effect Transistor). Each MOSFET includes three electrodes, i.e., a drain electrode, a source electrode, and a gate electrode. The MOSFET has a parasitic diode between the source electrode and the drain electrode. The forward direction of the parasitic diode is in the direction from the drain electrode to the source electrode. Therefore, when Metal Oxide Semiconductor Field Effect Transistors (MOSFETs) are used as the switching power semiconductors, it is unnecessary to provide the diodes 38 shown in FIG. 2.

The arm of each phase is constituted by the source electrode of the IGBT 21 and the drain electrode of the IGBT 21 being electrically connected to each other. In the present embodiment, only one IGBT is shown for each of upper and lower arms for each phase in FIG. 2. However, in actuality, since current capacity to be controlled is large, a plurality of IGBTs is electrically connected in parallel to constitute each arm. To make it simpler, it is assumed in the following description that each arm is constituted by only one power semiconductor.

In the example shown in FIG. 2, the upper arm and the lower arm are each constituted by three IGBTs for respective phases. The drain electrode of IGBTs 21 in each upper arm for each phase is electrically connected to the positive terminal of the battery 180 and the source electrode of IGBT 21 in each lower arm for each phase is electrically connected to the negative terminal of the battery 180.

A middle point (i.e., a connected portion of a source electrode of an upper arm side IGBT and a drain electrode of a lower arm side IGBT) of each arm for each phase is electrically connected to the armature winding of the corresponding electric rotating machine 200 or 202 of corresponding phase.

The first and second drive circuits 652 and 656 constitute driving units for controlling the corresponding inverter devices 610 and 620, respectively, and generate drive signals for driving IGBTs 21 based on control signals output from the control circuit 648. The drive signals generated by the respective drive circuits 652 and 656 are output to the gate of each power semiconductor in the first and second power modules 610 and 620. The two circuits that generate drive signals to be supplied to the gates of each of the upper and lower arms for each phase are formed into a single integrated circuit. The drive circuits 652 and 656 have each six such integrated circuits. The six integrated circuits are arranged in one block to constitute the drive circuit 652 or 656.

The control circuit 648 constitutes a control unit for each of the inverter devices 610 and 620. The control circuit 648 includes a micro computer that calculates control signals (control values) for operating (ON/OFF) a plurality of switching power semiconductors. In the control circuit 648, there are input torque command signals (torque command values) from a higher rank control device, signals detected by the current sensors 660 and 662, signals detected by rotation sensors (sensor outputs) mounted on the electric rotating machines 200 and 202. The control circuit 648 calculates control values based on the input signals and outputs control signals for controlling switching timing to the drive circuits 652 and 656.

The transmission/reception circuit 644 implemented on the connector board 642 is to electrically connect the power conversion system 600 and an external control device and transmits/receives information to/from other device through the communication line 174 shown in FIG. 1A.

The capacitor module 630 is to constitute a smoothing circuit for suppressing variation in DC voltage caused by the switching actions of the IGBTs 21. The capacitor module 630 is electrically connected in parallel to respective DC side terminals of the first and second power modules 610 and 620.

FIG. 3 is a cross-section showing the first electric rotating machine 200 or the second electric rotating machine 202 shown in FIG. 1. The first and the second electric rotating machines 200 and 202 have substantially the same construction. Accordingly, explanation is made on the construction of the first electric rotating machine 200 as a representative example. The construction to be detailed hereinbelow does not have to be adopted in both of the first and the second electric rotating machines 200 and 202 but may be adopted by at least one of them.

Inside a housing 212 is supported a stator 230. The stator 230 includes a stator core 232 and a stator winding 233. On an inner surface of the stator core 232, a rotor 250 is rotatably supported with a gap 222. The rotor 250 includes a rotor core 252 and a permanent magnet 254. The rotor core 252 is fixed to a shaft 218. The housing 212 has an end bracket 214 on each side thereof in the direction of rotational axis of the shaft 218. The shaft 218 having the rotor core 252 is rotatably supported through a baring 216 on each of the end brackets 214.

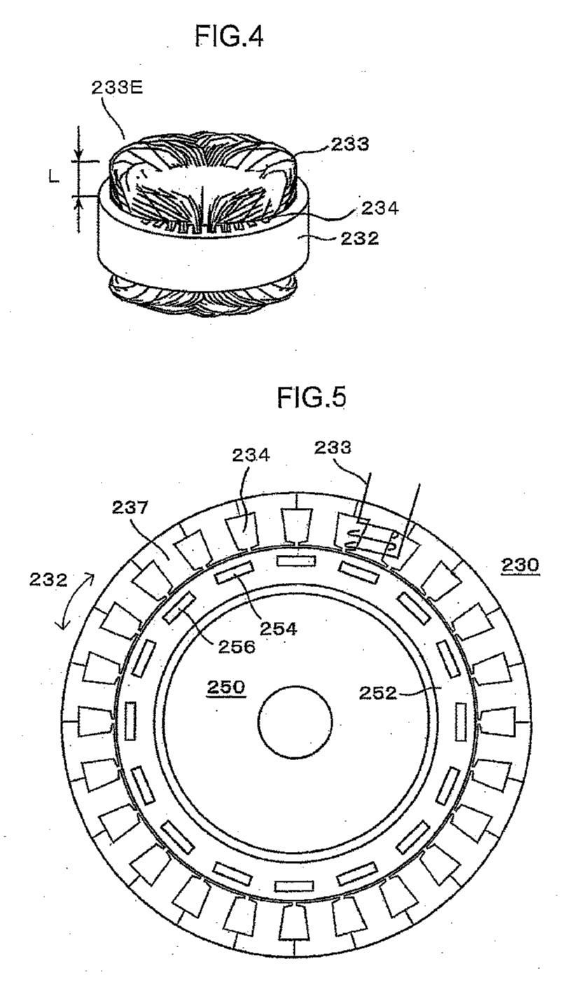

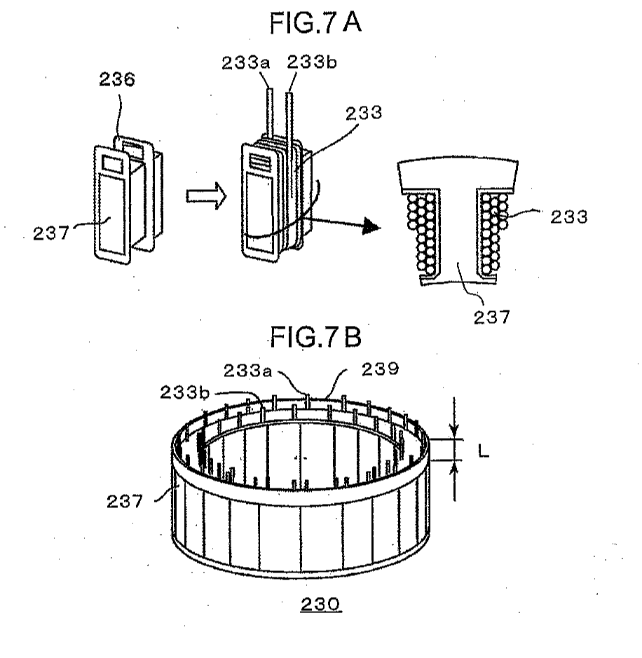

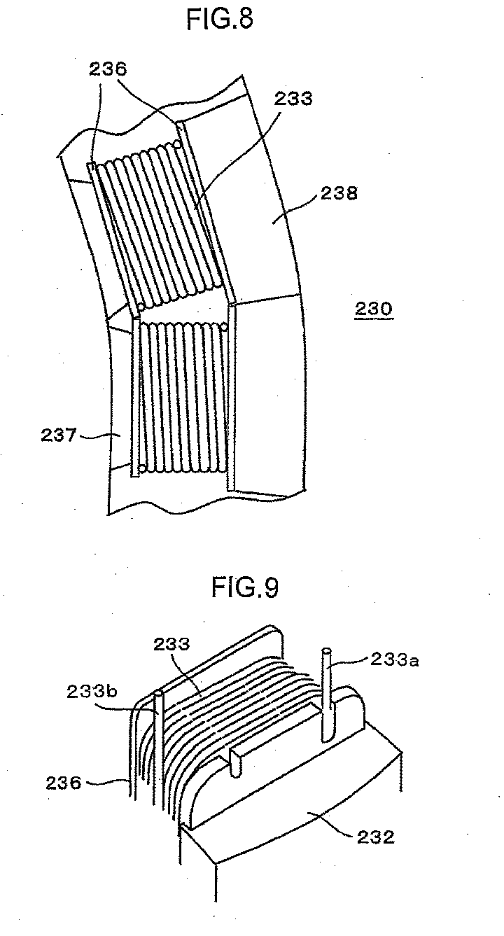

In the above-mentioned construction, a key factor for decreasing the thickness of the motor is the length of a coil end 233E. The coil end 233E will be described later referring to FIG. 4 and FIG. 7B. FIG. 4 is a diagram showing an appearance of a distributed winging stator. A conventional distributed winding inevitably has a long coil end as indicated by L in FIG. 4 because of cross-over arrangement of the winding with the conductor wire in adjacent slot. Accordingly, when the total length of the motor in the direction of axis is decreased, the length of the stator 232 of the stator 230 is not secured, so that no operable motor can be obtained. This is one of problems imposed on a motor for hybrid automobiles. To solve this problem, a concentrated winding motor is used. The construction of the stator is detailed later on.

The shaft 218 is equipped with a rotor position sensor 224 that detects the position of poles of the rotor and a rotation speed sensor 226 that detects the rotation speed of the rotor. Outputs from the sensors 224 and 226 are incorporated by the control circuit 648 shown in FIG. 2 to control the power module 610 based on the outputs from the sensors.

FIG. 5 is a cross-sectional view along the line A-A in FIG. 3 showing the stator 230 and the rotor 250. Description on the housing 212 and the shaft 218 is omitted. The stator 230 has the stator core 232. The stator is provided with a plurality of slots 234 and teeth 237. The slots 234 and the teeth 237 distribute uniformly in the circumferential direction. A coil 233 is provided around each of the teeth 237 in a concentrated fashion to form so-called concentrated winding. In FIG. 5, the teeth 237 and the slots 234 are provided all along the periphery of the stator on the side facing the rotor. Note that not all but only some of the teeth 237 and the slots 234 as representatives are attached reference numerals for convenience.

The rotor core 252 is provided with a plurality of holes or slots each having a shape corresponding to the shape of a magnet to be inserted therein. In each hole, a permanent magnet 254 to be detailed later on is embedded and fixed therein with an adhesive or the like. The permanent magnets 254 serve as filed poles of the rotor 250. The direction of magnetization of the permanent magnet 254 that constitutes the field pole is a direction in which the stator side surface of the magnet is an N pole or an S pole. The direction of magnetization of the permanent magnet is reversed field pole to field pole. In other words, any two adjacent permanent magnets 254 have opposite directions of magnetization.

The permanent magnets 254 may be embedded in the rotor core after they have been magnetized to be brought in a state of a permanent magnet. Alternatively, the permanent magnets 254 may be provided by inserting the permanent magnets 254 in a non-magnetized state into the rotor core 252 to form the rotor 250 and applying intense magnetic field to the rotor 250 to magnetize the permanent magnets 254. The latter method allows production of the electric rotating machine at a higher productivity than the former method. This is because the permanent magnets 254 are strong magnets and if the permanent magnets 254 are magnetized before they are fixed to the rotor 250, there occurs intense attraction between the permanent magnets 254 and the rotor core 252 upon fixing the permanent magnets 254. This centripetal force will hinder the operation. In addition, the intense attractive force may cause dust such as iron particles to be attached to the permanent magnets 254.

Referring to FIGS. 3 and 5, rotation of the rotor is described. According to outputs from the rotation speed sensor 226 and the rotor position sensor 224 of the rotor, the first drive circuit 652 shown in FIG. 2 generates control signals for controlling the first power module 610 and transmits them to the first power module 610. The first power module 610 performs switching actions according to the control signals to convert the DC power supplied from the battery 180 into three-phase AC power. The three-phase AC power is supplied to the stator wiring 233 shown in FIGS. 3 and 5. The frequency of the three-phase AC current is controlled according to the detected value of the rotation speed sensor 226 and the phase of the three-phase AC current with respect to the rotor is controlled based on the detected value of the rotor position sensor 224.

A rotating magnetic field having the above-mentioned phase and frequency is generated in the stator 230 due to the three-phase AC current. The rotating magnetic field of the stator 230 acts on the permanent magnets 254 and 256 in the rotor 250 to generate magnet torque based on the permanent magnets 254 and 256.

In the embodiment shown in FIG. 5, each field pole is constituted by a single permanent magnet 254 or 256, so that the direction of magnetization is reversed field pole to field pole. In this embodiment, any two adjacent permanent magnets 254 and 256 are opposite in polarity. The magnetic poles of the rotor 250 with the permanent magnets 254 and 256 are arranged at even interval in the circumferential direction of the rotor 250. In the present embodiment, there are sixteen (16) magnetic poles.

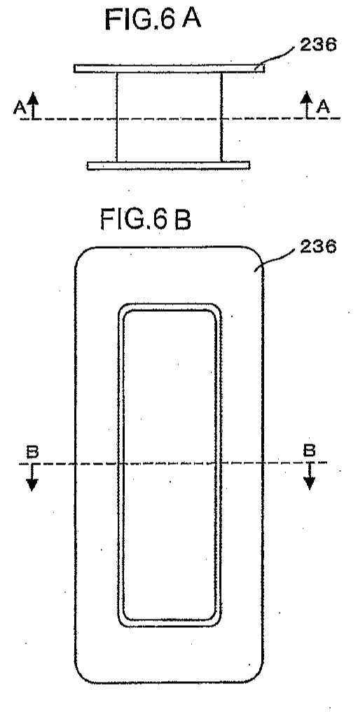

In the embodiment shown in FIG. 5, the stator core 232 is segmented into a plurality of teeth 237 each having a T-shaped form. Each segment or unit core 237 is provided with resin-made bobbins 236 as shown in FIGS. 6A and 6B and winding is formed as shown in FIG. 7A. In FIG. 7A, a conductor wire or wire rod 233, which may be a coated or insulated round wire, is wound around each segment core 237 between the bobbins 236 made of a resin. Each segment core 237 may be constituted by a stack of steel sheets. Note that the wiring of which the coil or conductor wire is wound in a concentrated fashion as shown in FIG. 7 is referred herein as “concentrated wiring”. On the other hand, the wiring of which the conductor wire or coil is inserted such that it strides a slot as shown in FIG. 4 is referred to herein as “distributed wiring”. The stator 230 is constructed by combining any two adjacent T-shaped units 237 with each other as shown in FIG. 8 to obtain a final annular structure as shown in FIG. 5 or FIG. 7B.

Each segment core 237 has own terminals 233a and 233b of the coil 233 separately from other segment cores as shown in FIG. 9. The terminals 233a are connected by a connection board or ring 239 (see FIG. 7B) made of a conductive resin. In the wiring shown in FIG. 9, the coil of the wiring has a circular cross-section. The coil may have a square cross-section. Winding a coil having a square cross-section around the core allows results in an increase in wire area within the slot, which in turn results in an increase in current that is supplied to the motor. Accordingly, the coil having a square cross-section is suitable for use in a motor of which high torque is required such as one for hybrid vehicles. In addition, winding the coil having a square cross-section densely around the core is advantageous in that the conductor wires such as copper wires can be arranged very closely so that the heat generated by the coil can be readily released to the core side.

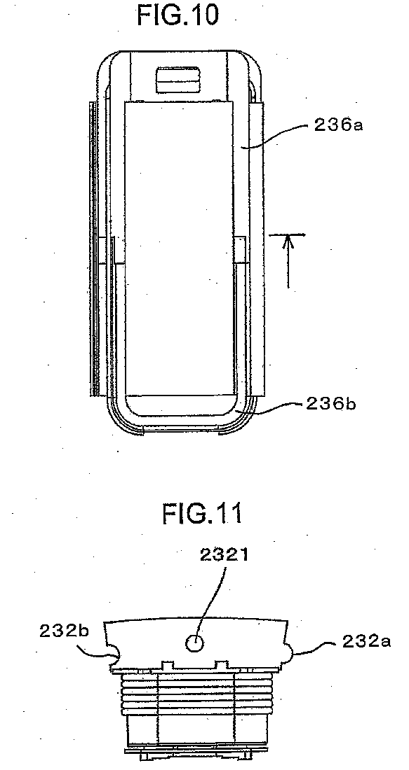

In the case of the T-shaped core, the bobbin 236 may be constituted by an upper bobbin part 236a and a lower bobbin part 236b as shown in FIG. 10. The upper and lower parts 236a and 236b can be arranged such that they sandwich the tooth 237 of the stator 230 vertically. For example, the upper bobbin part 236a is first attached to the tooth 237 from the above and then the lower bobbin part 236b is attached from the below by sliding along the side of the tooth 237 as indicated by an arrow in FIG. 10. Alternatively, the bobbin 236 may be integrally molded and attached to each of the teeth 237. Referring to the shape of the stator core, the stator core 232 is provided with a convex 232a and a concave 232b as shown in FIG. 11 in order to avoid occurrence of misalignment upon assembling the teeth 237 into an annular form. Upon assembling the teeth 237, the convex 232a of one of two adjacent teeth 237, 237 is snapped into the concave 232b of the other. The stator core is constructed by stacking steel sheets one on another. Each steel sheet is provided with caulking mates 2321 as schematically shown in FIG. 11. By stacking the steel sheets such that the caulking mates mate between two adjacent steel sheets, the steel sheets in whole can secure a predetermined integrated shape after the stacking.

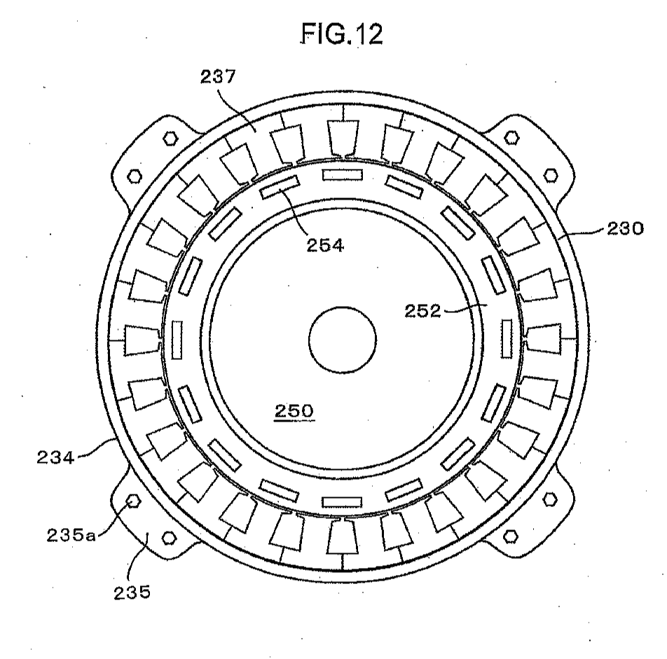

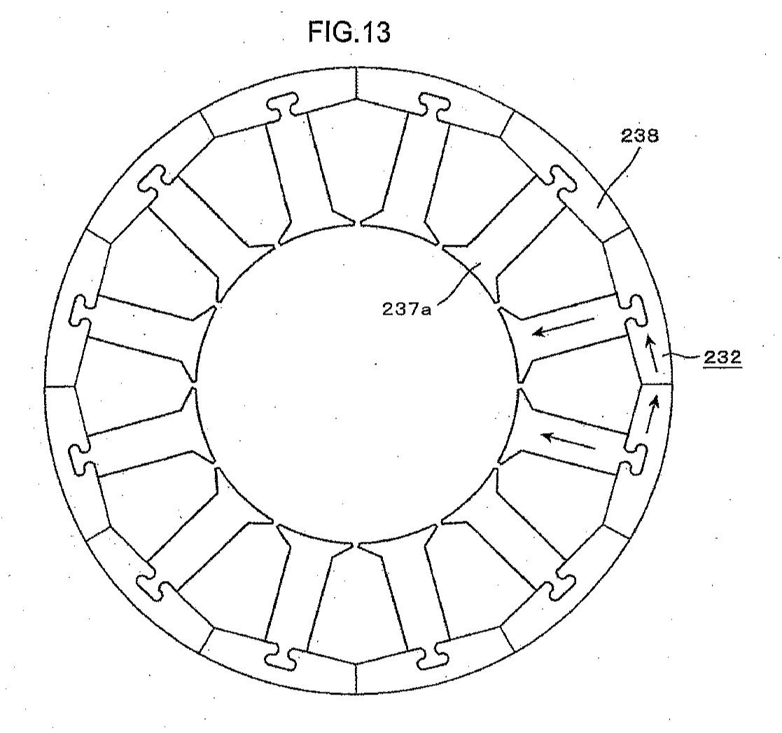

As shown in FIG. 12, to retain the stator in an annular form as assembled, the stator 2230 is fixed to a housing 234 of a thin annular form by, for example, shrinkage fitting. The housing 234 is provided with a plurality (for example, four as in FIG. 12) of flanges 235 for fixing the motor to the vehicle. Each flange 235 is formed of one or more holes (not shown) through which one or more bolts 235a are inserted and tightened to fix the motor to the vehicle.

FIG. 13 illustrates another method for fabricating the stator 230. The stator core 232 includes teeth 237a and core back sections 238 with which the teeth 237a are fitted, respectively. A set of one tooth 237a and one core back section 238 corresponding to the tooth 237a is equivalent to one tooth (or segment or unit core) 237 shown in FIG. 12. Each of the parts, i.e., the teeth 237a and the corresponding core back sections 238 are cut out from magnetic steel sheets such that their longitudinal directions are identical with the direction of rolling the steel sheets as indicated by arrows in FIG. 13 in order to obtain optimized magnetic characteristics. Since, for example, a silicon steel sheet has good magnetic characteristics along the direction of its rolling, teeth 237a and core back sections 238 have been prepared in advance by punching out from the steel sheet such that the longitudinal directions of the teeth 237a and the core back sections 238 correspond to the direction in which the steel sheet was rolled. Use of such punched out parts of the teeth 237a and the core back sections 238 results in a decrease in excitation loss or iron loss to improve fuel or energy cost of the vehicle.

Each tooth 237a and each corresponding core back section 238 are fitted with each other to form a T-shaped tooth, which is then combined with another t-shaped tooth formed in this manner to form a core of an annular form. Alternatively, the core back sections 238 may be formed as an integral annulus (core 232) and the teeth 237a may be fitted with the integral core 232 through respective mating structures such as those through which the teeth 237a and the core back sections 238 are fitted as shown in FIG. 13.

The bobbins may be arranged either before or after the teeth 237a are fitted with the core back sections 238. For example, the non-segmented bobbins 236 are fitted with the respective teeth 237a and then the teeth 237a with the respective bobbins 236 are fitted with the core back sections 238, respectively. Then, the resultant structures are combined with each other to form the stator 230. Alternatively, the teeth 237a are fitted with the core back sections 238, respectively, and the upper bobbin part 236a and the lower bobbin part 236b are attached to the teeth 237a so that the bobbin parts 236a and 236b sandwich the respective teeth 237a from above and from below.

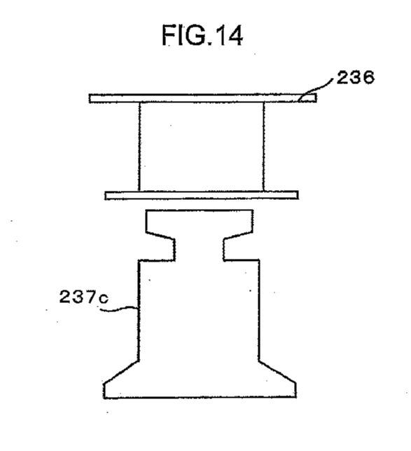

When the core back sections 238 are formed as an integral annulus (core 232), straight teeth after having wound thereon coil winding may be fitted with the integral core 232. In this case, the bobbin 236 is one molded as an integral component that can be fitted with each tooth 237c as shown in FIG. 14, so that the bobbin need not be segmented. This makes it easier to fabricate the stator and increases reliability of the product. Note that the tooth 237c shown in FIG. 14 has a different contour from that of each tooth 237a, which has round corners, in the mating structure for fitting with each core back section 238 in contrast to angulated corners of the tooth 237c.

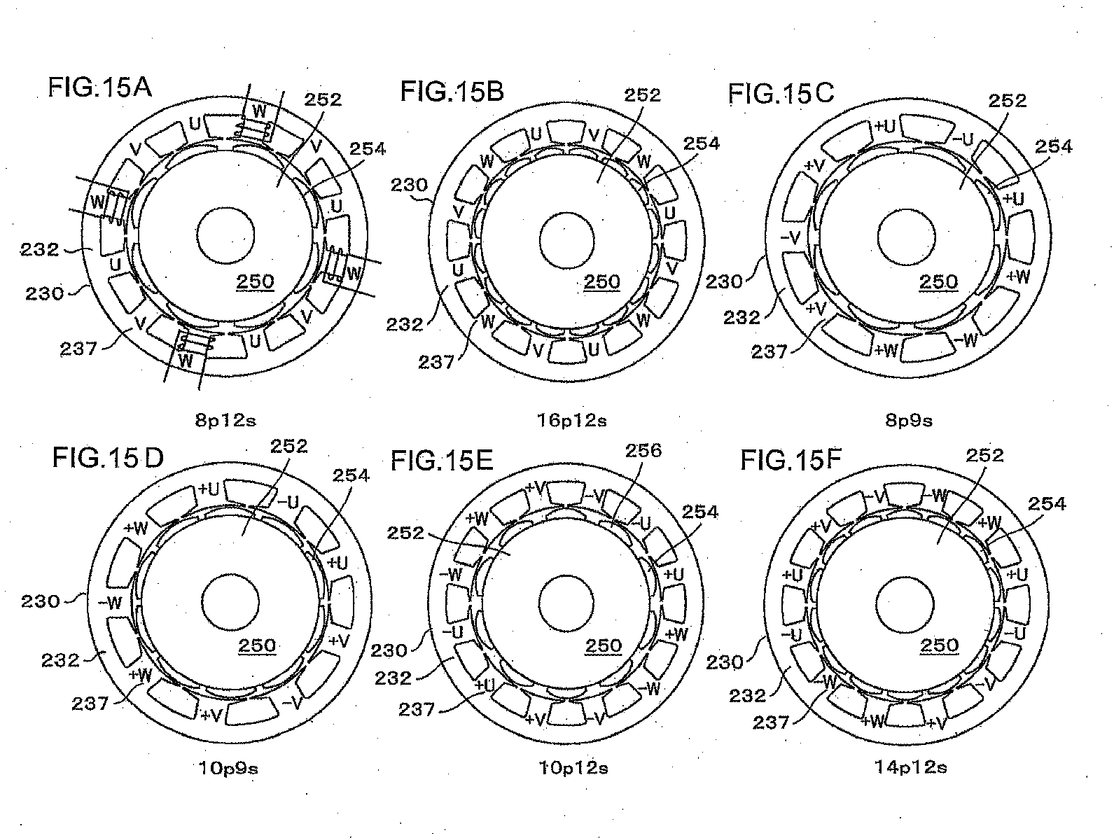

FIG. 15A shows an example of an electric rotating machine having a cross-sectional configuration with 8 poles and 12 slots instead of a concentrated winding motor having a cross-sectional configuration with 16 poles and 24 slots. The example shown in FIG. 15A is the same as the above-mentioned example except the following description.

This example is concerned with an electric rotating machine in which a stator whose winding is of a concentrated winding structure is used. In FIGS. 15A to 15F, symbols U, V, and W indicate corresponding structures, respectively, and only W-phase winding is illustrated in FIG. 15A, with U-phase winding and V-phase winding are omitted for convenience's sake. Also, in FIGS. 15B to 15F, all the windings are omitted for convenience's sake. By connecting the windings or coils in parallel or in series, the voltage with respect to the terminal can be controlled.

In the example shown in FIG. 15A, the rotor side surfaces of the permanent magnets 254 and 256 have a radius of curvature smaller than that of the gap side surfaces thereof as shown in FIG. 15A. In a cross-section in a plane perpendicular to the rotation axis of the rotor 250, each magnet 254 or 256 has a shape having an increasing thickness in a radial direction, more particularly along a direction from the rotor 250 toward the stator 230, starting at each peripheral end thereof. The side surface of each magnet 254 or 256 on the stator side 230 is defined by a curve with a curvature greater than that of a curve that defines the surface each magnet 254 or 256 on the rotor side. A central portion in the peripheral direction of the magnet is closest to the stator 230.

Due to the above-mentioned shape (hereinafter, referred to as “hog-backed shape”) of the permanent magnet 254, 256, the magnetic flux density of the magnet on the side of the stator 230 can smoothly distribute in a sinusoidal fashion in the peripheral direction. With this effect, harmonic components can be decreased to decrease cogging torque and harmonic waves in waveforms of induced voltage can be decreased. Permanent magnets of hog-backed shape as mentioned above can be fabricated with ease according to the present example.

The rotor 250 may be provided with a magnet holding member (not shown). The magnet holding member prevents the permanent magnets from being scattered by centrifugal force. The magnet holding member may be integral with the rotor core 252 or may be attached to the rotor core 252. If the magnet holding member is made of a magnetic material, a motor utilizing reluctance torque can be obtained. Since reluctance torque is better used in distributed winding structure motors, the stator may be of a distributed winding structure.

The following are explanations on differences between the permanent magnet used in the present embodiment and the conventionally used sintered magnet and bond magnet.

A sintered magnet is used for electric vehicles and hybrid electric vehicles since it can make the most of high energy density to downsize the motor in which it is used. However, in producing the sintered magnet, high temperature treatment is indispensable in the step of sintering, so that production cost including plant cost is high. Due to the sintering step in which a magnet material is heated at high temperatures, the shape and dimension of the magnet after the sintering varies from the shape and dimension of the magnet before the sintering. Therefore, in order to obtain a component having a precise dimension, it has been necessary to perform molding operations including substantial cutting for obtaining precision in size in a molding step after the sintering. This has led to an increase in production cost of magnet motors and has posed an obstacle to provide inexpensive motors with high controllability.

A bond magnet is produced by mixing a thermosetting epoxy resin with a magnet material and molding the resultant mixture. That is, the bond magnet is a magnet made of the magnet material bound with the epoxy resin. The magnet including the epoxy resin as a binding agent is produced by compression molding a mixture of the magnet material and the epoxy resin. Such a bond magnet contains the epoxy resin in a high proportion relative to the magnet material, that is, the proportion of the content of the magnet material in the magnet decreases to decrease magnetic characteristics of the magnet, so that the characteristics of the electric rotating machine is decreased. Such a bond magnet has a low energy density, so that it is not so frequently used for applications that require large capacity torque but it is used for small fan motors and the like.

As mentioned above, surface processing will be necessary to achieve the above-mentioned shape with a sintered magnet, which increases cost. In actuality, sintered magnets are sintered at a temperature of 1,000° C. or higher, it is necessary to correct deformation due to thermal shrinkage; it is indispensable to carry out processing afterwards. In bond magnets that contain a magnet material bound with the organic substance, it is difficult to use the epoxy resin as a binding agent at a temperature of 150° C. or higher, so that the bond magnets are not suitable for use in an electric rotating machine for automobiles that have to be frequently used in a thermal environment above 150° C.

The hog-backed shape magnet according to the embodiment shown in FIG. 15A can be applied to the embodiment shown in FIG. 5. In the embodiment shown in FIG. 5, the permanent magnets 254 and 256 held by the rotor 250 may be replaced by the hog-backed shape permanent magnets shown in FIG. 15A. In the distributed winding motor, the rotating magnetic field generated by the stator can be made smoother than the concentrated winding motor. In addition, the arrangement of hog-backed shape permanent magnets on the outer periphery of the rotor core makes it possible to bring variation of magnetic flux density of the magnet on the stator side into a state close to a sinusoidal function. These result in a decrease in torque ripple of the electric rotating machine. Low pulsation torque can be generated particularly in low speed operations, so that acceleration when the vehicle is started becomes smoother, which is suitable for providing to the driver a high quality feeling in the operation of the vehicle.

Such a permanent magnet of the conventional sintered magnet type requires molding to correct deformation after the heat treatment and hence is expensive. However, in the case of the electric rotating machine with the permanent magnet according to the present embodiment, one the shape of the permanent magnet mentioned above has been formed through a press die, there occurs less deformation after the pressing working, so that post-working of the magnet is not necessary or if the post-working is necessary, the amount of work is small and the process of the working is simplified.

The object to which the present embodiment is applicable is not limited to a motor having 8 poles or 16 poles. The number of poles in the rotor 250 may be 10, 12, or more. Conversely, the number of poles may be smaller. The winding type of the stator winding includes distributed winding and concentrated winding. In the case of a three-phase motor, the number of slots in the distributed winding stator is the same as the number of poles of 3n (where n is a positive integer). On the other hand, in the case of the concentrated winding stator, assuming that N is a number of slots in the stator and P is a number of poles, an efficient three-phase motor is obtained when the relations hip 2/3≦P/N≦4/3 is established. This applies in any combinations of P and N satisfying the above relationship. In the concentrated winding motor, the number of coils on the stator side that constitutes a single pole is small and the stator generates harmonic components other than the basic synchronizing frequency in large amounts. In particular, there are many harmonic components that are lower in dimension than the basic synchronizing frequency. For this reason, much eddy current flows in the permanent magnets on the surface of the rotor. In a motor with the conventional sintered magnet, it is indispensable to adopt a countermeasure such as splitting of the magnet. The principle and applications of splitting the magnet will be described later on. In the case of a magnet made of magnetic particles bound with a SiO-based binding agent to be detailed later on, the binding agent, which is an insulation material, is present between the magnetic particles, so that permanent magnet has a high internal resistance, which decreases eddy current accordingly. It is also possible to bind magnetic particles each having an insulation film on the surface thereof to form a permanent magnet. Therefore, it is less necessary to adopt countermeasure such as splitting of the magnet in contrast to the conventional sintered magnet. When the countermeasure is unnecessary, the rotation electrical machine can be produced at low cost. In addition, the magnet of the present embodiment can be applied to those electric rotating machines to which no countermeasure has been taken take in order to increase the efficiency of the motor. Since heat generation by the magnet can be decreased by using the magnet of the present embodiment, so that it becomes easier to take a countermeasure against heat.

The permanent magnets 254 and 256 are each constituted by powder or particles of one of rare earth elements, neodymium (Nd), which is a material of a magnet (hereafter, referred to as “magnet material”) bound with a binding agent whose precursor has good wettability with the Nd particles. The precursor having good wettability with the rare earth element powder or particles includes, for example, alkoxysiloxane or alkoxysilane, which serve as precursors of SiO₂. The particles of Nd have plate-like shapes such that a size in the Z axis (in the direction of height) is several times or more with respect to sizes of the X axis and of the Y axis. In other words, the particles of Nd are thin plates. It is preferred that the sizes in the X axis and the Y axis of the Nd particles are larger. For example, when Nd particles having sizes of the X axis and the Y axis being 45 μm or more are used, an improved residual magnetic flux density (or remanence) of the magnet can be obtained. It may be unavoidable that some Nd particles are broken into smaller particles during molding and finer particles are contained in the Nd powder. However, it is preferred that half (50%) or more of the powder contains particles having a size of 45 μm or more. When 70% or more of the Nd powder contains particles having a size of 45 μm or more, more preferred results are obtained. Further, when 90% or more of the Nd powder contains particles having a size of 45 μm or more, still more preferred results are obtained. When the Nd particles contain some amount of dysprosium (Dy), the motor has improved characteristics. The Dy contained in the Nd particles enables good magnetic characteristics to be maintained even when the temperature of the electric rotating machine increases. The content of Dy is about several atomic percents (%) up to 10 atomic % based on the total atoms of the rare earth elements in the magnetic particles. The magnet having a structure made of powder or particles of rare earth element magnet material bound with a binding agent and the method for producing such a magnet will be detailed later on.

FIGS. 15B to 15F are schematic diagrams showing concentrated winding motors having different number of poles of rotor and stator and different number of slots in place of those shown in FIG. 15A. Besides the constructions of the concentrated winding motors, it is also possible to configure a multi-pole motor in which one of the above-mentioned combinations is repeated electrically to constitute a full circle. In the case of three-phase motor, ratios of p:t where p is a number of poles and t is a number of teeth include 16:24, 18:37, 20:30, 22:33, 24:36, and 16:9 in 2:3 series; 16:9, 20:15, and 24:18 in 4:3 series; 16:18 and 24:27 in 8:9 series, 20:18 in 10:9 series; and 16:15, 16:21, 20:21, 22:18, 22:21, and 22:24 in other series.

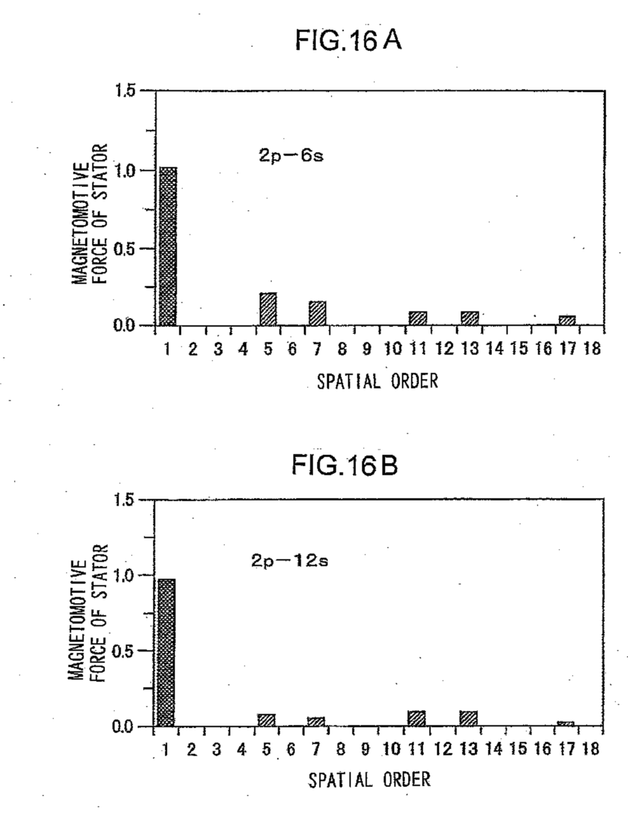

FIGS. 16A, 16B, 17A, 17B, 18A, 18B, 19A, and 19B are each a bar graph showing harmonic components of magnetomotive force generated by the stator of a concentrated winding motor. The horizontal axis of the bar graph indicates a synchronous order (black bar) and an asynchronous order (hatched bar), taking spatial magnetomotive force in the peripheral direction per pole pair as first order. FIGS. 16A and 16B show so-called distributed winding motors. FIG. 16A shows harmonic components of the magnetomotive force generated by the stator of a motor having 2 poles and 6 slots (2p-6s motor). FIG. 16B shows harmonic components of the magnetomotive force generated by the stator of a motor having 2 poles and 12 slots (2p-12s motor). As can be seen from FIGS. 12A and 12B, asynchronous components appear at a spatial order of 5 or more. As can be seen from FIGS. 16A and 16B, the 2p-12s motor has less harmonic components. The harmonic components cause eddy current in the motor.

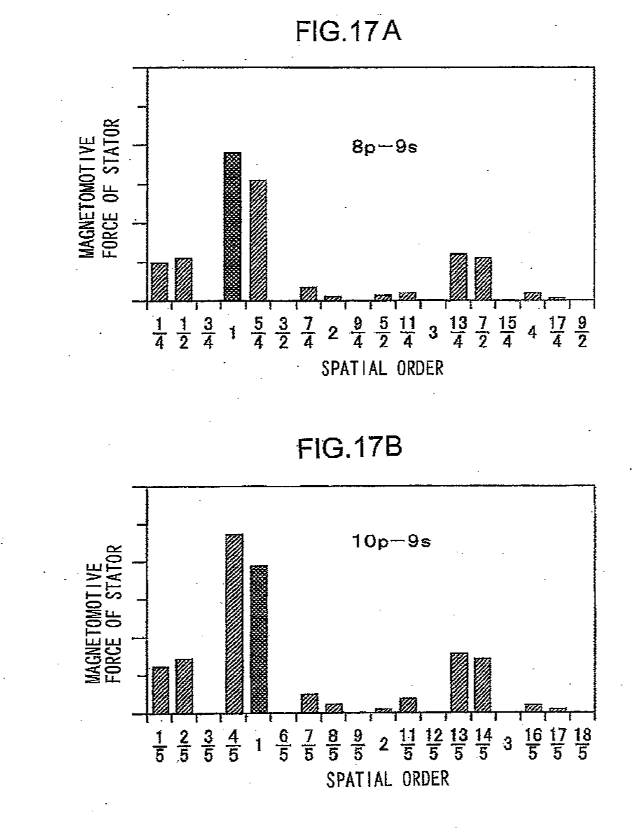

On the other hand, FIGS. 17A and 17B show so-called concentrated winding motors. FIG. 17A shows harmonic components of the magnetomotive force generated by the stator of a motor having 8 poles and 9 slots (8p-9s motor). FIG. 17B shows harmonic components of the magnetomotive force generated by the stator of a motor having 10 poles and 9 slots (10p-9s motor). Comparison of FIGS. 17A and 17B with FIGS. 16A and 16B indicates that the concentrated winding provides larger amounts of asynchronous components of magnetomotive force than the distributed winding. In particular, the 8p-9s motor provides a larger component at a spatial order of 5/4. The 100-9s motor provides a larger asynchronous component at a spatial order of ⅘. Only when the number of poles of the rotor corresponds to the spatial order of the magnetomotive force of the stator, torque is generated by the motor. Therefore, in the case of the 10p-9s motor, the stator is capable of generating magnetic force that can rotate an 8-pole motor whereas the components do not synchronize with the rotor. The components that do not synchronize with the rotor serve as asynchronous components to the rotor to generate eddy current. This causes demagnetization due to an increase in the temperature of the magnet.

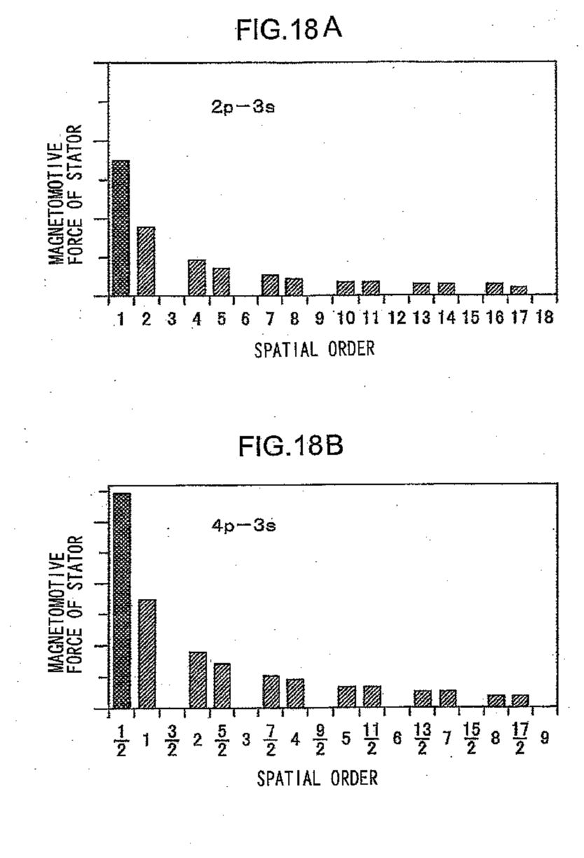

Similarly, FIGS. 18A and 18B show so-called concentrated winding motors. FIG. 18A shows harmonic components of the magnetomotive force generated by the stator of a motor having 2 poles and 3 slots (2p-3s motor). This corresponds to the embodiment shown in FIG. 5. The 2p-3s series motor does not generate asynchronous harmonic components at a spatial order lower than 1. Even so, the 20-3s series motor generates a larger amount of harmonic components than the distributed winding motor. On the contrary, the 4p-3s series motor generates a large low order component at a spatial order of ½.

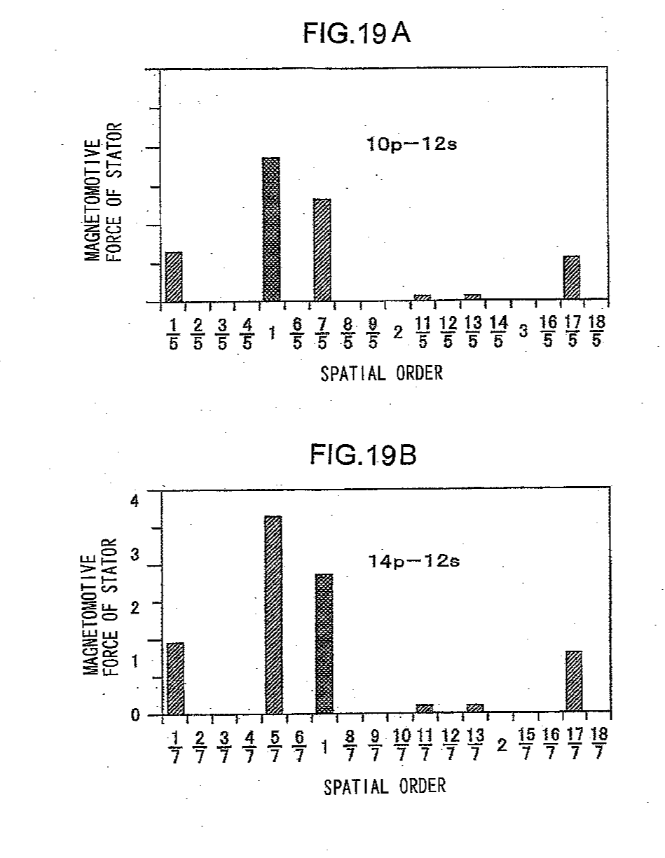

Similarly, FIGS. 19A and 19B show so-called concentrated winding motors. FIG. 19A shows harmonic components of the magnetomotive force generated by the stator of a motor having 10 poles and 12 slots (10p-12s motor). FIG. 19B shows harmonic components of the magnetomotive force generated by the stator of a motor having 14 poles and 12 slots (10p-12s motor). These correspond to the embodiments shown in FIGS. 15E and 15F. Also in this case, it can be seen that a large asynchronous harmonic component is present.

Note that the greater the number of pole is than the number of slots, the larger the asynchronous component is. This means that when poles are constructed in the stator, harmonic components are decreased when more coils are used to construct the poles. Therefore, since the concentrated winding motor has a small number of slots, it generates a large amount of eddy current. In particular, in the case of combinations where the relationship (number of poles)>(number of slots) is established, eddy current of the magnet tends to flow.

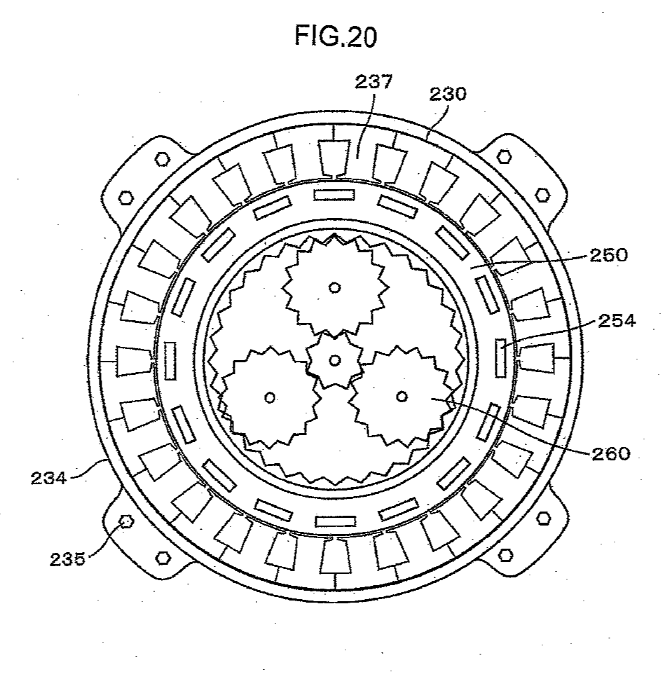

The concentrated winding motor as mentioned above is featured in that it can be made thin and configured to have a multipole structure. Use of multipole structure enables a reduction in length in the peripheral direction of the magnetic circuit of the motor. As a result, a deceleration system can be located within the motor and there can be made best use of the space in the engine room. FIG. 20 shows the construction of a motor according to another embodiment of the present invention in which a planet gear 260 is incorporated in the rotor 250 of the motor.

In a motor generator that is flat in the radial direction in which a space for incorporating parts of a drive system is provided on the inner periphery side of the rotor, the number of poles of the permanent magnet is preferably 16 or more.

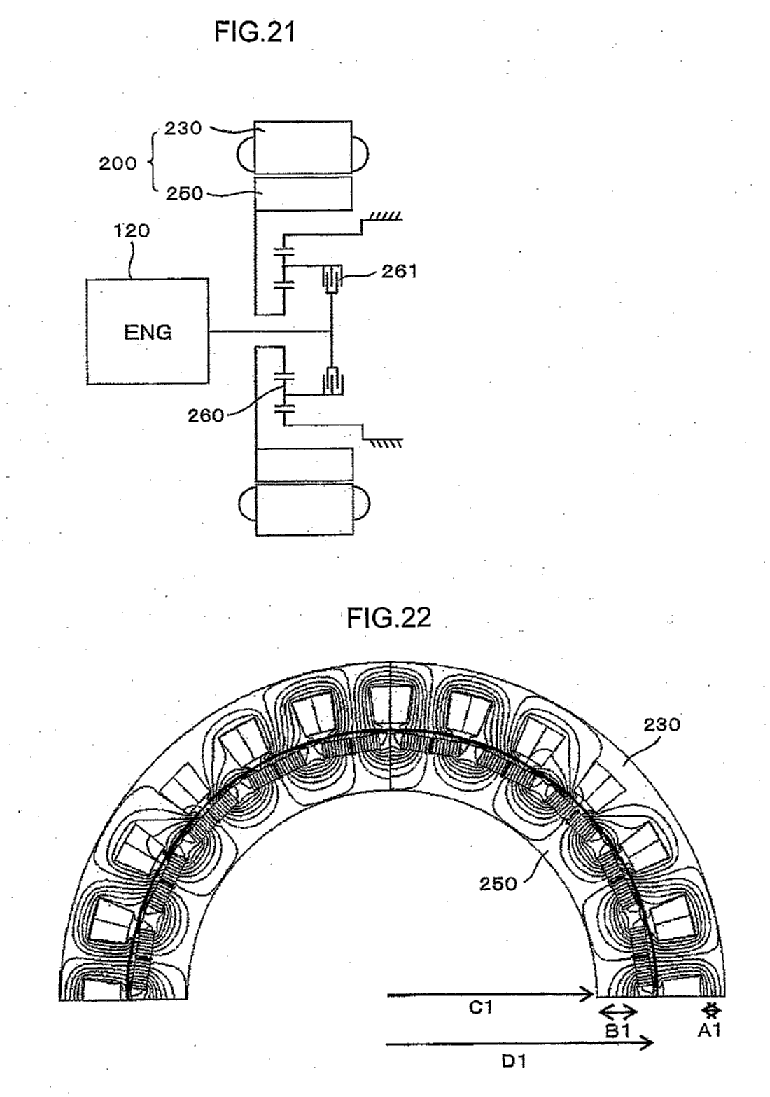

Referring to FIG. 21, the construction of a driving source of a hybrid electric vehicle using the electric rotating machine according to the present invention will be described below. FIG. 21 is a block diagram showing the construction of the driving source of the hybrid electric vehicle using the motor generator according to the other embodiment of the present invention.

The electric rotating machine includes a stator 230 and a rotor 250 that is rotatably supported and disposed inside the stator 230. A space is formed inside the stator 250, and a reduction gearing, i.e., a planetary gear 260, and a clutch 261 are disposed in the space. Driving forces of the electric rotating machine 200 are reduced in speed by the planetary gear 260 and transmitted to the clutch 261. Respective driving forces of an engine 120 and the electric rotating machine 200 are transmitted to the front wheels 110 through the power transfer mechanism or differential gear 160 and the transmission 130, which are shown in FIG. 1.

When driving system parts such as the planetary gear 260 and the clutch 261 are assembled inside the electric rotating machine, the space for assembling the driving system parts is required inside the rotor 250 of the electric rotating machine 200. In other words, the electric rotating machine 200 has a structure extending flat in the radial direction. By arranging the planetary gear 260 and the clutch 261 in that space, the system size can be reduced.

In the electric rotating machine 200 having the above-described construction, the radial width between the outer diameter of the stator 230 and the inner diameter of the rotor 250 is reduced. Particularly, the core back 238 (see FIG. 13) of the stator 230 and a yoke of the rotor 250 positioned inward of permanent magnets are thinned. From the viewpoint of realizing such a structure, it is effective to increase the number of poles of permanent magnets embedded in the rotor 250 of the electric rotating machine.

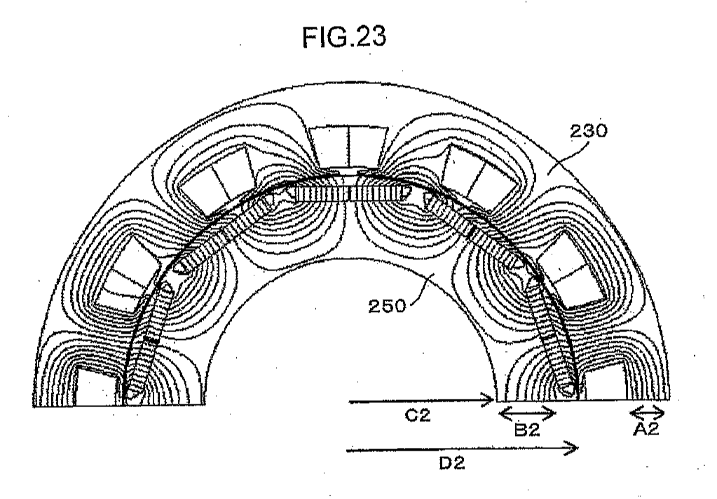

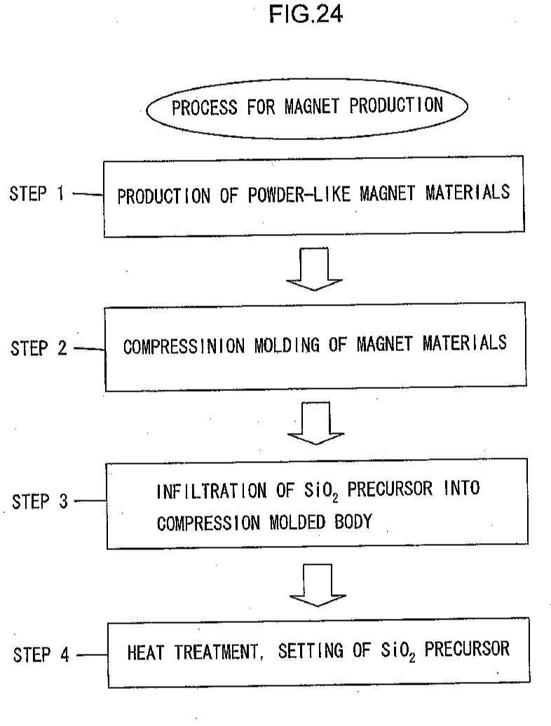

With reference to FIGS. 22 and 23, a description is made of lines of magnetic flux in the 20-pole and 24-teeth electric rotating machine (motor generator) with concentrated winding and a 10-pole and 12-teeth electric rotating machine (motor generator) with concentrated winding. FIG. 22 shows the lines of magnetic flux in the 20-pole and 24-teeth motor generator with concentrated winding. FIG. 23 shows the lines of magnetic flux in the 10-pole and 12-teeth motor generator with concentrated winding.

As seen from comparison of FIGS. 22 and 23, the thickness of the core back of the stator can be set to a smaller value in the case of the 20-pole motor than in the case of the 10-pole motor (i.e., A1<A2). Also, the radial thickness of the core of the rotor, which is positioned inward of the magnets, can be set to a smaller value (i.e., B1<B2). As a result, a radius C1 of the space inside the rotor of the 20-pole motor can be made larger than a radius C2 of the space inside the rotor of the 10-pole motor (i.e., C1>C2). This is because magnetic fluxes in a multi-pole motor go around following curves of smaller curvatures as seen from the lines of magnetic flux in the respective motors shown in FIGS. 32 and 33.

Further, the larger number of poles reduces the thickness A1 of the stator core back so that the radius of the rotor can be increased correspondingly (D1>D2). Thus, the 20-pole motor can produce higher torque than the 10-pole motor.

Also, as easily understood from the rotor layouts shown in FIGS. 22 and 23, the larger number of poles results in that a larger number of magnets are divided to increase the number of bridge portions, and therefore the mechanical strength against centrifugal forces can be increased. In other words, when magnetic fluxes are generated in the same amount, the larger number of poles is advantageous in that the size of one magnet can be reduced, and therefore the mechanical strength against centrifugal forces can be increased.

In addition, because the 20-pole motor is less apt to demagnetize than the 10-pole motor, the magnet thickness can be reduced and the cost can be cut in the former. The reason why the 20-pole motor is less apt to demagnetize is as follows. When the magnetic field formed by the stator is exactly opposite to the direction of magnetization of the magnet and the intensity of the magnetic field exceeds a predetermined value, the magnet is demagnetized. The magnet is required to have a certain thickness in order to avoid the demagnetization. In the 20-pole motor, because the number of slots is twice that in the 10-pole motor, the electromotive force per slot is about half and the intensity of the magnetic field formed by windings wound over one tooth of the stator is also reduced to half. Accordingly, equivalent demagnetization strength can be obtained even with the magnet having a substantially half thickness. It is hence possible to reduce the magnet amount and to provide a motor having a superior cost-performance ratio.

However, if the number of poles is further increased, the core back of the stator can be made thinner from the viewpoint of magnetic circuit, but the mechanical strength is too reduced. In practice, therefore, a satisfactory effect cannot be expected with the further increase in the number of poles. For that reason, an upper limit in the number of poles is about 30.

While the multi-pole structure is advantageous in arranging the gears inside the rotor as described above, the motor with distributed winding requires a larger number of slots. In the case of the motor with centralized winding, the number of slots will not exceed 1.5 times the number of poles in general combinations. In the case of the motor with distributed winding, however, the number of slots exceeds 3 times the number of poles. If the number of slots is increased and each slot has a narrower shape, electrical work becomes harder to execute and the coil density in each slot is reduced, thus leading to a difficulty in realizing a small size with sufficient performance. For that reason, the structure using the concentrated winding is more suitable for the multi-pole motor including the built-in gears.

Other problems accompanying with the multi-pole motor are iron loss (excitation loss) of the stator core and heat generated by eddy currents in the magnet, which are attributable to an increase of frequency. According to the present invention, the magnet can be made to have high resistance to heat without dividing the magnet in the axial direction, the circumferential direction or the direction of thickness, and/or forming slits therein. A bonded magnet formed by solidifying magnet dust may be used as an alternate solution. In this case, the magnet dust is covered with an inorganic coating to increase heat resistance. The reason is that, because a vehicular motor is subjected to high temperatures in excess of 150° C. and often requires oil cooling, the heat resistance of the conventional organic coating is insufficient. Alternatively, iron dust may be covered with the inorganic coating and an iron-dust core formed by compacting the coated iron dust may be used in the rotor and the stator. Thus, by employing the dust-magnet and/or -core, it is possible to reduce eddy currents, to lessen the iron loss, and to realize high-speed rotation.

Thus, in the case of the motor generator which has a space for assembling the driving system parts inside the rotor and is extended flat in the radial direction, the number of poles of the permanent magnets is preferably 16 or more.

FIG. 24 shows an example of a manufacturing process of the magnet according to the present invention. In step 1, a powdered magnet material is formed. The detailed forming methods will be described in the examples presented later.

In step 2, compression molding is performed on the powdered magnet material. If, for example, a permanent magnet for an electric rotating machine is to be made, the compression molding can be performed according to the final magnet shape of the permanent magnet to be used in the electric rotating machine. With the method described in detail below, the dimensions of the magnet shape that is compression molded at step 2 do not change much in subsequent steps. As a result, a highly precise magnet can be manufactured. This increases the possibilities for achieving the precision demanded for the permanent magnet electric rotating machine. For example, it would be possible to obtain the precision needed for a magnet to be used in an electric rotating machine with an internal permanent magnet. In contrast, conventional sintered magnets provide very bad dimensional precision in the manufactured magnets, requiring cutting of the magnet. This reduces operation efficiency while also possibly leading to degradation of the magnetic characteristics by the cutting operation.

In step 3, the SiO₂ precursor solution is infiltrated in the compression molded magnet shaped body. This precursor is a material having good wettability with the magnet shaped body that was compression molded. By impregnating with a binding agent solution having good wettability with the magnet shaped body, the binding agent covers the surface of the magnetic powder forming the magnet shaped body, acting to form effective bonds among a large number of the particles. Also, since the good wettability allows the binding agent solution to enter the fine areas of the magnet shaped body, good bonding can be achieved with a small quantity of binding agent. Also, since good wettability is involved, the equipment used is simpler and inexpensive as compared with the use of epoxy resin.

In step 4, the SiO₂-infiltrated shaped body is heated to obtain a magnet in which the magnet material is bonded with SiO₂ as a binding agent. As described in detail below, the processing temperature in the step 4 is relatively low, resulting in almost no changes in the shape or the dimensions of the magnet shaped body, thus eventually providing a very high degree of precision in the shape and relative dimensions of the manufactured magnet.

Examples of alkoxysiloxane and alkoxysilane, which are precursors of SiO₂ used in the binding agent solution used in the step 3, include compounds such as those shown in Chemical Formula 1 and Chemical Formula 2 in which there is an alkoxyl group at the terminal group and the side chain.

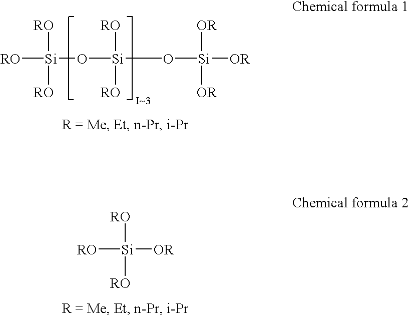

As an alcohol in the solvent, it would be preferable to use a compound with the same skeleton as the alkoxyl group in the alkoxysiloxane or the alkoxysilane, but the present invention is not restricted to this. More specifically, examples of the alcohol include methanol, ethanol, propanol, and isopropanol (isopropyl alcohol). Also, as a catalyst for hydrolysis and dehydration condensation, an acid catalyst, a base catalyst, or a neutral catalyst can be used, but it would be most preferable to use a neutral catalyst since it is possible to minimize corrosion of metal. For neutral catalysts, organotin catalysts are effective. Specific examples of the organotin catalyst include tin bis(2-ethylhexanoate), n-butyltin tris(2-ethylhexanoate), di-n-butyltin bis(2-ethylhexanoate), di-n-butyltin bis(2,4-pentanedionate), di-n-butyltin dilauryl, di-methyltin di-neodecanoate, dioctyltin dilaurate, and dioctyltin di-neodecanoate, but the present invention is not restricted to these. Also, examples of acid catalysts include diluted hydrochloric acid, diluted sulfuric acid, diluted nitric acid, formic acid, and acetic acid, and examples of base catalysts include sodium hydroxide, potassium hydroxide, and ammonia water. The present invention is not restricted to these examples.

It would be preferable for the total content of the alkoxysiloxane or the alkoxysilane, the hydrolysate thereof, and the dehydration condensation product thereof serving as the precursor for SiO₂ in the binding agent solution to be at least 5% by volume and no more than 96% by volume. If the total content of the alkoxysiloxane or the alkoxysilane, the hydrolysate thereof, and the dehydration condensation product thereof is less than 5% by volume, the low content of the binding agent in the magnet slightly reduces the strength of the binding agent as a material after setting curing. If, on the other hand, the total content of the alkoxysiloxane or the alkoxysilane, the hydrolysate thereof, and the dehydration condensation product thereof is 96% by volume or more, the rate of the polymerization reaction of the alkoxysiloxane or alkoxysilane as the precursor for SiO₂ is fast, resulting in an increased thickening rate for the binding agent solution. This makes it difficult to control the viscosity of the binding agent solution to be an appropriate value, and makes it more difficult to use this binding agent solution in impregnation than the aforementioned material.

The alkoxysiloxane or the alkoxysilane serving as the precursor for SiO₂ in the binding agent solution and water results in the hydrolysis reaction indicated in Chemical Equation I or Chemical Equation II. The Chemical Equations I and II here are the equations for reactions that take place where there is localized hydrolysis.

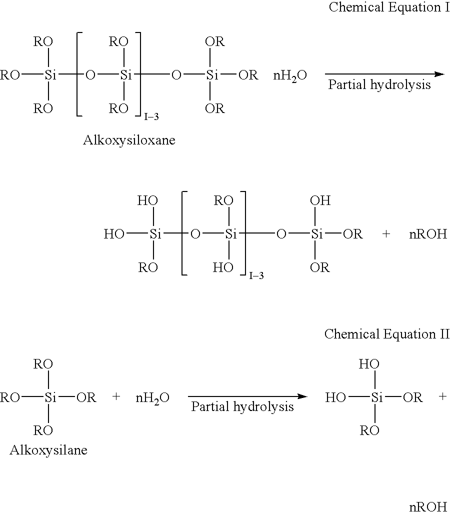

The amount of water added is one of the factors that dictate how the hydrolysis of alkoxysiloxane or alkoxysilane will progress. This hydrolysis is important for increasing the mechanical strength of the binding agent after setting. This is because without hydrolysis of alkoxysiloxane or alkoxysilane, there will be no subsequent dehydration condensation of the alkoxysiloxane or alkoxysilane hydrolysis reactants. The product of this dehydration condensation is SiO₂, and this SiO₂ has strong bonding with the magnetic particles and is an important material for increasing the mechanical strength of the binding agent. Furthermore, the OH group of silanol has a strong interaction with oxygen (O) atoms or the OH group of the magnetic powder surfaces and contributes to improved bonding. However, as the hydrolysis proceeds and the concentration of the silanol group increases, dehydration condensation between the organosilicon compounds containing the silanol group (the product of the hydrolysis of alkoxysiloxane or alkoxysilane) takes placer resulting in increased molecular weight of organosilicon compound and increased viscosity of the binding agent solution. This is not a suitable state for a binding agent solution to be used for the impregnation method. Thus, the amount of water added to the alkoxysiloxane or the alkoxysilane as the serving as the precursor for SiO₂ in the binding agent solution must be an appropriate value. It would be preferable for the amount of water to be added to the solution for forming the insulation layer to be 1/10 to 1 equivalent in the hydrolysis reaction indicated in Chemical Equation I or Chemical Equation II. If the water added to the alkoxysiloxane or alkoxysilane as the precursor for SiO₂ in the binding agent solution is 1/10 equivalent or less of the hydrolysis reaction shown in Chemical Equation I or II, the concentration of the silanol group of the organosilicon compound is lowered, resulting in low interaction between the organosilicon compound containing the silanol group and the magnetic powder surfaces. Also, since the dehydration condensation reaction is retarded, SiO₂ with a large amount of residual alkoxyl group in the product is generated, resulting in a large number of defects in the SiO₂ and hence low strength for the SiO₂. If, on the other hand, the amount of water added is greater than the reaction equivalent of the hydrolysis reaction shown in Chemical Equation I or II, dehydration condensation of the organosilicon compound containing the silanol group is made easier to occur, resulting in thickening of the binding agent solution. This prevents the binding agent solution from being infiltrated into the gaps between magnet particles and is not an appropriate state for the binding agent solution to be used in the impregnation method. Alcohol is generally used as the solvent in the binding agent solution. This is because the alkoxyl group in alkoxysiloxane dissociates quickly with the solvent used in the binding agent solution and replaces the alcohol solvent to maintain an equilibrium state. Thus, it would be preferable for the alcohol solvent to be an alcohol with a boiling point lower than that of water and with a low viscosity such as methanol, ethanol, n-propanol, or isopropanol. However, the solvent that can be used in the present invention also include those solvents which show the chemical stability of the solution slightly reduced but the viscosity of the binding agent solution not increasing in a few hours and the boiling point lower than that of water. For example, a water-soluble solvent such as a ketone, e.g., acetone, can be used.

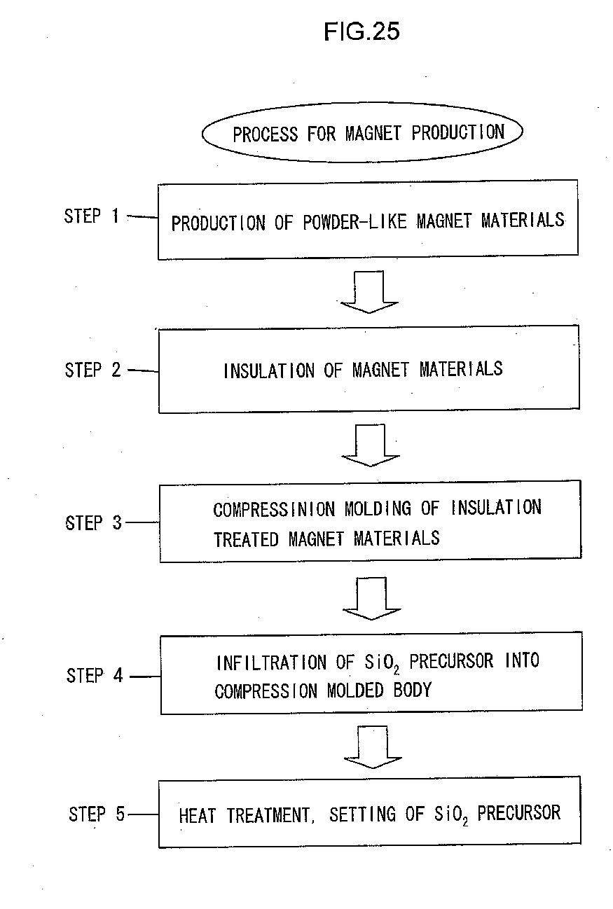

FIG. 25 shows another example of a magnet manufacturing process according to the present invention. This example differs from the one described with reference to FIG. 24 in that an insulating step is added after the creation of the powdered magnetic material and before compression molding.

In this insulating step, it would be preferable to form an insulating layer over as much of the surfaces of the magnet particles and as uniformly as possible. The details of the operation will be described later. If a magnet is to be used in different types of machines such as electric rotating machines, it will often be used in alternating current magnetic fields. For example, in an electric rotating machine, magnetic flux that is generated by coils and acts upon a magnet changes periodically. When magnetic flux changes in this manner, eddy currents may be generated at the magnet, reducing the efficiency of the electric rotating machine used. Covering the magnet particle surfaces with an insulation layer can limit these eddy currents and can prevent the efficiency of the electric rotating machine from being reduced.

When a magnet is used under the condition that a high frequency magnetic field containing harmonic components is applied to the magnet, it is preferred that an inorganic insulating film is formed on the surface of rare-earth magnet powder. Thus, it would be preferred to form an inorganic insulative film on the rare-earth magnet particle surfaces and apply a phosphatized film as the inorganic insulative film. When phosphoric acid, magnesium, and boric acid are used for a phosphatization solution, the following composition would be preferable. A phosphoric acid content of 1 g/dm³ to 163 g/dm³ would be preferable, since magnetic flux density would be reduced if the content is greater than 163 g/dm³ and insulative properties would be reduced if the content is less than 1 g/dm³. Also, it would be preferred for boric acid content to be 0.05 g to 0.4 g per gram of phosphoric acid. If the phosphoric acid content exceeds this range, the insulative layer becomes unstable. Magnesium may be used in an amount sufficient to form salts with phosphoric acid and boric acid. To form an insulative layer uniformly over all the magnet particle surfaces, improving wettability of the insulative film forming solutions relative to the magnet particles would be effective. To achieve this, it would be preferred to add a surfactant. Examples of this type of surfactant include perfluoroalkyl-based surfactants, alkylbenzenesulfonate-based surfactants, dipolar ion-based surfactants, or polyether-based surfactants. It would be preferable for the amount added to be 0.01% to 1% by weight in the insulative layer forming solution. If the amount is less than 0.01% by weight, the surface tension is lowered and the wetting of the magnetic powder surface is inadequate. If the amount exceeds 1% by weight, no additional advantages are gained, thus making it uneconomical.

Also, it would be preferable to add an antirust agent to the phosphatization solution. Preferably, the antirust agent includes one or more organic compounds containing at least one of sulfur and nitrogen with lone-pair electrons. Such organic compounds are, for example benzotriazoles, represented by Chemical Formula 3 below:

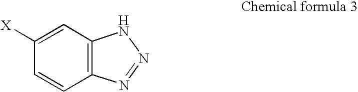

In Chemical Formula 3 above, X is any of H, CH₃, C₂H₅, C₃H₇, NH₂, OH, and COOH).

Specific examples of the benzotriazoles include benzotriazole (BT), imidazole (IZ), benzoimidazole (BI), thiourea (TU), 2-mercaptobenzoimidazole (MI), octylamine (OA), triethanolamine (TA), o-toluidine (TL), indole (ID) and 2-methylpyrrole (MP).

It would be preferable for the amount for an antirust agent to be 0.01 mol/dm³ to 0.5 mol/dm³. If the amount is less than 0.01 mol/dm³, it becomes difficult to prevent rust on the magnetic powder surfaces. If the amount exceeds 0.5 mol/dm³, no additional advantages are gained, thus making it uneconomical.

The amount of phosphatization solution added is dependent on the average particle diameter of the magnet particles for the rare-earth magnet. If the average particle diameter of the magnet particles for the rare-earth magnet is 0.1 μm to 500 μm, it would be preferable for the amount to be 300 ml to 25 ml for kg of magnet particles for the rare-earth magnet. If the amount is greater than 300 ml, the insulative film on the magnet particle surface becomes too thick and also leads to increased rust formation, thus reducing the magnetic flux density when the magnet is manufactured. If the amount is less than 25 ml, the insulative properties are not good and rust tends to form where the treatment liquid does not wet, potentially leading to degradation in magnet characteristics.

The reason that rare-earth fluorides or alkaline earth metal fluorides in the coat film forming solution are bloated or swelled in solvents having alcohol as the main component is that rare-earth fluoride or alkaline earth metal fluoride gel has a gelatinous plastic structure and that alcohol has good wettability with regard to magnetic powder for rare-earth magnets. Also, the rare-earth fluorides or alkaline earth metal fluorides in the gel state must be crushed to an average particle diameter of no more than 10 μm because this provides a uniform thickness for the coat film formed on the rare-earth magnetic powder surface. Furthermore, using alcohol as the main component for the solvent makes it possible to limit oxidation of the rare-earth magnetic powder, which tends to easily oxidize.

Furthermore, it would be preferable for the inorganic insulative film used to improve insulation properties and magnetic characteristics of the magnetic powder to be a fluoride coat film. When a fluoride coat film is formed on the rare-earth magnetic powder surface for these reasons, the concentration of the rare-earth fluoride or alkaline earth metal fluoride in the fluoride coat film forming solution is 200 g/dm³ to 1 g/dm³. While the concentration of the rare-earth fluoride or alkaline earth metal fluoride in the fluoride coat film forming solution is dependent on the thickness of the film to be formed on the rare-earth magnetic powder surface, it is important that the rare-earth fluoride or alkaline earth metal fluoride bloats in the solvent having alcohol as its main component and the rare-earth fluoride or alkaline earth metal fluoride in the gel state must be crushed to a average particle diameter of no more than 10 μm and be dispersed through the solvent having as alcohol as its main component.

The amount of rare-earth fluoride coat film forming solution added depends on the average particle diameter of the rare-earth magnetic powder. If the average particle diameter of the rare-earth magnetic powder is 0.1 μm to 500 μm, it would be preferable to add 300 ml to 10 ml per kilogram (kg) of rare-earth magnetic powder. If the amount of solution is too high, more time is required to remove the solvent and also the rare-earth magnetic powder tends to corrode. If the amount of solution is too low, the solution may not wet parts of the rare-earth magnetic powder surface. Table 1 indicates effective concentrations for the solution and the like for the rare-earth fluoride or alkaline earth metal fluoride coat film as described above.

TABLE 1
Treatment Liquid

| | | | | Average |
|---|---|---|---|---|
| | | Effective | | particle |
| Component | Nature | concentration | Solvent | size (nm) |
| MgF₂ | Colorless, transparent, slightly viscous | ≦200 | Methanol | <100 |
| CaF₂ | Milky, slightly viscous | ≦200 | Methanol | <1000 |
| LaF₃ | Semitransparent, viscous | ≦200 | Methanol | <1000 |
| LaF₃ | Milky, slightly viscous | ≦200 | Ethanol | <2000 |
| LaF₃ | Milky | ≦200 | n-Propanol | <3000 |
| LaF₃ | Milky | ≦200 | Isopropanol | <5000 |
| CaF₂ | Viscous, milky | ≦100 | Methanol | <2000 |
| PrF₃ | Yellowish-green, semitransparent, viscous | ≦100 | Methanol | <1000 |
| NdF₃ | Light purple, semitransparent, viscous | ≦200 | Methanol | <1000 |
| SmF₃ | Milky | ≦200 | Methanol | <5000 |
| EuF₃ | Milky | ≦200) | Methanol | <5000 |
| GdF₃ | Milky | ≦200 | Methanol | <5000 |
| TbF₃ | Milky | ≦200 | Methanol | <5000 |
| DyF₃ | Milky | ≦200 | Methanol | <5000 |
| HoF₃ | Pink, cloudy | ≦150 | Methanol | <5000 |
| ErF₃ | Pink, cloudy, slightly viscous | ≦200 | Methanol | <5000 |
| TmF₃ | Slightly semitransparent, viscous | ≦200 | Methanol | <1000 |
| YbF₃ | Slightly semitransparent, viscous | ≦200 | Methanol | <1000 |
| LuF₃ | Slightly semitransparent, viscous | ≦200 | Methanol | <1000 |

The above was a description of an example of a magnet manufacturing process according to the present invention, with references to FIG. 24 and FIG. 25. More specific examples will be described below.

### EXAMPLE 1

In this example, the rare-earth magnetic powder used is a magnetic powder crushed from NdFeB-based ribbons made by quenching a hardener with a controlled composition. The NdFeB-based hardener is formed by mixing Nd in an iron and a Fe—B alloy (ferroboron) and melting in a vacuum or an inert gas or a reduction gas atmosphere to make the composition uniform. The hardener is cut as needed and a method involving a roller such as a single-roller or double-roller method is used and the hardener melted on the surface of a rotating roller is spray quenched in an atmosphere of reduction gas or inert gas such as argon gas to form ribbons, which are then heated in an atmosphere of reduction gas or inert gas. The heating temperature is at least 200° C. and no more than 700° C., and this heat treatment results in the growth of fine Nd₂Fe₁₄ crystals. The ribbons have a thickness of 10 μm to 100 μm and the fine Nd₂Fe₁₄B crystal sizes are 10 nm to 100 nm.

If the Nd₂Fe₁₄ fine crystals have an average size of 30 nm, the grain boundary layer has a composition close to Nd₇₀Fe₃₀ and is thinner than critical particle diameter of a single magnetic domain, thus making the formation of a magnetic wall in the Nd₂Fe₁₄ fine crystals difficult. It is believed that the magnetization of Nd₂Fe₁₄ fine crystals occurs because the individual fine crystals are magnetically bonded and the inversion of magnetization takes place due to the propagation of magnetic walls. One method for limiting magnetization inversion is to make the magnetic particles crushed from ribbons more easy to magnetically bond with each other. To do this, making the non-magnetic sections between magnet particles as thin as possible is effective. The crushed powder is charged into a WC carbide die with Co added. Then, the powder is compression molded with upper and lower punches at a press pressure of 5 t/cm² or more and 20 t/cm² or less. As a result, the molded article has reduced non-magnetic sections between magnet particles in the direction perpendicular to the direction of the press. This is because the magnetic powders are flat powders formed by crushing ribbons, there is anisotropy in the arrangement of the flat powders of the compression molded shaped body. As a result, the long axes of the flat powders (parallel to the direction perpendicular to the thickness of the ribbon) are aligned with the direction perpendicular to the press direction. Since the long axes of the flat powders tend to orient themselves perpendicular to the press direction, the magnetization in the shaped body is more continuous in the direction perpendicular to the press direction than in the press direction. This provides increased permeance between the particles and reduces magnetization inversion. As a result, there are differences in the demagnetization curves between the press direction and the direction perpendicular to the press direction in the shaped body. With a 10×10×10 mm shaped body, when magnetization is applied in the direction perpendicular to the press direction at 20 kOe and the demagnetization curve is prepared by performing demagnetization and measuring magnetic flux density at each applied magnetic field, analysis of the prepared demagnetization curve shows a residual magnetic flux density (Br) of 0.64 T and a coercivity (iHc) of 12.1 kOe. On the other hand, when 20 kOe magnetization is applied in the direction parallel to the press direction and a demagnetization curve is prepared by performing demagnetization in the magnetization direction and measuring magnetic flux density at each applied magnetic field, analysis of the prepared demagnetization curve shows a residual magnetic flux density (Br) of 0.60 T and iHc of 11.8 kOe.

This type of differences in demagnetization curves is believed to be due to the use of flat magnetic particles used in the shaped body, with the orientation of the flat particles resulting in anisotropy within the shaped body. The grain size of the individual flat particles are small, at 10 nm to 100 nm, and there is little anisotropy in the crystal orientation, but since the shape of the flat particles have anisotropy, there is magnetic anisotropy due to the anisotropy of the orientation of the flat particles. Test samples of this type of shaped body were infiltrated with SiO₂ precursor solutions according to 1) to 3) below and heat was applied. The steps that were performed are described below.

The following three solutions were used for the SiO₂ precursor, which is the binding agent.

1) A mixture of 5 ml of CH₃O—(Si(CH₃O)₂—O)ₘ—CH₃ (m is 3 to 5, average 4), 0.96 ml of water, 95 ml of dehydrated methanol, and 0.05 ml of dibutyltin dilaurate was prepared and left standing at a temperature of 25° C. for 2 days.

2) A mixture of 25 ml of CH₃O—(Si(CH₃O)₂—O)ₘ—CH₃ (m is 3 to 5, average 4), 4.8 ml of water, 75 ml of dehydrated methanol, and 0.05 ml of dibutyltin dilaurate was prepared and left standing at a temperature of 25° C. for 2 days.

3) A mixture of 100 ml of CH₃O—(Si(CH₃O)₂—O)ₘ—CH₃ (m is 3 to 5, average 4), 3.84 ml of water, and 0.05 ml of dibutyltin dilaurate was prepared and left standing at a temperature of 25° C. for 4 hours.

The viscosities of the SiO₂ precursor solutions described above were measured using an Ostwald viscometer at 30° C.

(1) Compression molded test pieces with 10 mm length, 10 mm width and 5 mm thickness for magnetic characteristic measurement and with 15 mm length, 10 mm width and 2 mm thickness for strength measurement were produced by filling molds with Nd₂Fe₁₄ magnetic powder magnetic powder, described above, and applying pressure at 16 t/cm².

(2) The compression molded test pieces prepared in (1) were disposed in a vat so that the direction of pressure application was horizontal, and the binding agent, SiO₂ precursor solution from 1) through 3) described above were poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) described above were measured by the 4 probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5). Samples of the compression molded pieces with a form of 15 mm×10 mm×2 mm were subjected to bending tests to evaluate flexural strength by 3 points bending tests with 12 mm distance between the points.

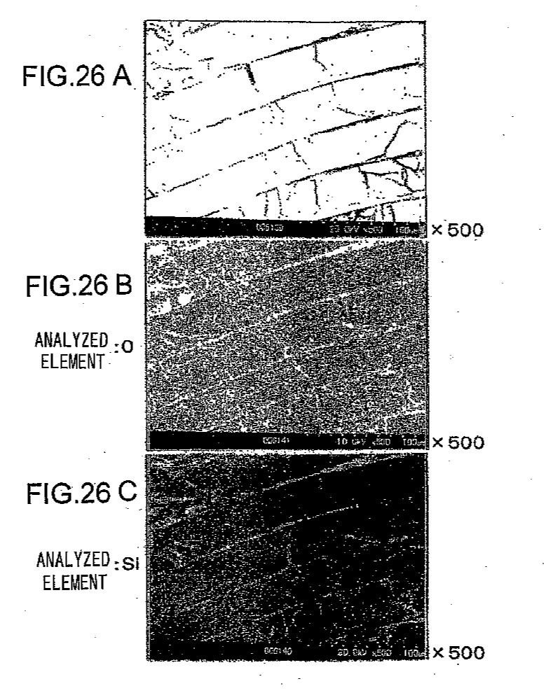

FIGS. 26A, 26B, and 26C show each an example of SEM observation results of cross-sections of compression molded test pieces with 10 mm length, 10 mm width and 5 mm thickness prepared in (5) above. FIG. 26A is a secondary electron image, FIG. 26B is an oxygen surface analysis image, and FIG. 26C is a silicon surface analysis image. As FIG. 26A shows, the flat particles are deposited with anisotropy and localized cracks are formed. Also, oxygen and silicon were detected along the crack at the flat particle surfaces and inside the flat particles. These cracks were formed during compression molding and were hollow before infiltration. Based on this, it was determined that the SiO₂ precursor solution infiltrated all the way into cracks of the magnet particles.

Regarding the magnetic characteristics of the compression molded test pieces with 10 mm length, 10 mm width and 5 mm thickness prepared in (5), there could be a 20% to 30% improvement in residual magnetic flux density compared to a bond magnet containing resin (Comparative Example 1). According to the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets which was less than the heat demagnetization rate with no SiO₂ infiltration (5%). Furthermore, the irreversible heat demagnetization rate after treating the magnet at 200° C. for 1 hour, cooling to room temperature and then remagnetizing was less than 1% in the infiltration heat-treated magnet, while it was nearly 3% in the epoxy-based bond magnet (Comparative Example 1). This was because infiltration allowed the powder surf aces with cracks to be protected by the SiO2, thus limiting corrosion such as oxidation and reducing the irreversible heat demagnetization rate. In other words, since powder surfaces containing cracks were protected by the infiltration of the SiO₂ precursor, corrosion from oxidation and the like was limited, and the irreversible heat demagnetization rate was reduced. Not only was the irreversible heat demagnetization rate limited, but the infiltrated magnets showed less demagnetization in Pressure Cooker Tests (PCT) and salt-spray tests as well.

The compression molded test pieces with 10 mm length, 10 mm width and 5 mm thickness that were produced in (5) were kept in a 225° C. atmosphere for 1 hour and the demagnetization was measured after cooling at 20° C. The direction of application of the magnetic field was in the 10 mm direction. Initially, a magnetic field of +20 kOe was applied and then alternating positive and negative magnetic fields from ±1 kOe to ±10 kOe was applied to perform demagnetization. Residual magnetic flux density at each applied magnetic field was measured and a demagnetization curve was prepared based on the results of the measurement.

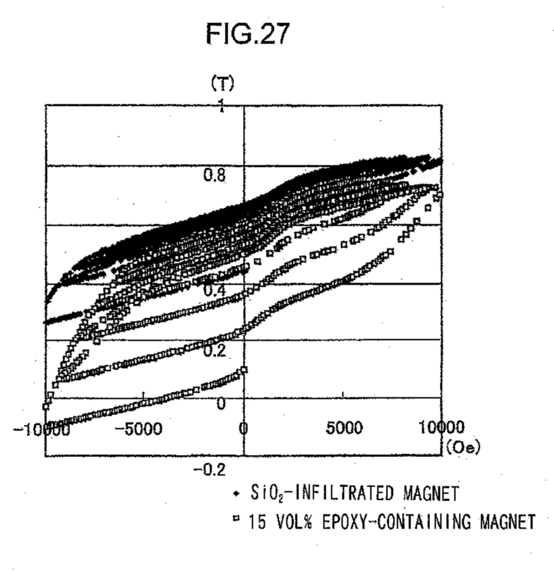

The results are shown in FIG. 27. In this figure, demagnetization curves are compared between the infiltrated magnets prepared under the conditions indicated in 2) above and compression molded bond magnets containing epoxy resin as a binding agent at 15% by volume, described later. The horizontal axis in FIG. 27 indicates the applied magnetic field and the vertical axis indicates the residual magnetic flux density. When a magnetic field greater on the negative side than −8 kOe is applied, the infiltrated magnets show a sudden drop in magnetic flux. The compression molded bond magnets show a sudden drop in magnetic flux at a magnetic field value with an absolute value lower than that of the infiltrated magnets, with significant magnetic flux decline at magnetic fields greater on the negative side than −5 kOe. The residual magnetic flux density after application of a magnetic field of −10 kOe was 0.44 T for the infiltrated magnets and 0.11 T for the compression molded bond magnets, with the residual magnetic flux density of the infiltrated magnets having a value 4 times that of the compression molded bond magnets. This is believed to be due to reduction in the magnetic anisotropy of the NdFeB crystals in the NdFeB particles resulting from oxidation on the surfaces of the NdFeB particles and crack surfaces of the NdFeB particles during heating at 225° C., thus resulting in a reduction in coercivity and a tendency for inversion in magnetization when a negative magnetic field is applied. In contrast, with the infiltrated magnets, the NdFeB particles and the crack surfaces are coated by SiO₂ film, thus preventing oxidation during heating in an atmosphere and reducing the drop in coercivity.

The flexural strength of the compression molded test pieces with 15 mm length, 10 mm width and 2 mm thickness prepared in (7) was no more than 2 MPa before infiltration with SiO₂, but it became at least 30 MPa after SiO₂ infiltration and heating. When the SiO₂ precursor solutions in 2) and 3) of this example were used, it was possible to manufacture magnetic shaped bodies with flexural strengths of 100 MPa or higher.

The specific resistance of the magnets of the present invention had values that were approximately 10 times those of sintered rare-earth magnets but were approximately 1/10 of the value of compression-type rare-earth bond magnets. However, this is not a problem since eddy current loss is low at least for use in standard motors of 10,000 rotations or less.

Based on the results from this example, compared to standard rare-earth bond magnets containing resin, rare-earth bond magnets in which low-viscosity SiO₂ precursor of the present invention is infiltrated into a rare-earth magnet shaped body cold formed without resin according to the present invention showed an improvement of 20% to 30% magnetic characteristics, bend strengths in a range of a similar value to 3 times as highs a reduction in the irreversible heat demagnetization rate to half or less, and improved reliability of the magnet.

Table 2 summarizes the magnetic characteristics when binding agents 1) through 3) were used for the present example as well as for Example 2 through Example 5, described later.

TABLE 2
Characteristics of magnets infiltrated with SiO₂ precursor material

| | Composition of binding agent | | | | | |
|---|---|---|---|---|---|---|
| | | | Silicate | | | Dibutyltin |
| Binding | | Type of | compound | Water | Alcohol | dilaurate |
| agent | SiO₂ Precursor material | alcohol | (ml) | (ml) | (ml) | (ml) |
| Example 1-1) | CH₃O—(Si(CH₃O)₂—O)ₘ—CH₃, average m is 4 | Methanol | 5.0 | 0.96 | 95 | 0.05 |
| Example 1-2) | CH₃O—(Si(CH₃O)₂—O)ₘ—CH₃, average m is 4 | Methanol | 25 | 4.8 | 75 | 0.05 |
| Example 1-3) | CH₃O—(Si(CH₃O)₂—O)ₘ—CH₃, average m is 4 | Methanol | 100 | 3.84 | 0.0 | 0.05 |
| Example 2-1) | CH₃O—(Si(CH₃O)₂—O)ₘ—CH₃, average m is 4 | Methanol | 25 | 0.96 | 75 | 0.05 |
| Example 2-2) | CH₃O—(Si(CH₃O)₂—O)ₘ—CH₃, average m is 4 | Methanol | 25 | 4.8 | 75 | 0.05 |
| Example 2-3) | CH₃O—(Si(CH₃O)₂—O)ₘ—CH₃, average m is 4 | Methanol | 25 | 9.6 | 75 | 0.05 |
| Example 3-1) | CH₃O—Si(CH₃O)₂—OCH₃ | Methanol | 25 | 5.9 | 75 | 0.05 |
| Example 3-2) | CH₃O—(Si(CH₃O)₂—O)ₘ—CH₃, average m is 4 | Methanol | 25 | 4.8 | 75 | 0.05 |
| Example 3-3) | CH₃O—(Si(CH₃O)₂—O)ₘ—CH₃, average m is 7 | Methanol | 25 | 4.6 | 75 | 0.05 |
| Example 4-1) | CH₃O—Si(CH₃O)₂—OCH₃ | Methanol | 25 | 5.9 | 75 | 0.05 |
| Example 4-2) | C₂H₅O—Si(C₂H₅O)₂—OC₂H₅ | Ethanol | 25 | 4.3 | 75 | 0.06 |
| Example 4-3) | n-C₃H₇O—Si(n-C₃H₇O)₂—O-n-C₃H₇ | Isopropanol | 25 | 3.4 | 75 | 0.05 |
| Example 5-1) | CH₃O—(Si(CH₃O)₂—O)ₘ—CH₃, average m is 4 | Methanol | 25 | 9.6 | 75 | 0.05 |
| Example 5-2) | CH₃O—(Si(CH₃O)₂—O)ₘ—CH₃, average m is 4 | Methanol | 25 | 9.6 | 75 | 0.05 |
| Example 5-3) | CH₃O—(Si(CH₃O)₂—O)ₘ—CH₃, average m is 4 | Methanol | 25 | 9.6 | 75 | 0.05 |

| | | | | Magnetic characteristics of magnet | | |
|---|---|---|---|---|---|---|
| | | | | | | Irreversible |
| | | | | Residual | | heat |
| | | Flexural | Specific | magnetic | | demagnetization |
| Binging | Viscosity | strength | resistance | flux density | Coercivity | rate |
| agent | (mPa · s) | (MPa) | (Ωcm) | (MG) | (kOe) | (%) |
| Example 1-1) | 1.8 | 35 | 0.0017 | 7.1 | 12.2 | <1 |
| Example 1-2) | 17 | 140 | 0.0019 | 6.8 | 12.2 | <1 |
| Example 1-3) | 80 | 210 | 0.0025 | 6.7 | 12.2 | <1 |
| Example 2-1) | 8.7 | 72 | 0.0016 | 6.9 | 12.2 | <1 |
| Example 2-2) | 17 | 140 | 0.0019 | 6.8 | 12.2 | <1 |
| Example 2-3) | 38 | 170 | 0.0031 | 6.7 | 12.2 | <1 |
| Example 3-1) | 3.9 | 110 | 0.0021 | 6.9 | 12.2 | <1 |
| Example 3-2) | 17 | 140 | 0.0019 | 6.9 | 12.2 | <1 |
| Example 3-3) | 56 | 150 | 0.0019 | 6.8 | 12.2 | <1 |
| Example 4-1) | 3.9 | 110 | 0.0021 | 6.9 | 12.2 | <1 |
| Example 4-2) | 2.6 | 94 | 0.0020 | 6.9 | 12.2 | <1 |
| Example 4-3) | 2.1 | 79 | 0.0019 | 7.0 | 12.2 | <1 |
| Example 5-1) | 23 | 130 | 0.0035 | 6.8 | 12.2 | <1 |
| Example 5-2) | 38 | 170 | 0.0031 | 6.7 | 12.2 | <1 |
| Example 5-3) | 92 | 180 | 0.0029 | 6.7 | 12.2 | <1 |

### EXAMPLE 2

In this example, magnetic powder crushed from NdFeB-based ribbons as in Example 1 was used as the rare-earth magnetic powder.

The following three solutions were used as the SiO₂ precursor, which is binding agent.

1) A mixture of 25 ml of CH₃O—(Si(CH₃O)₂—O)ₘ—CH₃ (m is 3 to 5, average 4), 0.96 ml of water, 75 ml of dehydrated methanol, and 0.05 ml of dibutyltin dilaurate was prepared and left standing at a temperature of 25° C. for 2 days.

2) A mixture of 25 ml of CH₃O—(Si(CH₃O)₂—O)ₘ—CH₃ (m is 3 to 5, average 4), 4.8 ml of water, 75 ml of dehydrated methanol, and 0.05 ml of dibutyltin dilaurate was prepared and left standing at a temperature of 25° C. for 2 days.

3) A mixture of 100 ml of CH₃O—(Si(CH₃O)₂—O)ₘ—CH₃ (m is 3 to 5, average 4), 9.6 ml of water, 75 ml of dehydrated methanol, and 0.05 ml of dibutyltin dilaurate was prepared and left standing at a temperature of 25° C. for 2 days.

The viscosities of the SiO₂ precursor solutions described 1) through 3) above were measured using an Ostwald viscometer at 30° C.

(1) Compression molded test pieces with 10 mm length, 10 mm width and 5 mm thickness for magnetic characteristic measurement and with 15 mm length, 10 mm width and 2 mm thickness for strength measurement were produced by filling molds with Nd₂Fe₁₄ magnetic powder, described above, and applying pressure at 16 t/cm².

(2) The compression molded test pieces prepared in (1) were disposed in a vat so that the direction of pressure application was horizontal, and the binding agent, SiO₂ precursor solution from 1) through 3) described above were poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) were measured by the 4-probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5). Samples of the compression molded pieces with a form of 15 mm×10 mm×2 mm were subjected to bending tests to evaluate flexural strength by 3 points bending tests with 12 mm distance between the points.

Regarding the magnetic characteristics of the compression molded test pieces with 10 mm lengths 10 mm width and 5 mm thickness prepared in (5), there could be a 20% to 30% improvement in residual magnetic flux density compared to a bond magnet containing resin (Comparative Example 1). Regarding the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets, which was less than the heat demagnetization rate with no SiO₂ infiltration (5%). Furthermore, after 1 hour in a 200° C. atmosphere, the irreversible heat demagnetization rate was no more than 1% after SiO₂ infiltration and heating, which was less than the value of almost 3% when no SiO₂ infiltration was involved. This is due to the SiO₂ limiting deterioration of the magnet particles due to oxidation.

The flexural strength of the compression molded test pieces with 15 mm length, 10 mm width and 2 mm thickness prepared in (7) was no more than 2 MPa before infiltration with SiO₂ but it became at least 70 MPa after SiO₂ infiltration and heating. When the SiO₂ precursor solution in 2) and 3) of this example were used, it was possible to manufacture magnetic shaped bodies with flexural strengths of 100 MPa or higher.

Regarding the specific resistance of the magnets, the magnets of the present invention had values that were approximately 10 times those of sintered rare-earth magnets but were approximately 1/10 of the value of compression-type rare-earth bond magnets. While there is some increase in eddy current loss, it is not enough to obstruct use.

Based on the results from this example, compared to standard rare-earth bond magnets containing resin, rare-earth bond magnets in which low-viscosity SiO₂ precursor of the present invention had been infiltrated into a rare-earth magnet shaped body cold formed without resin according to the present invention showed an improvement of 20% to 30% magnetic characteristics, bend strengths that were 2 to 3 times as high, a reduction in the irreversible heat demagnetization rate to half or less, and improved reliability of the magnet.

### EXAMPLE 3

In this example, magnetic powder crushed from NdFeB-based ribbons as in Example 1 was used as the rare-earth magnetic powder.

The following three solutions were used as the SiO₂ precursor, which is binding agent.

1) A mixture of 25 ml of CH₃O—(Si(CH₃O)₂—O)—CH₃, 5.9 ml of water, 75 ml of dehydrated methanol, and 0.05 ml of dibutyltin dilaurate was prepared and left standing at a temperature of 25° C. for 2 days.

2) A mixture of 25 ml of CH₃O—(Si(CH₃O)₂—O)ₘ—CH₃ (m is 3 to 5, average 4), 4.8 ml of water, 75 ml of dehydrated methanol, and 0.05 ml of dibutyltin dilaurate was prepared and left standing at a temperature of 25° C. for 2 days.

3) A mixture of 25 ml of CH₃O—(Si(CH₃O)₂—O)ₘ—CH₃ (m is 6 to 8, average 7), 4.6 ml of water, 75 ml of dehydrated methanol, and 0.05 ml of dibutyltin dilaurate was prepared and left standing at a temperature of 25° C. for 2 days.

The viscosities of the SiO₂ precursor solutions described above were measured using an Ostwald viscometer at 30° C.

(1) Compression molded test pieces with 10 mm length, 10 mm width and 5 mm thickness for magnetic characteristic measurement and with 15 mm length, 10 mm width and 2 mm thickness for strength measurement were produced by filling molds with Nd₂Fe₁₄ magnetic powder, described above, and applying pressure at 16 t/cm².

(2) The compression molded test pieces prepared in (1) were disposed in a vat so that the direction of pressure application was horizontal, and the binding agent, SiO₂ precursor solution from 1) through 3) described above were poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compress ion molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) were measured by the 4 probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5). Samples of the compression molded pieces with a form of 15 mm×10 mm×2 mm were subjected to bending tests to evaluate flexural strength by 3 points bending tests with 12 mm distance between the points.

Regarding the magnetic characteristics of the compression molded test pieces with 10 mm length, 10 mm width and 5 mm thickness prepared in (5), there could be a 20% to 30% improvement in residual magnetic flux density compared to a bond magnet containing resin (Comparative Example 1). Regarding the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets, which was less than the heat demagnetization rate with no SiO₂ infiltration (5%). Furthermore, after 1 hour in a 200° C. atmosphere, the irreversible heat demagnetization rate was no more than 1% after SiO₂ infiltration and heating, which was less than the value of almost 3% when no SiO₂ infiltration was involved. This is due to the SiO₂ limiting deterioration of the magnet particles due to oxidation.

The flexural strength of the compression molded test pieces with 15 mm length, 10 mm width and 2 mm thickness prepared in (7) was no more than 2 MPa before infiltration with SiO₂, but it became possible to manufacture magnetic shaped bodies with flexural strengths of 100 MPa or higher after SiO₂ infiltration and heating.

The specific resistance of the magnets of the present invention had values that were approximately 10 times those of sintered rare-earth magnets but were approximately 1/10 of the value of compression-type rare-earth bond magnets. However, this reduction in specific resistance is not a major problem. For example, in the case of use in a motor, the eddy current loss increases somewhat but not enough to pose a problem in practice.

Based on the results from this example, compared to standard rare-earth bond magnets containing resin, rare-earth bond magnets in which low-viscosity SiO₂ precursor of the present invention had been infiltrated into a rare-earth magnet shaped body cold formed without resin according to the present invention showed an improvement of 20% to 30% magnetic characteristics, bend strengths that were 2 to 3 times as high, a reduction in the irreversible heat demagnetization rate to half or less, and improved reliability of the magnet.

### EXAMPLE 4

In this example, magnetic powder crushed from NdFeB-based ribbons as in Example 1 was used as the rare-earth magnetic powder.

The following three solutions were used as the SiO₂ precursor, which is binding agent.

1) A mixture of 25 ml of CH₃O—(Si(CH₃O)₂—O)—CH₃, 5.9 ml of water, 75 ml of dehydrated methanol, and 0.05 ml of dibutyltin dilaurate was prepared and left standing at a temperature of 25° C. for 2 days.

2) A mixture of 25 ml of C₂H₅O—(Si(C₂H₅O)₂—O)—CH₃, 4.3 ml of water, 75 ml of dehydrated methanol, and 0.05 ml of dibutyltin dilaurate was prepared and left standing at a temperature of 25° C. for 3 days.

3) A mixture of 25 ml of n-C₃H₇O—(Si(C₂H₅O)₂—O)-n-C₃H₇, 3.4 ml of water, 75 ml of dehydrated isopropanol, and 0.05 ml of dibutyltin dilaurate was prepared and left standing at a temperature of 25° C. for 6 days.

The viscosities of the SiO₂ precursor solutions described above were measured using an Ostwald viscometer at 30° C.

(1) Compression molded test pieces with 10 mm length, 10 mm width and 5 mm thickness for magnetic characteristic measurement and with 15 mm length, 10 mm width and 2 mm thickness for strength measurement were produced by filling molds with Nd₂Fe₁₄ magnetic powder, described above, and applying pressure at 16 t/cm².

(2) The compression molded test pieces prepared in (1) were disposed in a vat so that the direction of pressure application was horizontal, and the binding agent, SiO₂ precursor solution from 1) through 3) described above were poured into the vat at a rate of liquid surf ace rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) were measured by the 4 probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5). Samples of the compression molded pieces with a form of 15 mm×10 mm×2 mm were subjected to bending tests to evaluate flexural strength by 3 points bending tests with 12 mm distance between the points.

Regarding the magnetic characteristics of the compression molded test pieces with 10 mm length, 10 mm width and 5 mm thickness prepared in (5), there could be a 20% to 30% improvement in residual magnetic flux density compared to a bond magnet containing resin (Comparative Example 1). Regarding the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets, which was less than the heat demagnetization rate with no SiO₂ infiltration (5%). Furthermore, after 1 hour in a 200° C. atmosphere, the irreversible heat demagnetization rate was no more than 1% after SiO₂ infiltration and heating, which was less than the value of almost 3% when no SiO₂ infiltration was involved. This is due to the SiO₂ limiting deterioration of the magnet particles due to oxidation.

The flexural strength of the compression molded test pieces with 15 mm length, 10 mm width and 2 mm thickness prepared in (7) was no more than 2 MPa before infiltration with SiO₂, but it became possible to manufacture magnetic shaped bodies with flexural strengths of 80 MPa or higher after SiO₂ infiltration and heating.

Regarding the specific resistance of the magnets, the magnets of the present invention had values that were approximately 10 times those of sintered rare-earth magnets but were approximately 1/10 of the value of compression-type rare-earth bond magnets. While there is an increase somewhat in eddy current loss, this degree of reduction in specific resistance is not enough to pose a problem.

Based on the results from this example, compared to standard rare-earth bond magnets containing resin, rare-earth bond magnets in which low-viscosity SiO₂ precursor of the present invention had been infiltrated into a rare-earth magnet shaped body cold formed without resin according to the present invention showed an improvement of 20% to 30% magnetic characteristics, bend strengths that were approximately 2 times as high, a reduction in the irreversible heat demagnetization rate to half or less, and improved reliability of the magnet.

### EXAMPLE 5

In this example, magnetic powder crushed from NdFeB-based ribbons as in Example 1 was used as the rare-earth magnetic powder.

The following three solutions were used as the SiO₂ precursor, which is binding agent.

1) A mixture of 25 ml of CH₃O—(Si(CH₃O)₂—O)ₘ—CH₃ (m is 3 to 5, average 4), 9.6 ml of water, 75 ml of dehydrated methanol, and 0.05 ml of dibutyltin dilaurate was prepared and left standing at a temperature of 25° C. for 1 day.

2) A mixture of 25 ml of CH₃O—(Si(CH₃O)₂—O)ₘ—CH₃ (m is 3 to 5, average 4), 9.6 ml of water, 75 ml of dehydrated methanol, and 0.05 ml of dibutyltin dilaurate was prepared and left standing at a temperature of 25° C. for 2 days.

3) A mixture of 100 ml of CH₃O—(Si(CH₃O)₂—O)ₘ—CH₃ (m is 3 to 5, average 4), 9.6 ml of water, 75 ml of dehydrated methanol, and 0.05 ml of dibutyltin dilaurate was prepared and left standing at a temperature of 25° C. for 4 days.

The viscosities of the SiO₂ precursor solutions described above were measured using an Ostwald viscometer at 30° C.

(1) Compression molded test pieces with 10 mm length, 10 mm width and 5 mm thickness for magnetic characteristic measurement and with 15 mm length, 10 mm width and 2 mm thickness for strength measurement were produced by filling molds with Nd₂Fe₁₄ magnetic powder, described above, and applying pressure at 16 t/cm².

(2) The compression molded test pieces prepared in (1) were disposed in a vat so that the direction of pressure application was horizontal, and the binding agent, SiO₂ precursor solution from 1) through 3) described above were poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) were measured by the 4 probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5). Samples of the compression molded pieces with a form of 15 mm×10 mm×2 mm were subjected to bending tests to evaluate flexural strength by 3 points bending tests with 12 mm distance between the points.

Regarding the magnetic characteristics of the compression molded test pieces with 10 mm length, 10 mm width and 5 mm thickness prepared in (5) described above, there could be a 20% to 30% improvement in residual magnetic flux density compared to a bond magnet containing resin (Comparative Example 1). Regarding the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets, which was less than the heat demagnetization rate with no SiO₂ infiltration (5%). Furthermore, after 1 hour in a 200° C. atmosphere, the irreversible heat demagnetization rate was no more than 1% after SiO₂ infiltration and heating, which was less than the value of almost 3% when no SiO₂ infiltration was involved. This is due to the SiO₂ limiting deterioration of the magnet particles due to oxidation.

The flexural strength of the compression molded test pieces with 15 mm length, 10 mm width and 2 mm thickness prepared in (7) described above was no more than 2 MPa before in filtration with SiO₂, but it became possible to manufacture magnetic shaped bodies with flexural strengths of 130 MPa or higher after SiO₂ infiltration and heating.

Regarding the specific resistance of the magnets, the magnets of the present invention had values that were approximately 10 times those of sintered rare-earth magnets but were approximately 1/10 of the value of compression-type rare-earth bond magnets. While there is an increase somewhat in eddy current loss, this degree of reduction in specific resistance is not enough to pose a problem.

Based on the results from this example, compared to standard rare-earth bond magnets containing resin, rare-earth bond magnets in which low-viscosity SiO₂ precursor of the present invention had been infiltrated into a rare-earth magnet shaped body cold formed without resin according to the present invention showed an improvement of 20% to 30% magnetic characteristics, bend strengths that were 3 to 4 times as high, a reduction in the irreversible heat demagnetization rate to half or less, and improved reliability of the magnet.

### EXAMPLE 6

In this example, magnetic powder crushed from NdFeB-based ribbons as in Example 1 was used as the rare-earth magnetic powder.

A solution for forming a rare-earth fluoride or an alkaline earth metal fluoride coat film was prepared in the following manner.

(1) A salt with high water-solubility is placed in water, e.g., in the case of La, 4 g of acetic acid La or nitric acid La in 100 ml water, and completely dissolved with a shaker or an ultrasonic mixer.

(2) Hydrofluoric acid diluted to 10% was slowly added up to an equivalent amount of the chemical reaction generating LaF₃.

(3) The solution, in which gel-like precipitates of LaF₃ were formed, was stirred using an ultrasonic mixer for 1 hour or longer.

(4) After centrifugation at 4,000 to 6,000 rpm, the supernatant was removed. Then, approximately the same volume of methanol was added thereto.

(5) After stirring the methanol solution containing gel-like LaF₃ to prepare homogeneous suspension, the suspension was further stirred for 1 hour or longer using an ultrasonic mixer.

(6) The operations of (4) and (5) described above were repeated 3 to 10 times until negative ions, e.g., acetate ions or nitrate ions, were no longer detected.

(7) Finally, almost transparent sol-like LaF₃ was obtained in the case of LaF₃. For the treatment solution, was dissolved in methanol at 1 g/5 ml.

Table 3 summarizes other rare-earth fluoride and alkaline earth metal fluoride coat film solutions that were used.

TABLE 3
Characteristics of powder magnet from magnetic powder formed with rare-earth fluoride,
alkaline earth metal fluoride coat film

| | | Amount | | | | | | | |
|---|---|---|---|---|---|---|---|---|---|
| | | of | | | | | | | |
| | | treatment | | | | | | | |
| | | liquid | | | | | Residual | | |
| | | added | | | | | Magnetic | | Irreversible |
| | | per 100 g | | | Flexural | Specific | flux | | heat |
| Treatment | | magnetic | | | strength | resistance | density | Coercivity | demagnetization |
| solution | Component | powder | Concentration | Solvent | (MPa) | (Ωcm) | (kG) | (kOe) | rate |
| Example 6-1) | MgF₂ | 15 ml | 100 g/dm³ | Methanol | 130 | 0.032 | 6.6 | 12.2 | <1 |
| Example 6-2) | CaF₂ | 15 ml | 100 g/dm³ | Methanol | 100 | 0.026 | 6.5 | 12.2 | <1 |
| Example 6-3) | LaF₃ | 15 ml | 100 g/dm³ | Methanol | 120 | 0.03 | 6.5 | 12.3 | <1 |
| Example 6-4) | LaF₃ | 15 ml | 100 g/dm³ | Ethanol | 97 | 0.027 | 6.4 | 12.5 | <1 |
| Example 6-5) | LaF₃ | 15 ml | 100 g/dm³ | n-Propanol | 76 | 0.025 | 6.5 | 12.3 | <1 |
| Example 6-6) | LaF₃ | 15 ml | 100 g/dm³ | Isopropanol | 54 | 0.021 | 6.6 | 12.3 | <1 |
| Example 6-7) | CeF₃ | 15 ml | 100 g/dm³ | Methanol | 110 | 0.029 | 6.5 | 12.3 | <1 |
| Example 6-8) | PrF₃ | 15 ml | 100 g/dm³ | Methanol | 110 | 0.031 | 6.4 | 13.8 | <1 |
| Example 6-9) | NdF₃ | 15 ml | 100 g/dm³ | Methanol | 110 | 0.028 | 6.6 | 12.5 | <1 |
| Example 6-10) | SmF₃ | 15 ml | 100 g/dm³ | Methanol | 75 | 0.023 | 6.6 | 12.5 | <1 |
| Example 6-11) | EuF₃ | 15 ml | 100 g/dm³ | Methanol | 73 | 0.022 | 6.5 | 12.4 | <1 |
| Example 6-12) | GdF₃ | 15 ml | 100 g/dm³ | Methanol | 69 | 0.023 | 6.4 | 12.3 | <1 |
| Example 6-13) | TbF₃ | 15 ml | 100 g/dm³ | Methanol | 70 | 0.025 | 6.4 | 18.9 | <1 |
| Example 6-14) | DyF₃ | 15 ml | 100 g/dm³ | Methanol | 68 | 0.026 | 6.3 | 18.5 | <1 |
| Example 6-15) | HoF₃ | 15 ml | 100 g/dm³ | Methanol | 57 | 0.024 | 6.4 | 12.6 | <1 |
| Example 6-16) | ErF₃ | 15 ml | 100 g/dm³ | Methanol | 52 | 0.021 | 6.5 | 12.5 | <1 |
| Example 6-17) | TmF₃ | 15 ml | 100 g/dm³ | Methanol | 56 | 0.023 | 6.5 | 12.9 | <1 |
| Example 6-18) | YbF₃ | 15 ml | 100 g/dm³ | Methanol | 53 | 0.025 | 6.4 | 12.2 | <1 |
| Example 6-19) | LuF₃ | 15 ml | 100 g/dm³ | Methanol | 50 | 0.027 | 6.1 | 12.3 | <1 |
| Example 7-1) | PrF₃ | 1 ml | 10 g/dm³ | Methanol | 130 | 0.018 | 6.3 | 13.1 | <1 |
| Example 7-2) | PrF₃ | 10 ml | 10 g/dm³ | Methanol | 120 | 0.018 | 6.5 | 13.5 | <1 |
| Example 7-3) | PrF₃ | 30 ml | 10 g/dm³ | Methanol | 120 | 0.018 | 6.4 | 13.6 | <1 |
| Example 8-1) | DyF₃ | 10 ml | 1 g/dm³ | Methanol | 130 | 0.017 | 6.5 | 13.5 | <1 |
| Example 8-2) | DyF₃ | 10 ml | 10 g/dm³ | Methanol | 110 | 0.017 | 6.6 | 15.5 | <1 |
| Example 8-3) | DyF₃ | 10 ml | 200 g/dm³ | Methanol | 42 | 0.036 | 6.5 | 18.5 | <1 |

Rare-earth fluoride or alkaline earth metal fluoride coat film was formed on the Nd₂Fe₁₄ magnetic powder using the following process.

The case of NdF₃ coat film forming process: NdF₃ concentration 1 g/10 ml, semitransparent sol-like solution.

(1) Fifteen ml of NdF₃ coat film forming solution was added to 100 g of the magnetic powder prepared by crushing an NdFeB-based ribbon and mixed until wetness of all the magnetic powder for rare-earth magnet was confirmed.

(2) Solvent methanol was removed from the magnetic powder for rare-earth magnet, which underwent the NdF₃ coat film forming treatment as described in (1), under reduced pressure of 2 torr to 5 torr.

(3) The magnetic powder for rare-earth magnet that underwent solvent removal as described in (2) was transferred to a quartz boat, and heated at 200° C. for 30 minutes and at 400° C. for 30 minutes under reduced pressure of 1×10⁻⁵ torr.

(4) The magnetic powder that underwent heat treatment as described in (3) was transferred to a container with a lid made of Macor (Riken Denshi Co., Ltd.) and then heated at 700° C. for 30 minutes under reduced pressure of 1×10⁻⁵ torr.

For the SiO₂ precursor, which is binding agent, 25 ml of CH₃₀—(Si(CH₃O)₂—O)ₘ—CH₃ (m is 3 to 5, average 4), 4.8 ml of water, 75 ml of dehydrated methanol, and 0.05 ml of dibutyltin dilaurate were mixed and left standing at a temperature of 25° C. for 2 days.

(1) The magnetic powder of Nd₂Fe₁₄ that was coated with the rare-earth fluoride or alkaline earth metal fluoride coat film was placed in molds, and a test piece for measuring the magnetic characteristic with a dimension of 10 mm length, 10 mm width and 5 mm thickness and a compression molded test piece for measuring the strength with a dimension of 15 mm length, 10 mm width and 2 mm thickness were produced under the pressure of 16 t/cm².

(2) The compression molded test pieces prepared in (1) described above were disposed in a vat so that the direction of pressure application was horizontal, and the binding agent, SiO₂ precursor solution left standing for 2 days at a temperature of 25° C. was poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) described above were measured by the 4 probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5) described above. Samples of the compression molded pieces with a form of 15 mm×10 mm×2 mm were subjected to bending tests to evaluate flexural strength by 3 points bending tests with 12 mm distance between the points.

Regarding the magnetic characteristics of the compression molded test pieces with 10 mm length, 10 mm width and 5 mm thickness prepared in (5) described above, there could be a 20% to 30% improvement in residual magnetic flux density compared to a bond magnet containing resin (Comparative Example 1). Regarding the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets, which was less than the heat demagnetization rate with no SiO₂ infiltration (5%). Furthermore, after 1 hour in a 200° C. atmosphere, the irreversible heat demagnetization rate was no more than 1% after SiO₂ infiltration and heating, which was less than the value of almost 3% when no SiO₂ infiltration was involved. This is due to the SiO₂ limiting deterioration of the magnet particles due to oxidation.

In addition to the advantages described later of the presence of an insulating film, with the magnet of this example, in which a rare-earth fluoride or alkaline earth metal fluoride coat film was formed on rare-earth magnetic powder, it was found that the coercivity of magnets could be improved by the use in the coat film of TbF₃ and DyF₃, and to a lesser extent of PrF₃.

The flexural strength of the compression molded test pieces with 15 mm length, 10 mm width and 2 mm thickness prepared in (7) described above was no more than 2 MPa before in filtration with SiO₂, but it became possible to manufacture magnetic shaped bodies with flexural strengths of 50 MPa or higher and heating.

Regarding the specific resistance of the magnets, the magnets of the present invention had values that were approximately 100 times or more those of sintered rare-earth magnets and were approximately the same value as compression-type rare-earth bond magnets. Thus, the magnet has low eddy current loss and good characteristics.

Based on the results from this example, compared to standard rare-earth bond magnets containing resin, rare-earth bond magnets in which low-viscosity SiO₂ precursor of the present invention had been infiltrated into a rare-earth magnet shaped body cold formed without resin according to the present invention showed an improvement of approximately 20% in magnetic characteristics, bend strengths that were 1 to 3 times as high, a reduction in the irreversible heat demagnetization rate to half or less, and improved reliability of the magnet. In addition, there was a significant improvement in magnetic characteristics when TbF₃ and DyF₃ were used in forming the coat film.

### EXAMPLE 7

In this example, magnetic powder crushed from NdFeB-based ribbons as in Example 1 was used as the rare-earth magnetic powder.

A rare-earth fluoride or an alkaline earth metal fluoride coat film was formed on the Nd₂Fe₁₄B magnetic powder according to the following process.

In the case of PrF₃ coat film forming process, a semitransparent sol-like solution a PrF₃ concentration 0.1 g/10 ml was used.

(1) One to 30 ml of PrF₃ coat film forming solution was added to 100 g of the magnetic powder prepared by crushing an NdFeB-based ribbon and mixed until wetness of all the magnetic powder for rare-earth magnet was confirmed.

(2) Solvent methanol was removed from the magnetic powder for rare-earth magnet, which underwent the PrF₃ coat film forming treatment as described in (1), under reduced pressure of 2 torr to 5 torr.

(3) The magnetic powder for rare-earth magnet that underwent solvent removal as described in (2) was transferred to a quartz boat, and heated at 200° C. for 30 minutes and at 400° C. for 30 minutes under reduced pressure of 1×10⁻⁵ torr.

4) The magnetic powder that underwent heat treatment as described in (3) was transferred to a container with a lid made of Macor (Riken Denshi Co., Ltd.) and then heated at 700° C. for 30 minutes under reduced pressure of 1×10⁻⁵ torr.

For the SiO₂ precursor, which is binding agent, 25 ml of CH₃O—(Si(CH₃O)₂—O)ₘ—CH₃ (m is 3 to 5, average 4), 4.8 ml of water, 75 ml of dehydrated methanol, and 0.05 ml of dibutyltin dilaurate were mixed and left standing at a temperature of 25° C. for 2 days.

(1) The magnetic powder of Nd₂Fe₁₄B that was coated with the PrF₃ coat film was placed in molds, and a test piece for measuring the magnetic characteristic with a dimension of 10 mm length, 10 mm width and 5 mm thickness and a compression molded test piece for measuring the strength with a dimension of 15 mm length, 10 mm width and 2 mm thickness were produced under the pressure of 16 t/cm².

(2) The compression molded test pieces prepared in (1) described above were disposed in a vat so that the direction of pressure application was horizontal, and the binding agent, SiO₂ precursor solution left standing for 2 days at a temperature of 25° C. was poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) described above were measured by the 4 probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5) described above. Samples of the compression molded pieces with a form of 15 mm×10 mm×2 mm were subjected to bending tests to evaluate flexural strength by 3 points bending tests with 12 mm distance between the points.

Regarding the magnetic characteristics of the compression molded test pieces with 10 mm length, 10 mm width and 5 mm thickness prepared in (5), there could be a 20% to 30% improvement in residual magnetic flux density compared to a bond magnet containing resin (Comparative Example 1). Regarding the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets, which was less than the heat demagnetization rate with no SiO₂ infiltration (5%). Furthermore, after 1 hour in a 200° C. atmosphere, the irreversible heat demagnetization rate was no more than 1% after SiO₂ infiltration and heating, which was less than the value of almost 3% when no SiO₂ infiltration was involved. This is due to the SiO₂ limiting deterioration of the magnet particles due to oxidation.

In addition to the advantages described later of the presence of an insulating film, with the magnet of this example, in which a PrF₃ coat film is formed on rare-earth magnetic powder, it was found that while the effect was small, the coercivity of the magnet could be improved.

The flexural strength of the compression molded test pieces with 15 mm length, 10 mm width and 2 mm thickness prepared in (7) described was no more than 2 MPa before infiltration with SiO₂, but it became possible to manufacture magnetic shaped bodies with flexural strengths of 100 MPa or higher after SiO₂ infiltration and heating.

Regarding the specific resistance of the magnets, the magnets of the present invention had values that were approximately 100 times or more those of sintered rare-earth magnets and were approximately the same value as compression-type rare-earth bond magnets. Thus, the magnet has low eddy current loss and good characteristics.

Based on the results from this example, compared to standard rare-earth bond magnets containing resin, rare-earth bond magnets in which low-viscosity SiO₂ precursor of the present invention had been infiltrated into a rare-earth magnet shaped body cold formed without resin according to the present invention showed an improvement of approximately 20% in magnetic characteristics, bend strengths that were 2 to 3 times as high, a reduction in the irreversible heat demagnetization rate to half or less, and improved reliability of the magnet. In addition, there was an improvement in magnetic characteristics when PrF₃ was used in forming the coat film. It was found that magnets using rare-earth magnetic powder formed with a PrF₃ coat film provided a well-balanced magnet with overall improvements in magnetic characteristics, bend strength, and reliability.

### EXAMPLE 8

In this example, magnetic powder crushed from NdFeB-based ribbons as in Example 1 was used.

A rare-earth fluoride or alkaline earth metal fluoride coat film was formed on the Nd₂Fe₁₄B magnetic powder according to the following process.

In the case of DyF₃ coat film forming process, a semitransparent sol-like solution having a DyF₃ concentration of 2 to 0.01 g/10 ml was used.

(1) Ten ml of DyF₃ coat film forming solution was added to 100 g of the magnetic powder prepared by crushing an NdFeB-based ribbon and mixed until wetness of all the magnetic powder for rare-earth magnet was confirmed.

(2) Solvent methanol was removed from the magnetic powder for rare-earth magnet, which underwent the DyF₃ coat film forming treatment as described in (1), under reduced pressure of 2 torr to 5 torr.

(3) The magnetic powder for rare-earth magnet that underwent solvent removal as described in (2) was transferred to a quartz boat, and heated at 200° C. for 30 minutes and at 400° C. for 30 minutes under reduced pressure of 1×10⁻⁵ torr.

(4) The magnetic powder that underwent heat treatment as described in (3) was transferred to a container with a lid made of Macor (Riken Denshi Co., Ltd.) and then heated at 700° C. for 30 minutes under reduced pressure of 1×10⁻⁵ torr.

For the SiO₂ precursor, which is binding agent, 25 ml of CH₃O—(Si(CH₃O)₂—O)ₙ—CH₃ (m is 3 to 5, average 4), 4.8 ml of water, 75 ml of dehydrated methanol, and 0.05 ml of dibutyltin di-laurate were mixed and left standing at a temperature of 25° C. for 2 days.

(1) The magnetic powder of Nd₂Fe₁₄B that was coated with the DyF₃ coat film was placed in molds, and a test piece for measuring the magnetic characteristic with a dimension of 10 mm length, 10 mm width and 5 mm thickness and a compression molded test piece for measuring the strength with a dimension of 15 mm length, 10 mm width and 2 mm thickness were produced under the pressure of 16 t/cm².

(2) The compression molded test pieces prepared in (1) described above were disposed in a vat so that the direction of pressure application was horizontal, and the binding agent, SiO₂ precursor solution left standing for 2 days at a temperature of 25° C. was poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test pieces that had been infiltrated with the SiO₂ precursor solutions prepared in (4) described above were set in a vacuum drying oven and vacuum heat-treated under the conditions of a pressure of 1 Pa to 3 Pa and a temperature of 150° C.

(6) The specific resistances of the compression molded test pieces with 10 mm length, 10 mm width and 5 mm thickness that were produced in (5) described above were measured by the 4 probe method.

(7) Further, a pulse magnetic field of 30 kOe or above was applied to the compression molded test pieces, which were subjected to the specific resistance measurement as described above, and the magnetic characteristic of the compression molded test piece was investigated.

(8) A mechanical bending test was conducted using the compression molded test pieces with 15 mm length, 10 mm width and 2 mm thickness that were produced in (5) described above. Samples of the compression molded pieces with a form of 15 mm×10 mm×2 mm were subjected to bending tests to evaluate flexural strength by 3 points bending tests with 12 mm distance between the points.

Regarding the magnetic-characteristics of the compression molded test pieces with 10 mm length, 10 mm width and 5 mm thickness prepared in (5) described above, there could be a 20% to 30% improvement in residual magnetic flux density compared to a bond magnet containing resin (Comparative Example 1) Regarding the demagnetization curve prepared based on measurement at 20° C., the residual magnetic flux density and coercivity values were roughly the same for shaped bodies before SiO₂ infiltration and after SiO₂ infiltration and heating. Also, the heat demagnetization rate after 1 hour in a 200° C. atmosphere was 3.0% for SiO₂ infiltrated bond magnets, which was less than the heat demagnetization rate with no Sio₂ infiltration (5%). Furthermore, after 1 hour in a 200° C. atmosphere, the irreversible heat demagnetization rate was no more than 1% after SiO₂ infiltration and heating, which was less than the value of almost 3% when no SiO₂ infiltration was involved. This is due to the SiO₂ limiting deterioration of the magnet particles due to oxidation.

In addition to the advantages described later of the presence of an insulating film, with the magnet of this example, in which a Dy F₃ coat film is formed on rare-earth magnetic powder, it was found that the coercivity of the magnet was improved.

The flexural strength of the compression molded test pieces with 15 mm length, 10 mm width and 2 mm thickness prepared in (7) described above was no more than 2 MPa before in filtration with SiO₂, but it became possible to manufacture magnetic shaped bodies with flexural strengths of 40 MPa or higher after SiO₂ infiltration and heating.

Regarding the specific resistance of the magnets, the magnets of the present invention had values that were approximately 100 times or more those of sintered rare-earth magnets and were approximately the same value as compression-type rare-earth bond magnets. Thus, the magnet has low eddy current loss and good characteristics.

Based on the results from this example, compared to standard rare-earth bond magnets containing resin, rare-earth bond magnets in which low-viscosity SiO₂ precursor of the present invention had been infiltrated into a rare-earth magnet shaped body cold formed without resin according to the present invention showed an improvement of approximately 20% in magnetic characteristics, bend strengths that were 1 to 3 times as high, a reduction in the irreversible heat demagnetization rate to halt or less, and improved reliability of the magnet. In addition, there was a significant improvement in magnetic characteristics when TbF₃ and DyF₃ were used in forming the coat film.

### EXAMPLE 9

In this example, magnetic powder crushed from NdFeB-based ribbons as in Example 1 was used as the rare-earth magnetic powder.

A solution for forming a phosphatized film was prepared as follows.

Twenty grams (20 g) of phosphoric acid, 4 g of boric acid and 4 g of MgO, ZnO, CdO, CaO, or BaO as a metal oxide were dissolved in 1 liter of water and a surfactant, EF-104 (Tohkem Products Co., Ltd.), EF-122 (Tohkem Products Co., Ltd.), EF-132 (Tohkem Products Co., Ltd.) was added to achieve concentration of 0.1 wt %. As an antirust agent, benzotriazole (BT), imidazole (IZ), benzoimidazole (BI), thiourea (TU), 2-mercaptobenzoimidazole (MI), octylamine (OA), triethanolamine (TA), o-toluidine (TL), indole (ID), 2-methylpyrrole (MP) were added to achieve 0.04 mol/l.

The following method was used to carry out the process for forming the phosphatized film on the magnetic powder of Nd₂Fe₁₄B. The compositions of the phosphatized solution that were used are shown in Table 4.

TABLE 4
Characteristics of powder magnet from magnetic powder formed with phosphatized film

| | | | | | | Treatment |
|---|---|---|---|---|---|---|
| | | | | Concentration | | liquid |
| | | | | of | Concentration | added per |
| | Metal | | | Antirust | of | 100 g |
| Treatment | oxide | | Antirust | agent | surfactant | magnetic |
| solution | Component | Surfactant | agent | (mol/dm³) | (wt %) | powder |
| Example 9-1) | MgO | HF-104 | BT | 0.04 | 0.1 | 5 ml |
| Example 9-2) | ZnO | HF-104 | BT | 0.04 | 0.1 | 5 ml |
| Example 9-3) | CuO | HF-104 | BT | 0.04 | 0.1 | 5 ml |
| Example 9-4) | CaO | HF-104 | BT | 0.04 | 0.1 | 5 ml |
| Example 9-5) | BaO | HF-104 | BT | 0.04 | 0.1 | 5 ml |
| Example 9-6) | MgO | HF-122 | BT | 0.04 | 0.1 | 5 ml |
| Example 9-7) | MgO | HF-132 | BT | 0.04 | 0.1 | 5 ml |
| Example 9-8) | MgO | HF-104 | IZ | 0.04 | 0.1 | 5 ml |
| Example 9-9) | MgO | HF-104 | BI | 0.04 | 0.1 | 5 ml |
| Example 9-10) | MgO | HF-104 | TU | 0.04 | 0.1 | 5 ml |
| Example 9-11) | MgO | HF-104 | MI | 0.04 | 0.1 | 5 ml |
| Example 9-12) | MgO | HF-104 | OA | 0.04 | 0.1 | 5 ml |
| Example 9-13) | MgO | HF-104 | TA | 0.04 | 0.1 | 5 ml |
| Example 9-14) | MgO | HF-104 | TL | 0.04 | 0.1 | 5 ml |
| Example 9-15) | MgO | HF-104 | ID | 0.04 | 0.1 | 5 ml |
| Example 9-16) | MgO | HF-104 | MP | 0.04 | 0.1 | 5 ml |
| Example 10-1) | MgO | HF-104 | BT | 0.01 | 0.1 | 5 ml |
| Example 10-2) | MgO | HF-104 | BT | 0.04 | 0.1 | 5 ml |
| Example 10-3) | MgO | HF-104 | BT | 0.5 | 0.1 | 5 ml |
| Example 11-1) | MgO | HF-104 | BT | 0.04 | 0.01 | 5 ml |
| Example 11-2) | MgO | HF-104 | BT | 0.04 | 0.1 | 5 ml |
| Example 11-3) | MgO | HF-104 | BT | 0.04 | 1 | 5 ml |
| Example 12-1) | MgO | HF-104 | BT | 0.04 | 0.1 | 25 ml |
| Example 12-2) | MgO | HF-104 | BT | 0.04 | 0.1 | 5 ml |
| Example 12-3) | MgO | HF-104 | BT | 0.04 | 0.1 | 30 ml |

| | | | Residual | | |
|---|---|---|---|---|---|
| | Flexural | Specific | Magnetic flux | | Irreversible heat |
| Treatment | strength | resistance | density | Coercivity | demagnetization |
| solution | (MPa) | (Ωcm) | (kG) | (kOe) | rate (%) |
| Example 9-1) | 150 | 0.038 | 6.8 | 12.2 | <1 |
| Example 9-2) | 140 | 0.036 | 6.8 | 12.2 | <1 |
| Example 9-3) | 140 | 0.034 | 6.8 | 12.2 | <1 |
| Example 9-4) | 130 | 0.036 | 6.8 | 12.2 | <1 |
| Example 9-5) | 110 | 0.031 | 6.8 | 12.1 | <1 |
| Example 9-6) | 140 | 0.036 | 6.7 | 12 | <1 |
| Example 9-7) | 140 | 0.035 | 6.8 | 12.1 | <1 |
| Example 9-8) | 130 | 0.036 | 6.8 | 12.1 | <1 |
| Example 9-9) | 140 | 0.036 | 6.7 | 12 | <1 |
| Example 9-10) | 120 | 0.031 | 6.6 | 11.8 | <1 |
| Example 9-11) | 130 | 0.034 | 6.7 | 12 | <1 |
| Example 9-12) | 120 | 0.033 | 6.7 | 11.9 | <1 |
| Example 9-13) | 120 | 0.032 | 6.7 | 12 | <1 |
| Example 9-14) | 130 | 0.03 | 6.6 | 11.7 | <1 |
| Example 9-15) | 110 | 0.03 | 6.6 | 11.8 | <1 |
| Example 9-16) | 140 | 0.035 | 6.7 | 12 | <1 |
| Example 10-1) | 140 | 0.031 | 6.7 | 12 | <1 |
| Example 10-2) | 150 | 0.038 | 6.8 | 12.2 | <1 |
| Example 10-3) | 120 | 0.041 | 6.8 | 12.2 | <1 |
| Example 11-1) | 130 | 0.03 | 6.8 | 12.2 | <1 |
| Example 11-2) | 150 | 0.038 | 6.8 | 12.2 | <1 |
| Example 11-3) | 90 | 0.045 | 6.8 | 12.2 | <1 |
| Example 12-1) | 140 | 0.03 | 6.6 | 11.8 | <1 |
| Example 12-2) | 150 | 0.038 | 6.8 | 12.2 | <1 |
| Example 12-3) | 140 | 0.075 | 6.6 | 12.2 | <1 |

(1) Five ml of phosphatized solution was added to 100 g of the magnetic powder prepared by crushing an NdFeB-based ribbon and mixed until wetness of all the magnetic powder for rare-earth magnet was confirmed.

(2) The magnetic powder for rare-earth magnet, which underwent the phosphatized film formation treatment as described in (1), was heated for 30 minutes at 180° C. under reduced pressure of 2 torr to 5 torr.

For the SiO₂ precursor, which is binding agent, 25 ml of CH₃O—(Si(CH₃O)₂—O)ₘ—CH₃ (m is 3 to 5, average 4), 4.8 ml of water, 75 ml of dehydrated methanol, and 0.05 ml of dibutyltin dilaurate were mixed and left standing at a temperature of 25° C. for 2 days.

(1) The magnetic powder of Nd₂Fe₁₄B that was coated with the phosphatized coat film was placed in molds, and a test piece for measuring the magnetic characteristic with a dimension of 10 mm length, 10 mm width and 5 mm thickness and a compression molded test piece for measuring the strength with a dimension of 15 mm length, 10 mm width and 2 mm thickness were produced under the pressure of 16 t/cm².

(2) The compression molded test pieces prepared in (1) described above were disposed in a vat so that the direction of pressure application was horizontal, and the binding agent, SiO₂ precursor solution left standing for 2 days at a temperature of 25° C. was poured into the vat at a rate of liquid surface rising vertically 1 mm/min until reaching to 5 mm above the upper face of the compression molded test pieces.

(3) The vat from (2) containing the compression molded test pieces and filled with the SiO₂ precursor solution was set in a vacuum chamber, and the air was exhausted slowly to about 80 Pa. The vat was left standing until few bubbles were generated from the surface of the compression molded test pieces.

(4) Internal pressure of the vacuum chamber, in which the vat containing the compression molded test pieces and filled with the SiO₂ precursor solution was set, was slowly returned to atmospheric pressure, and the compression molded test pieces were taken out of the SiO₂ precursor solution.

(5) The compression molded test piece which was infiltrated with the SiO₂ precursor solution produced in (4) described above was set inside a vacuum drying oven, and vacuum heating of the compression molded test piece was conducted under the conditions of a pressure of 1 Pa to 3 Pa and a temperature of 150° C.

(6) The specific resistance of the compression molded test piece of 10 mm length, 10 mm width, 5 mm thickness that was produced in (5) described above was measured by the 4 probe method.

(7) Further, a pulse magnetic field of 30 kOe or greater was applied to the compression molded test piece which was subjected to the specific resistance measurement as described above, and the magnetic characteristic of the compression molded test piece was investigated.

(8) Using the compression molded test piece of 15 mm length, 10 mm width, 2 mm thickness produced in (5) described above, a mechanical bending test was implemented. For the bending test, samples of the compression molded body with a form of 15 mm×10 mm×2 mm was used to evaluate the flexural strength by a 3 point flex test with a point distance of 12 mm.

With regard to the magnetic characteristic of the compression molded test piece of 10 mm length, 10 mm width, 5 mm thickness produced in (5), the residual magnetic flux density was improved 20% to 30% when compared to the resin containing bond magnet (Comparative Example 1). When the demagnetization curve prepared based on measurement at 20° C., the values of the residual magnetic flux density and coercivity were approximately the same between the molded products before and after SiO₂ infiltration and heat treatment. In addition, the heat demagnetization rate after 1 hour at 200° C. under atmosphere was 3.0% for the SiO₂ infiltrated bond magnet, which was lower than that of the bond magnet without SiO₂ infiltration (5%). Furthermore, after 1 hour at 200° C. in atmosphere, the irreversible heat demagnetization rate was 1% or less for the SiO₂ infiltration heat-treated magnet which was less than the nearly 3% for the magnet without SiO₂ infiltration. This is because the SiO₂ prevents deterioration from oxidation of the magnetic powder.

The flexural strength of the compressed molded test piece of 15 mm length, 10 mm width, 2 mm thickness produced in (7) described above was 2 MPa or less prior to SiO₂ infiltration. However, after SiO₂ infiltration and heat treatment, a molded magnetic product having a flexural strength of 100 MPa or greater could be produced.

Furthermore, the magnet of the present invention has a specific resistance value that is approximately 100 times or greater compared to that of sintered rare-earth magnets. Even compared with the compression-type rare-earth bond magnet, similar values were achieved.

Therefore, the characteristics are favorable with minimal eddy current loss.

As seen from the results of the present example, with the present invention, in which a low viscosity SiO₂ precursor is infiltrated into a rare-earth molded magnet product which is produced without resin and by a cold molding method, magnetic characteristics of the rare-earth bond magnet were improved 20% to 30%, flexural strength was approximately tripled, and the irreversible heat demagnetization rate was reduced to half or less as compared with the standard resin containing rare-earth bond magnet, and a magnet which was much more reliable could be produced.

### EXAMPLE 10

In the present example, as in Example 1, a magnetic powder prepared by grinding a thin ribbon of NdFeB was used for the rare-earth magnetic powder.

The treatment solution which forms the phosphatization film was produced as described below.

20 g of phosphoric acid, 4 g of boric acid, 4 g of MgO as the metal oxide were dissolved in 1 liter of water. For the surfactant, EF-104 (manufactured by Tohkem Products Co., Ltd.) was added to achieve 0.1 wt %. As an antirust agent, benzotriazole (BT) was used. This was added to achieve a concentration of 0.01 mol/l to 0.5 mol/l.

The formation of a phosphatization film on the magnetic powder of Nd₂Fe₁₄B was implemented by the following process.

(1) For 100 g of magnetic powder which was obtained by grinding an NdFeB thin ribbon, 5 ml of phosphatization solution was added. This was mixed until all of the magnetic powder for the rare-earth magnet was confirmed to be wet.

(2) Heat treatment of the magnetic powder for the rare-earth magnet which has had phosphatization film formation treatment according to (1) described above was conducted at 180° C. for 30 minutes under a reduced pressure of 2 torr to 5 torr.

For the SiO₂ precursor which is the binding agent, 25 ml of CH₃O—(Si(CH₃O)₂—O)ₘ—CH₃ (m is 3 to 5, average of 4), 4.8 ml of water, 75 ml of dehydrated methanol, and 0.05 ml of dibutyltin dilaurate were mixed, and this was left for 2 days at 25° C.

(1) Molds were filled with Nd₂Fe₁₄B magnetic powder which had had phosphatization film formation treatment as described above. Under pressure of 16 t/cm², a test piece of 10 mm length, 10 mm width, 5 mm thickness which will be used for measuring the magnetic characteristics and a compression molded test piece of 15 mm length, 10 mm width, 2 mm thickness which will be used to measure strength were produced.

(2) The compression molded test pieces produced in (1) described above were placed in a vat so that the pressurizing direction was horizontal. The SiO₂ precursor solution, which is the binding agent and which had been left for 2 days at a temperature of 25° C., was poured into the vat at a rate of liquid surface rising vertically of 1 mm/min until reaching to 5 mm above the upper face of the compression molded test piece.

(3) The compression molded test piece used in the above (2) was positioned, and the vat filled with the SiO₂ precursor solution was set inside a vacuum chamber. The air was exhausted slowly to approximately 80 Pa. The vat was left standing until few bubbles were generated from the surface of the compression molded test piece.

(4) The internal pressure of the vacuum chamber, in which the vat containing the compression molded test piece and filled with the SiO₂ precursor solution was set, was raised gradually to atmospheric pressure. The compression molded test piece was removed from the SiO₂ precursor solution.

(5) The compression molded test piece which was infiltrated with SiO₂ precursor solution as produced in (4) described above was set inside a vacuum drying oven, and vacuum heating of the compression molded test piece was conducted under the conditions of a pressure of 1 Pa to 3 Pa and a temperature of 150° C.

(6) The specific resistance of the compression molded test piece of 10 mm length, 10 mm width, 5 mm thickness that was produced in (5) described above was measured by the 4 probe method.

(7) Further, a pulse magnetic field of 30 kOe or greater was applied to the compression molded test piece which was subjected to the specific resistance measurement as described above, and the magnetic characteristic of the compression molded test piece was investigated.

(8) Using the compression molded test piece of 15 mm length, 10 mm width, 2 mm thickness produced in (5) described above, a mechanical bending test was implemented. For the bending test, samples of the compression molded body with a form of 15 mm×10 mm×2 mm was used to evaluate the flexural strength by a 3 point flex test with a point distance of 12 mm.

With regard to the magnetic characteristic of the compression molded test piece of 10 mm length, 10 mm width, 5 mm thickness produced in (5) described above, the residual magnetic flux density was improved 20% to 30% when compared to the resin containing bond magnet (Comparative Example 1). When the demagnetization curve was prepared based on measurement at 20° C., the values of the residual magnetic flux density and coercivity were approximately the same between the molded products before and after SiO₂ infiltration and heat treatment. In addition, the heat demagnetization rate after 1 hour at 200° C. under atmosphere was 3.0% for the SiO₂ infiltrated bond magnet, which was lower than that of the bond magnet without SiO₂ infiltration (5%). Furthermore, after 1 hour at 200° C. in atmosphere, the irreversible heat demagnetization rate was 1% or less for the SiO₂ infiltration heat-treated magnet which was less than the nearly 3% for the magnet without SiO₂ infiltration. This is because the SiO₂ prevents deterioration from oxidation of the magnetic powder.

The flexural strength of the compression molded test piece of 15 mm length, 10 mm width, 2 mm thickness produced in (7) described above was 2 MPa or less prior to SiO₂ infiltration. However, after SiO₂ infiltration and heat treatment, a molded magnetic product having a flexural strength of 100 MPa or greater could be produced.

Furthermore, the magnet of the present invention has a specific resistance value that is approximately 100 times or greater compared to that of sintered rare-earth magnets. Even compared with the compression-type rare-earth bond magnet, similar values were achieved. Therefore, the characteristics are favorable with minimal eddy current loss.

As seen from the results of the present example, with the present invention, in which a low viscosity SiO₂ precursor is infiltrated into a rare-earth molded magnet product which is produced without resin and by a cold molding method, magnetic characteristics of the rare-earth bond magnet were improved 20% to 30%, flexural strength was approximately tripled, and the irreversible heat demagnetization rate was reduced to half or less as compared with the standard resin containing rare-earth bond magnet, and a magnet which was much more reliable could be produced.

### EXAMPLE 11

In the present example, as in Example 1, a magnetic powder prepared by grinding a thin ribbon of NdFeB was used for the rare-earth magnetic powder.

The treatment solution which forms the phosphatization film was produced as described below.

20 g of phosphoric acid, 4 g of boric acid, 4 g of MgO as the metal oxide were dissolved in 1 liter of water. As an antirust agent, benzotriazole (BT) was added to achieve a concentration of 0.04 mol/l. For the surfactant, EF-104 (manufactured by Tohkem Products Co., Ltd.) was added to achieve a concentration of 0.01 wt % to 1 wt %.

The formation of a phosphatization film on the magnetic powder of Nd₂Fe₁₄B was implemented by the following process.

(1) For 100 g of magnetic powder which was obtained by grinding an NdFeB thin ribbon, 5 ml of phosphatization treatment solution was added. This was mixed until all of the magnetic powder for the rare-earth magnet was confirmed to be wet.

(2) Heat treatment of the magnetic powder for the rare-earth magnet which has had phosphatization film formation treatment according to (1) was conducted at 180° C. for 30 minutes under a reduced pressure of 2 torr to 5 torr.

For the SiO₂ precursor which is the binding agent, 25 ml of CH₃O—(Si(CH₃O)₂—O)ₘ—CH₃ (m is 3 to 5, average of 4), 4.8 ml of water, 75 ml of dehydrated methanol, and 0.05 ml of dibutyltin dilaurate were mixed, and this was left for 2 days at 25° C.

(1) Molds were filled with Nd₂Fe₁₄B magnetic powder which had had phosphatization film formation treatment as described above. Under a pressure of 16 t/cm², a test piece of 10 mm length, 10 mm width, 5 mm thickness which will be used for measuring the magnetic characteristics and a compression molded test piece of 15 mm length, 10 mm width, 2 mm thickness which will be used to measure strength were produced.

(2) The compression molded test pieces produced in (1) described above were placed in a vat so that the pressurizing direction was horizontal. The SiO₂ precursor solution, which is the binding agent and which had been left for 2 days at a temperature of 25° C., was poured into the vat at a rate of liquid surface rising vertically of 1 mm/min until reaching to 5 mm above the upper face of the compression molded test piece.

(3) The compression molded test piece used in the above (2) was positioned, and the vat filled with the SiO₂ precursor solution was set inside a vacuum chamber. The air was exhausted slowly to approximately 80 Pa. The vat was left standing until few bubbles were generated from the surface of the compression molded test piece.

(4) The internal pressure of the vacuum chamber, in which the vat containing the compression molded test piece and filled with the SiO₂ precursor solution was set, was raised gradually to atmospheric pressure. The compression molded test piece was removed from the SiO₂ precursor solution.

(5) The compression molded test piece which was infiltrated with SiO₂ precursor solution as produced in (4) described above was set inside a vacuum drying oven, and vacuum heating of the compression molded test piece was conducted under the conditions of a pressure of 1 Pa to 3 Pa and a temperature of 150° C.

(6) The specific resistance of the compression molded test piece of 10 mm length, 10 mm width, 5 mm thickness that was produced in (5) described above was measured by the 4 probe method.

(7) Further, a pulse magnetic field of 30 kOe or greater was applied to the compression molded test piece which was subjected to the specific resistance measurement as described above, and the magnetic characteristic of the compression molded test piece was investigated.

(8) Using the compression molded test piece of 15 mm length, 10 mm width, 2 mm thickness produced in (5) described above, a mechanical bending test was implemented. For the bending test, samples of the compression molded body with a form of 15 mm×10 mm×2 mm was used to evaluate the flexural strength by a 3 point flex test with a point distance of 12 mm.

With regard to the magnetic characteristic of the compression molded test piece of 10 mm length, 10 mm width, 5 mm thickness produced in (5), the residual magnetic flux density was improved 20% to 30% when compared to the resin containing bond magnet (Comparative Example 1). When the demagnetization curve was prepared based on measurement at 20° C., the values of the residual magnetic flux density and coercivity were approximately the same between the molded products before and after SiO₂ infiltration and heat treatment. In addition, the heat demagnetization rate after 1 hour at 200° C. under atmosphere was 3.0% for the SiO₂ infiltrated bond magnet, which was lower than that of the bond magnet without SiO₂ infiltration (5%). Furthermore, after 1 hour at 200° C. in atmosphere, the irreversible heat demagnetization rate was 1% or less for the SiO₂ infiltration heat-treated magnet and this was less than the nearly 3% for the magnet without SiO₂ infiltration. This is because the SiO₂ prevents deterioration from oxidation of the magnetic powder.

The flexural strength of the compression molded test piece of 15 mm length, 10 mm width, 2 mm thickness produced in (7) described above was 2 MPa or less prior to SiO₂ infiltration. However, after SiO₂ infiltration and heat treatment, a molded magnetic product having a flexural strength of 90 MPa or greater could be produced.

Furthermore, the magnet of the present invention has a specific resistance value that is approximately 100 times or greater compared to that of sintered rare-earth magnets. Even compared with the compression-type rare-earth bond magnet, similar values were achieved. Therefore, the characteristics are favorable with minimal eddy current loss.

As seen from the results of the present example, with the present invention, in which a low viscosity SiO₂ precursor is infiltrated into a rare-earth molded magnet product which is produced without resin and by a cold molding method, magnetic characteristics of the rare-earth bond magnet were improved 20% to 30%, flexural strength was approximately tripled, and the irreversible heat demagnetization rate was reduced to half or less as compared with the standard resin containing rare-earth bond magnet, and a magnet which was much more reliable could be produced.

### EXAMPLE 12

In the present example, as in Example 1, a magnetic powder prepared by grinding a thin ribbon of NdFeB was used for the rare-earth magnetic powder.

The treatment solution which forms the phosphatization film was produced as described below.

Twenty grams (20 g) of phosphoric acid, 4 g of boric acid, 4 g of MgO as the metal oxide were dissolved in 1 liter of water. For the surfactant, EF-104 (manufactured by Tohkem Products Co., Ltd.) was added to achieve 0.1 wt %. As an antirust agent, benzotriazole (BT) was added to achieve a concentration of 0.04 mol/l.

The formation of a phosphatization film on the magnetic powder of Nd₂Fe₁₄B was implemented by the following process.

(1) For 100 g of magnetic powder which was obtained by grinding an NdFeB thin ribbon, 2.5 to 30 ml of phosphatization solution was added. This was mixed until all of the magnetic powder for the rare-earth magnet was confirmed to be wet.

(2) Heat treatment of the magnetic powder for the rare-earth magnet which has had phosphatization film formation treatment according to (1) was conducted at 180° C. for 30 minutes under a reduced pressure of 2 torr to 5 torr.

For the SiO₂ precursor which is the binding agent, 25 ml of CH₃O—(Si(CH₃O)₂—O)ₘ—CH₃ (m is 3 to 5, average of 4), 4.8 ml of water, 75 ml of dehydrated methanol, and 0.05 ml of dibutyltin dilaurate were mixed, and this was left for 2 days at 25° C.

(1) Molds were filled with Nd₂Fe₁₄B magnetic powder which had had phosphatization film formation treatment as described above. Under pressure of 16 t/cm², a test piece of 10 mm length, 10 mm width, 5 mm thickness which will be used for measuring the magnetic characteristics and a compression molded test piece of 15 mm length, 10 mm width, 2 mm thickness which will be used to measure strength were produced.

(2) The compression molded test pieces produced in (1) described above were placed in a vat so that the pressurizing direction was horizontal. The SiO₂ precursor solution, which is the binding agent and which had been left for 2 days at a temperature of 25° C., was poured into the vat at a rate of liquid surface rising vertically of 1 mm/min until reaching 5 mm above the upper face of the compression molded test piece.

(3) The compression molded test piece used in the above (2) was positioned, and the vat filled with the SiO₂ precursor solution was set inside a vacuum chamber. The air was exhausted slowly to approximately 80 Pa. The vat was left standing until few bubbles were generated from the surface of the compression molded test piece.

(4) The internal pressure of the vacuum chamber, in which the vat containing the compression molded test piece and filled with the SiO₂ precursor solution was set, was raised gradually to atmospheric pressure. The compression molded test piece was removed from the SiO₂ precursor solution.

(5) The compression molded test piece which was infiltrated with SiO₂ precursor solution as produced in (4) described above was set inside a vacuum drying oven, and vacuum heating of the compression molded test piece was conducted under the conditions of a pressure of 1 Pa to 3 Pa and a temperature of 150° C.

(6) The specific resistance of the compression molded test piece of 10 mm length, 10 mm width, 5 mm thickness that was produced in (5) described above was measured by the 4 probe method.

(7) Further, a pulse magnetic field of 30 kOe or greater was applied to the compression molded test piece which was subjected to the specific resistance measurement as described above, and the magnetic characteristic of the compression molded test piece was investigated.

(8) Using the compression molded test piece of 15 mm length, 10 mm width, 2 mm thickness produced in (5) described above, a mechanical bending test was implemented. For the bending test, samples of the compression molded body with a form of 15 mm×10 mm×2 mm was used to evaluate the flexural strength by a 3 point flex test with a point distance of 12 mm.

With regard to the magnetic characteristic of the compression molded test piece of 10 mm length, 10 mm width, 5 mm thickness produced in (5) described above, the residual magnetic flux density was improved 20% to 30% when compared to the resin containing bond magnet (Comparative Example 1). When the demagnetization curve was prepared based on measurement at 20° C., the values of the residual magnetic flux density and coercivity were approximately the same between the molded products before and after SiO₂ infiltration and heat treatment. In addition, the heat demagnetization rate after 1 hour at 200° C. under atmosphere was 3.0% for the SiO₂ infiltrated bond magnet, which was lower than that of the bond magnet without SiO₂ infiltration (5%). Furthermore, after 1 hour at 200° C. in atmosphere, the irreversible heat demagnetization rate was 1% or less for the SiO₂ infiltration heat-treated magnet which was less than the nearly 3% for the magnet without SiO₂ infiltration. This is because the SiO₂ prevents deterioration from oxidation of the magnetic powder.

The flexural strength of the compression molded test piece of 15 mm length, 10 mm width, 2 mm thickness produced in (7) described above was 2 MPa or less prior to SiO₂ infiltration. However, after SiO₂ infiltration and heat treatment, a molded magnetic product having a flexural strength of 100 MPa or greater could be produced.

Furthermore, the magnet of the present invention has a specific resistance value that is approximately 100 times or greater compared to that of sintered rare-earth magnets. Even compared with the compression-type rare-earth bond magnet, similar values were achieved. Therefore, the characteristics are favorable with minimal eddy current loss.

As seen from the results of the present example, with the present invention, in which a low Viscosity SiO₂ precursor is infiltrated into a rare-earth molded magnet product which is produced without resin and by a cold molding method, magnetic characteristics of the rare-earth bond magnet were improved 20% to 30%, flexural strength was approximately tripled, and the irreversible heat demagnetization rate was reduced to half or less as compared with the standard resin containing rare-earth bond magnet, and a magnet which was much more reliable could be produced.

### COMPARATIVE EXAMPLE 1

In the present comparative example, as in Example 1, a magnetic powder prepared by grinding a thin ribbon of NdFeB was used for the rare-earth magnetic powder.

(1) Solid epoxy resin (EPX 6136 by Somar Co.) with a size of 100 micrometers or less was mixed at 0% to 20% by volume with the rare-earth magnetic powder using a V mixer.

(2) Dies were filled with the compound of rare-earth magnetic powder and resin as produced in (1) described above. In an inert gas atmosphere and a molding pressure of 16 t/cm², heat compression molding was conducted at 80° C. The magnets that were produced were of sizes 10 mm length, 10 mm width, 5 mm thickness which will be used for measuring the magnetic characteristics and 15 mm length, 10 mm width, 2 mm thickness which will be used to measure strength.

(3) The setting of the resin of the bond magnet produced in (2) described above was conducted in a nitrogen atmosphere at 170° C. for 1 hour.

(4) The specific resistance of the compression molded test piece of 10 mm length, 10 mm width, 5 mm thickness that was produced in (3) described above was measured by the 4 probe method.

(5) Further, a pulse magnetic field of 30 kOe or greater was applied to the compression molded test piece which was subjected to the specific resistance measurement as described above, and the magnetic characteristic of the compression molded test piece was investigated.

(6) Using the compression molded test piece of 15 mm length, 10 mm width, 2 mm thickness produced in (3) described above, a mechanical bending test was implemented. For the bending test, samples of the compression molded body with a form of 15 mm×10 mm×0.2 mm was used to evaluate the flexural strength by a 3 point flex test with a point distance of 12 mm.

The magnetic characteristic of the compression molded test piece of 10 mm length, 10 mm width, 5 mm thickness produced in (4) described above was investigated. As the epoxy resin content in the magnet increased, the residual magnetic flux density of the magnet decreased. When compared with the bond magnet produced by SiO₂ binding agent infiltration (Examples 1 to 5), with magnets with a flexure strength of 50 MPa or greater, the epoxy resin containing bond magnets had a magnetic flux density which was lower by 20% to 30%. In addition, the heat demagnetization rate after 1 hour at 200° C. under atmosphere was 5% for the epoxy resin containing bond magnet, and this was higher than the SiO₂ infiltrated bond magnet which was 3.0%. Furthermore, after 1 hour at 200° C. in atmosphere and then remagnetizing after returning to room temperature, the irreversible heat demagnetization rate was less than 1% for the infiltration heat-treated magnet (Examples 1 to 5), and in contrast, the epoxy resin containing bond magnet (Comparative Example 1) was large at a value of almost 3%. Not only the irreversible heat demagnetization rate was suppressed, but even with PCT tests and saline atomization tests, the epoxy resin containing bond magnet was at a lower level compared to SiO₂ infiltrated bond magnets.

Furthermore, the compression molded test piece of 10 mm length, 10 mm width, 5 mm thickness described in (4) described above was maintained in atmosphere at 225° C. for 1 hour, and after cooling to 20° C., demagnetization was performed and the demagnetization curve was prepared. The magnetic field was applied in the direction of the 10 mm direction. After an initial magnetization with a magnetic field of +20 kOe, a magnetic field of ±1 kOe to ±10 kOe was applied with alternating plus and minus, and magnetic flux density at each applied magnetic field was measured to prepare demagnetization curves. The results are shown in FIG. 27. In FIG. 27, the demagnetization curves for the magnet infiltrated with SiO₂ under conditions of (2) of Example 1 and a compression molded bond magnet containing a 15 vol % of epoxy resin as a binding agent as in the present comparative example are compared. In FIG. 27, the horizontal axis is the magnetic field that is applied and the vertical axis is the magnetic flux density. The magnetic flux of the magnet infiltrated with SiO₂ binding agent decreased dramatically when a magnetic field more negative than −8 kOe was applied. With the compression molded bond magnet, there was a dramatic reduction in magnetic flux at a magnetic field with an absolute value that was smaller than that of the infiltration magnet, and it showed a dramatic decrease of magnetic flux at a magnetic field that was more negative than −5 kOe. The residual magnetic flux density after applying a magnetic field of −10 kOe was 0.44 for the infiltration heat-treated magnet, 0.11 T for the compression molded bond magnet. The infiltration heat-treated magnet had a residual magnetic flux density of 4 times the value of the compression molded bond magnet. With the compression molded bond magnet, during heating to 225° C., the surface of each NdFeB powder or the crack surface of the NdFeB powder was oxidized, and magnetic anisotropy of the NdFeB crystals which construct each NdFeB powder was reduced. As a result, the coercivity was reduced, and with the application of a negative magnetic field, the magnetization was readily reversed. In contrast, it is considered that, with the infiltrated magnet, the NdFeB powder and the crack surfaces are covered with a SiO₂ film, and as a result, oxidation during heating in atmosphere is prevented, and there is less reduction in the coercivity.

The flexure strength of the compression molded test piece of 15 mm length, 10 mm width, 2 mm thickness that was produced in (7) described above increased when the epoxy resin content of the binding agent increased, and at a volume content of 20 vol %, the flexure strength of the magnet became 48 MPa. The necessary flexure strength for a bonded magnet is achieved.

When comparing the level of specific resistance of the SiO₂ infiltrated bond magnet and the epoxy resin containing bond magnet, they were the same.

As seen from the results of the present comparative example, compared with the rare-earth bond magnet of the present invention in which a low viscosity SiO₂ precursor is infiltrated into a rare-earth molded magnet product which is produced without resin and by a cold molding method, the epoxy resin containing rare-earth bond magnet had magnetic characteristics that were 20% to 30% lower. It was found that the irreversible heat demagnetizing rate and the reliability of the magnet was low.

In the present comparative example, the volume ratios of the resin (the volume ratio of the resin in the resin and rare-earth magnetic powder) were changed, and the bond magnets containing epoxy resin were evaluated. These results are summarized in Table 5.

TABLE 5
Various characteristics of bond magnet using epoxy resin

| | | Volume | | | Residual | | Irreversible |
|---|---|---|---|---|---|---|---|
| | | ratio | | | Magnetic | | heat |
| | Epoxy | of | Flexural | Specific | flux | | demagnetization |
| | resin | resin | strength | resistance | density | Coercivity | rate |
| Binging agent | material | (vol %) | (MPa) | (Ωcm) | (kG) | (kOe) | (%) |
| Comparative | — | 0 | 1.8 | 0.0015 | 6.9 | 12.2 | 3.5 |
| Example 1-1) | | | | | | | |
| Comparative | EPX6136 | 5 | 5.1 | 0.0016 | 6.3 | 11.9 | 2.9 |
| Example 1-2) | | | | | | | |
| Comparative | EPX6136 | 10 | 12 | 0.0018 | 6.1 | 11.8 | 2.8 |
| Example 1-3) | | | | | | | |
| Comparative | EPX6136 | 15 | 29 | 0.0022 | 5.7 | 11.7 | 2.6 |
| Example 1-4) | | | | | | | |
| Comparative | EPX6136 | 20 | 49 | 0.0031 | 5.4 | 11.7 | 2.5 |
| Example 1-5) | | | | | | | |

### COMPARATIVE EXAMPLE 2

In the present comparative example, as in Example 1, a magnetic powder prepared by grinding a thin ribbon of NdFeB was used for the rare-earth magnetic powder.

The binding agent, SiO₂ precursor, was prepared by mixing 1 ml of CH₃O—(Si(CH₃O)₂—O)ₘ—CH₃ (m is 3 to 5, average 4), 0.19 ml of water, 99 ml of dehydrated methanol and 0.05 ml of dibutyltin dilaurate and left standing at 25° C. for 2 days, and the resulting SiO₂ precursor solution was used.

Viscosity of the SiO₂ precursor solution described above was measured using an Ostwald viscometer at a temperature of 30° C.

(1) Compression molded test pieces of 10 mm length, 10 mm width and 5 mm thickness for magnetic characteristic measurement and of 15 mm length, 10 mm width and 2 mm thickness for strength measurement were produced by filling molds with the Nd₂Fe₁₄B described above and applying pressure at 16 t/cm².

(2) The compression molded test pieces produced in (1) described above were disposed in a vat so that the direction of pressure application was horizontal, and the binding agent, SiO₂ precursor solution described above was poured into the vat at a rate of liquid surface rising vertically 1 mm/min until reaching 5 mm above the upper face of the compression molded test piece.

(3) The vat containing the compression molded test piece used in (2) described above and filled with the SiO₂ precursor solution was set in a vacuum chamber, and the air was exhausted slowly to about 80 Pa. The vat was left standing until few bubbles were generated from the surface of the compression molded test piece.

(4) Internal pressure of the vacuum chamber, in which the vat containing the compression molded test piece and filled with the SiO₂ precursor solution was set, was slowly returned to atmosphere, and the compression molded test piece was taken out of the SiO₂ precursor solution.

(5) The compression molded test piece that was infiltrated with the SiO₂ precursor solution prepared in (4) described above was set in a vacuum drying oven and treated under the condition of the pressure 1 Pa to 3 Pa and temperature of 150° C.

(6) The specific resistance of the compression molded test piece of 10 mm length, 10 mm width and 5 mm thickness that was produced in (5) described above was measured by the 4 probe method.

(7) Further, a pulse magnetic field of 30 kOe or above was applied to the compression molded test piece which was subjected to the specific resistance measurement as described above, and the magnetic characteristic of the compression molded test piece was investigated.

(8) A mechanical bending test was conducted using a compression molded test piece of 15 mm length, 10 mm width and 2 mm thickness that was produced in (5) described above. A sample of the compression molded piece with a form of 15 mm×10 mm×2 mm was subjected to bending tests to evaluate flexural strength by 3 point bending tests with 12 mm distance between the points.

With regard to the magnetic characteristic of the compression molded test piece of 10 mm length, 10 mm width, 5 mm thickness produced in (5) described above, the residual magnetic flux density was improved 20% to 30% when compared to the resin containing bond magnet (Comparative Example 1). When the demagnetization curve was prepared based on measurement at 20° C., the values of the residual magnetic flux density and coercivity were approximately the same between the molded products before and after SiO₂ infiltration and heat treatment. In addition, the heat demagnetization rate after 1 hour at 200° C. under atmosphere was 3.0% for the SiO₂ infiltrated bond magnet, which was lower than that of the bond magnet without SiO₂ infiltration (5%). Furthermore, after 1 hour at 200° C. in atmosphere and then remagnetizing after returning to room temperature, the irreversible heat demagnetization rate was less than 1% for the SiO₂ infiltration heat-treated magnet and nearly 3% for the epoxy magnet (Comparative Example 1).

However, the flexural strength of the compression molded test piece of 15 mm length, 10 mm width, 2 mm thickness produced in (7) described above was low. The SiO₂ infiltrated bond magnet of the present comparative example only had about 1/10 of the value of flexural strength compared with that of the bond magnet containing epoxy resin. This is because, in the present comparative example, the SiO₂ precursor content in the binding agent is 1 vol % and it is 1 or 2 digits less as compared with the SiO₂ precursor content in the binding agent of the examples. As a result, even though the flexural strength of the SiO₂ elementary substance is large after hardening, the content in the magnet is too low.

In conclusion, the magnet of the present comparative example has the shortcoming that the magnet strength is low.

The various characteristics of the present comparative example as well as 1) and 2) of Comparative Example 3, and Comparative Example 4 which will be described later are summarized in Table 6.

TABLE 6
Characteristics of magnets infiltrated with SiO₂ precursor material

| | Composition of binding agent | | | | | |
|---|---|---|---|---|---|---|
| | | | Silicate | | | Dibutyltin |
| Binding | | Type of | compound | Water | Alcohol | dilaurate |
| agent | SiO₂ Precursor material | alcohol | (ml) | (ml) | (ml) | (ml) |
| Comparative | CH₃O—(Si(CH₃O)₂—O)ₘ—CH₃, | Methanol | 1 | 0.19 | 99 | 0.05 |
| Example 2 | average m is 4 | | | | | |
| Comparative | CH₃O—(Si(CH₃O)₂—O)ₘ—CH₃, | Methanol | 25 | 0.19 | 75 | 0.05 |
| Example 3-1) | average m is 4 | | | | | |
| Comparative | CH₃O—(Si(CH₃O)₂—O)ₘ—CH₃, | Methanol | 25 | 24 | 75 | 0.05 |
| Example 3-2) | average m is 4 | | | | | |
| Comparative | CH₃O—(Si(CH₃O)₂—O)ₘ—CH₃, | Methanol | 25 | 9.6 | 75 | 0.05 |
| Example 4 | average m is 4 | | | | | |

| | | | | Magnetic characteristics of magnet | | |
|---|---|---|---|---|---|---|
| | | | | Residual | | Irreversible |
| | | | | magnetic | | heat |
| | | Flexural | Specific | flux | | demagnetization |
| Binging | Viscosity | strength | resistance | density | Coercivity | rate |
| agent | (mPa · s) | (MPa) | (Ωcm) | (MG) | (kOe) | (%) |
| Comparative | 0.87 | 4.2 | 0.0016 | 6.9 | 12.2 | <1 |
| Example 2 | | | | | | |
| Comparative | 1.9 | 7.8 | 0.0017 | 6.9 | 12.2 | <1 |
| Example 3-1 | | | | | | |
| Comparative | 350 | 170 | 0.0027 | 6.5 | 12.2 | 1.9 |
| Example 3-2) | | | | | | |
| Comparative | 240 | 190 | 0.0032 | 6.6 | 12.2 | 1.6 |
| Example 4 | | | | | | |

### COMPARATIVE EXAMPLE 3

In the present comparative example, as in Example 1, a magnetic powder prepared by grinding a thin ribbon of NdFeB was used for the rare-earth magnetic powder.

The following two solutions were used as the SiO₂ precursor, which is binding agent.

1) The SiO₂ precursor was prepared by mixing 25 ml of CH₃O—(Si(CH₃O)₂—O)ₘ—CH₃ (m is 3 to 5, average 4), 0.19 ml of water, 75 ml of dehydrated methanol and 0.05 ml of dibutyltin dilaurate and left standing at 25° C. for 2 days.

2) The SiO₂ precursor was prepared by mixing 25 ml of CH₃O—(Si(CH₃O)₂—O)ₘ—CH₃ (m is 3 to 5, average 4), 24 ml of water, 75 ml of dehydrated ethanol and 0.05 ml of dibutyltin dilaurate and left standing at 25° C. for 2 days.

Viscosity of the SiO₂ precursor solution of 1) 2) was measured using an Ostwald viscometer at a temperature of 30° C.

(1) Compression molded test pieces of 10 mm length, 10 mm width and 5 mm thickness for magnetic characteristic measurement and of 15 mm length, 10 mm width and 2 mm thickness for strength measurement were produced by filling molds with the Nd₂Fe₁₄B described above and applying pressure at 16 t/cm².

(2) The compression molded test pieces produced in (1) described above were disposed in a vat so that the direction of pressure application was horizontal, and the binding agent, SiO₂ precursor solution 1) and 2) was poured into the vat at a rate of liquid surface rising vertically 1 mm/min until reaching 5 mm above the upper face of the compression molded test piece.

(3) The vat containing the compression molded test piece used in (2) described above and filled with the SiO₂ precursor solution was set in a vacuum chamber, and the air was exhausted slowly to about 80 Pa. The vat was left standing until few bubbles were generated from the surface of the compression molded test piece.

(4) Internal pressure of the vacuum chamber, in which the vat containing the compression molded test piece and filled with the SiO₂ precursor solution was set, was slowly returned to atmosphere, and the compression molded test piece was taken out of the SiO₂ precursor solution.

(5) The compression molded test piece that was infiltrated with the SiO₂ precursor solution prepared in (4) described above was set in a vacuum drying oven and treated under the condition of the pressure 1 Pa to 3 Pa and temperature of 150° C.

(6) The specific resistance of the compression molded test piece of 10 mm length, 10 mm width and 5 mm thickness that was produced in (5) described above was measured by the 4 probe method.

(7) Further, a pulse magnetic field of 30 kOe or above was applied to the compression molded test piece which was subjected to the specific resistance measurement as described above, and the magnetic characteristic of the compression molded test piece was investigated.

(8) A mechanical bending test was conducted using a compression molded test piece of 15 mm length, 10 mm width and 2 mm thickness produced in (5) described above. A sample of the compression molded piece with a form of 15 mm×10 mm×2 mm was subjected to bending tests to evaluate flexural strength by 3 points bending tests with 12 mm distance between the points.

For the magnetic characteristic of compression molded test piece of 10 mm length, 10 mm width and 5 mm thickness produced in (5) described above (Comparative Example 3)-1)), the residual magnetic flux density can be improved by 20% to 30% when compared to a resin containing bond magnet (Comparative Example 1), and in the demagnetization curve prepared based on measurement at 20° C., the values of residual magnetic flux density and coercivity were almost the same between the molded products before and after SiO₂ infiltration and heat treatment. Also, the rate of heat demagnetization after keeping for 1 hour at 200° C. under the atmosphere was 3.0% in the SiO₂ infiltrated bond magnet, which was lower than that in the bond magnet without SiO₂ infiltration (5%). Further, the irreversible heat demagnetization rate after treating the magnet at 200° C. for 1 hour, cooling to room temperature and then remagnetizing was less than 1% in the infiltration heat-treated magnet, while it was nearly 3% in the epoxy bond magnet (Comparative Example 1).

However, the flexural strength of the compression molded test piece of 15 mm length, 10 mm width and 2 mm thickness produced in (7) described above was low, and the SiO₂ infiltrated bond magnet of the present comparative example had about ⅙ strength compared to the epoxy resin containing bond magnet. Since the amount of water added to the binding agent was small in the present comparative example, hydrolysis of the metonym group in the SiO₂ precursor material, shown in chemical formula 1, did not proceed, the silanol group was not generated, and the dehydration/condensation reaction between silanol groups in thermosetting of the SiO₂ precursor did not take place and thus the amount of generated SiO₂ after thermosetting was small, resulting in low flexural strength of the SiO₂ infiltrated bond magnet.

In conclusion, the magnet of Comparative Example 3)-1) is difficult to use as a magnet due to weak magnetizing power.

For Comparative Example 3)-2), the flexural strength of compression molded test piece of 15 mm length, 10 mm width and 2 mm thickness produced in (7) was 2 MPa or below before SiO₂ infiltration, but it was possible to produce a molded magnet product having a flexural strength of 170 MPa after SiO₂ infiltration heat treatment.

For the magnetic characteristic of the compression molded test piece of 10 mm length, 10 mm width and 5 mm thickness produced in (5), the residual magnetic flux density can be improved by 20% when compared to a resin containing bond magnet (Comparative Example 1), and in the demagnetization curve prepared based on measurement at 20° C., the values of residual magnetic flux density and coercivity were almost the same in the molded products before and after SiO₂ infiltration and heat treatment. However, the rate of heat demagnetization after keeping for 1 hour at 200° C. under the atmosphere was 4.0% in the present comparative example, which was greater than 3.0% of the SiO₂ infiltrated bond magnet of the Example. Further, the irreversible heat demagnetization rate after treating the magnet at 200° C. under the atmosphere for 1 hour, cooling to room temperature and then remagnetizing was less than 1% in the SiO₂ infiltration heat-treated magnet of the Example, while it was nearly 2% in the present comparative example. It was revealed that the SiO₂ precursor solution infiltrated into the magnet only a little more than about 1 mm from the surface of the magnet, and this influenced heat demagnetization. Thus, the magnetic powder in the center of the magnet was deteriorated by oxidation during heating in an atmosphere, causing the magnet of the present comparative example to have a greater irreversible heat demagnetization rate than the magnets of the examples.

This result suggests that the bond magnet of the present comparative example is not inferior to the conventional epoxy bond magnet, but its long term reliability may be lower than the conventional epoxy resin bond magnet.

### COMPARATIVE EXAMPLE 4

In the present comparative example, similarly to Example 1, the magnetic powder prepared by grinding a thin ribbon of NdFeB was used for producing the rare-earth magnet powder.

The binding agent, SiO₂ precursor, was prepared by mixing 25 ml of CH₃O—(Si(CH₃O)₂—O)ₘ—CH₃ (m is 3 to 5, average 4), 9.6 ml of water, 75 ml of dehydrated methanol and 0.05 ml of dibutyltin dilaurate and left standing at 25° C. for 6 days and the resulting SiO₂ precursor solution was used.

Viscosity of the SiO₂ precursor solution described above was measured using an Ostwald viscometer at 30° C.

(1) Molds were filled with the Nd₂Fe₁₄B magnetic powder described above. Under a pressure of 16 t/cm², a test piece of 10 mm length, 10 mm width, 5 mm thickness which will be used for measuring the magnetic characteristics and a compression molded test piece of 15 mm length, 10 mm width, 2 mm thickness which will be used to measure strength were produced.

(2) The compression molded test pieces produced in (1) described above were placed in a vat so that the pressurizing direction was horizontal. The SiO₂ precursor solution, which is the binding agent described above, was poured into the vat at a rate of liquid surface rising vertically 1 mm/min until reaching to 5 mm above the upper face of the compression molded test piece.

(3) The compression molded test piece used in the above (2) was positioned, and the vat filled with the SiO₂ precursor solution was set in a vacuum chamber. The air was exhausted slowly to about 80 Pa. The vat was left standing until few bubbles were generated from the surface of the compression molded test piece.

(4) The internal pressure of the vacuum chamber, in which the vat containing the compression molded test piece and filled with the SiO₂ precursor solution was set, was gradually returned to atmospheric pressure. The compression molded test piece was removed from the SiO₂ precursor solution.

(5) The compression molded test piece which was infiltrated with the SiO₂ precursor solution prepared in (4) described above was set in a vacuum drying oven and vacuum heating of the compression molded test piece was conducted at 1 Pa to 3 Pa of pressure and 150° C.

(6) The specific resistance of the compression molded test piece of 10 mm length, 10 mm width and 5 mm thickness produced in (5) described above was measured by the 4 pin probe method.

(7) Further, a pulse magnetic field of 30 kOe or above was applied to the compression molded test piece which was subjected to the specific resistance measurement as described above, and the magnetic characteristic of the compression molded test piece was investigated.

(8) Using a compression molded test piece of 15 mm length, 10 mm width and 2 mm thickness produced in (5) described above, a mechanical bending test was implemented. For the bending test, a compression molded piece with a form of 15 mm×10 mm×2 mm was used to evaluate flexural strength by a 3 points flex test with a point distance of 12 mm.

The flexural strength of the compression molded test piece of 15 mm length, 10 mm width and 2 mm thickness produced in (7) described above was 2 MPa or below before the infiltration of SiO₂ but it was possible to produce a molded magnet product having a flexural strength of 190 MPa after SiO₂ infiltration heat treatment.

For the magnetic characteristic of the compression molded test piece of 10 mm length, 10 mm width and 5 mm thickness produced in (5) described above, the residual magnetic flux density can be improved by 20% when compared to a resin containing bond magnet (Comparative Example 1), and in the demagnetization curve prepared based on measurement at 20° C., the values of residual magnetic flux density and coercivity were almost the same in the molded products before and after SiO₂ infiltration and heat treatment. However, the rate of heat demagnetization after keeping for 1 hour at 200° C. under the atmosphere was 3.6% in the present comparative example, which is greater than the 3.0% of the SiO₂ infiltrated bond magnet in the Example. Further, the irreversible heat demagnetization rate after treating the magnet at 200° C. for 1 hour, cooling to room temperature and then remagnetizing was less than 1% in the SiO₂ infiltration heat-treated magnet in the Example, while it was 1.6% in the present comparative example. It was revealed that the SiO₂ precursor solution infiltrated into the magnet only a little less than about 2 mm from the surface of the magnet and this influenced heat demagnetization. Thus, magnetic powder in the center of the magnet was deteriorated by oxidation during heating in an atmosphere, causing the magnet of the present comparative example to have greater irreversible heat demagnetization rate than the magnet of the example.

This result suggests that the bond magnet of the present comparative example is not inferior to the conventional epoxy bond magnet, but its long term reliability may be lower than the conventional epoxy bond magnet.

### COMPARATIVE EXAMPLE 5

In the present comparative example, similarly to Example 1, the magnet powder prepared by grinding a thin ribbon of NdFeB was used for producing the rare-earth magnet powder.

A treatment solution for forming a coat film of fluoride of rare-earth metal or alkaline earth metal was prepared as described below.

(1) In the cases of highly water soluble salts, for example, Nd, 4 g of Nd acetate or Nd nitrate was placed in 100 ml of water and dissolved completely using a shaker or an ultrasonic mixer.

(2) Hydrofluoric acid diluted to 10% was slowly added up to an equivalent amount of the chemical reaction generating NdF₃.

(3) The solution, in which gel-like precipitates of NdF₃ were formed, was stirred using an ultrasonic mixer for 1 hour or longer.

(4) After centrifugation at 4,000 to 6,000 rpm, the supernatant was removed. Then, approximately the same volume of methanol was added.

(5) After stirring the methanol solution containing gel-like NdF₃ to prepare homogeneous suspension, the suspension was further stirred for 1 hour or longer using an ultrasonic mixer.

(6) The operations of (4) and (5) described above were repeated 3 to 10 times until anion such as acetate ion or nitrate ion was no longer detected.

(7) Finally, almost transparent sol-like NdF₃ was obtained in the case of NdF₃. For the treatment solution, NdF₃ was dissolved in methanol at 1 g/5 ml.

The following method was used to carry out the process for forming the aforementioned magnetic powder of Nd₂Fe₁₄B coated by rare-earth fluoride or alkaline earth metal fluoride film.

The case of NdF₃ coat film forming process: NdF₃ concentration 1 g/10 ml, semitransparent sol-like solution.

(1) Fifteen ml of NdF₃ coat film forming solution was added to 100 g of the magnetic powder prepared by grinding a thin ribbon of NdFeB and mixed until wetness of all the magnetic powder for rare-earth magnet was confirmed.

(2) Solvent methanol was removed from the magnetic powder for rare-earth magnet, which underwent the NdF₃ coat film forming treatment as described in (1) under reduced pressure of 2 torr to 5 torr.

(3) The magnetic powder for rare-earth magnet that underwent solvent removal as described in (2) was transferred to a quartz boat, and heated at 200° C. for 30 minutes and at 400° C. for 30 minutes under reduced pressure of 1×10⁻⁵ torr.

(4) The magnetic powder that underwent heat treatment as described in (3) was transferred to a container with a rid made of Macor (Riken Denshi Co., Ltd.) and then heated at 700° C. for 30 minutes under reduced pressure of 1×10⁻⁵ torr.

(5) The magnetic powder of Nd₂Fe₁₄B that was coated with a film of rare-earth fluoride or alkaline earth metal fluoride was placed in molds, and a test piece for measuring the magnetic characteristic with a dimension of 10 mm length, 10 mm width and 5 mm thickness and a compression molded test piece for measuring the strength with a dimension of 15 mm length, 10 mm width and 2 mm thickness were produced under the pressure of 16 t/cm².

(6) The specific resistance of the compression molded test piece of 10 length, 10 mm width and 5 mm thickness produced in (5) described above was measured by the 4 pin probe method.

(7) Further, a pulse magnetic field of 30 kOe or greater was applied to the compression molded test piece which was subjected to the specific resistance measurement as described above, and the magnetic characteristic of the compression molded test piece was investigated.

(8) Using a compression molded test piece of 15 mm length, 10 mm width and 2 mm thickness produced in (5) described above, a mechanical bending test was implemented. For the bending test, samples of the compression molded body with a form of 15 mm×10 mm×2 mm was used to evaluate flexural strength by a 3 points flex test with a point distance of 12 mm.

For the magnetic characteristic of the compression molded test piece of 10 mm length, 10 mm width and 5 mm thickness produced in (5) described above, the residual magnetic flux density can be improved by about 20% when compared to a resin containing bond magnet (Comparative Example 1), and in the demagnetization curve prepared based on measurement at 20° C., the values of residual magnetic flux density and coercivity were almost the same in the molded products before and after SiO₂ infiltration and heat treatment. Also, the rate of heat demagnetization after keeping for 1 hour at 200° C. under the atmosphere was 3.0% in the present comparative example, which is almost the same as 3.0% of the SiO₂ infiltrated bond magnet in the Example. Further, the irreversible heat demagnetization rate after treating the magnet at 200° C. for 1 hour, cooling to room temperature and then remagnetizing was less than 1% in the SiO₂ infiltration heat-treated magnet in the Example, while it was less than 1% in the present comparative example. The results are shown in Table 7.

TABLE 7
Characteristics of materials molded from magnetic powder single body
treated with various coat film

| | | | | Residual | | Irreversible |
|---|---|---|---|---|---|---|
| | | | | Magnetic | | heat |
| | | Flexural | Specific | flux | | demagnetization |
| Binging | Type of coat | strength | resistance | density | Coercivity | rate |
| agent | film | (MPa) | (Ωcm) | (kG) | (kOe) | (%) |
| Comparative | NdF₃ coat film | 2.9 | 0.015 | 6.6 | 12.2 | <1 |
| Example 5 | | | | | | |
| Comparative | EPX6136 | 2.4 | 0.016 | 6.8 | 12.1 | 1.2 |
| Example 6 | | | | | | |

However, the flexural strength of the compression molded test piece of 15 mm length, 10 mm width and 2 mm thickness produced in (7) was a low value of 2.9 MPa because in the present comparative example SiO₂ infiltration was not conducted. It was about 1/15 compared to that of the epoxy bond magnet.

This result indicates that the bond magnet of the present comparative example lacks mechanical strength compared to conventional epoxy bond magnets, and therefore care is needed in this point when the magnet is used powder.

### COMPARATIVE EXAMPLE 6

In the present comparative example, similarly to Example 1, the magnetic powder prepared by grinding a thin ribbon of NdFeB was used for producing the rare-earth magnet powder.

The treatment solution which forms a phosphatization film was produced as described below.

Twenty grams (20 g) of phosphoric acid, 4 g of boric acid and 4 g of MgO as the metal oxide were dissolved in 1 liter of water. For the surfactant, EF-104 (Tohkem Products Co., Ltd.) was added to achieve 0.1 wt %. As an antirust agent, benzotriazole (BT) was used. This was added to achieve a concentration of 0.04 mol/l.

The formation of a phosphatization film on the magnetic powder of Nd₂Fe₁₄B was implemented by the following process. The composition of the phosphatization solution used is shown in Table 4 above.

(1) For 100 g of magnetic powder which was obtained by grinding a thin ribbon of NdFeB, 5 ml of phosphatization solution was added. This was mixed until all of the magnetic powder for the rare-earth magnet was confirmed to be wet.

(2) Heat treatment of the magnetic powder for the rare-earth magnet which has had phosphatization film formation treatment according to (1) was conducted at 180° C. for 30 minutes under a reduced pressure of 2 torr to 5 torr.

(3) The magnetic powder of Nd₂Fe₁₄B that was treated with the phosphatization process for forming film was placed in molds, and a test piece for measuring the magnetic characteristic with a dimension of 10 mm length, 10 mm width and 5 mm thickness and a compression molded test piece for measuring the strength with a dimension of 15 mm length, 10 mm width and 2 mm thickness were produced under the pressure of 16 t/cm².

(4) The specific resistance of the compression molded test piece of 10 mm length, 10 mm width and 5 mm thickness produced in (3) described above was measured by the 4 pin probe method.

(5) Further, a pulse magnetic field of 30 kOe or above was applied to the compression molded test piece which was subjected to the specific resistance measurement as described above, and the magnetic characteristic of the compression molded test piece was investigated.

(6) A mechanical bending test was conducted using a compression molded test piece of 15 mm length, 10 mm width and 2 mm thickness produced in (3) described above. A sample of the compression molded piece with a form of 15 mm×10 mm×2 mm was subjected to bending tests to evaluate flexural strength by 3 points bending tests with 12 mm distance between the points.

For the magnetic characteristic of the compression molded test piece of 10 mm length, 10 mm width and 5 mm thickness produced in (3), the residual magnetic flux density can be improved by about 25% when compared to a resin containing bond magnet (Comparative Example 1), and in the demagnetization curve prepared based on measurement at 20° C., the values of residual magnetic flux density and coercivity were almost the same in the molded products before and after SiO₂ infiltration and heat treatment. Also, the rate of heat demagnetization after keeping for 1 hour at 200° C. under the atmosphere was 3.1% in the present comparative example, which is almost the same as 3.0% of the SiO₂ infiltrated bond magnet in the Example. Further, the irreversible heat demagnetization rate after treating the magnet at 200° C. for 1 hour, cooling to room temperature and then remagnetizing was less than 1% in the SiO₂ infiltration heat-treated magnet of the Example, while it was 1.2% in the present comparative example, which was a little increase but there was no big difference (see Table 7 above).

However, the flexural strength of the compression molded test piece of 15 mm length, 10 mm width and 2 mm thickness produced in (5) described above was a low value of 2.9 MPa because in the present comparative example the SiO₂ infiltration was not conducted. It was about 1/20 compared to that of the epoxy bond magnet.

This result indicates that the bond magnet of the present comparative example lacks mechanical strength compared to conventional epoxy bond magnets, and therefore care is needed in this point when the magnet is used.

The present invention is described by the Examples described as above, the magnet according to the present invention has following effects.

1) The capability as a magnet is superior to the conventional resin magnets.

2) In addition to the superior characteristic, it has strength as a magnet. A magnet that is superior in characteristics and in strength not available with the resin magnets is obtained.

The effects of 1) and 2) above can be achieved, for example, as described below.

The binding agent solution must infiltrate into 1 μm or smaller gaps between magnetic powder particles which are formed in compression molding of magnetic powder without resin. To achieve this objective, it is required that the viscosity of the binding agent solution is 100 mPas or lower, and the wettability of the magnetic powder with the binding agent solution is high. In addition, it is important that adhesiveness between the binding agent and the magnetic powder is high after setting, that mechanical strength of the binding agent is high and that the binding agent is formed continuously.

For the viscosity of the binding agent solution, it depends upon the size of the magnet. However, when the thickness of a compression molded piece is 5 mm or less and gaps between the magnetic powder particles are about 1 μm, the binding agent solution having a viscosity of about 100 mPas can be introduced into the gaps between the magnetic powder particles in the central part of the compression molded piece. When the thickness of the compression molded piece is 5 mm or more and gaps between the magnetic powder particles are about 1 μm, for example, in a compression molded piece with about 30 mm thickness, 100 mPas viscosity of the binding agent solution is too high to introduce the binding agent solution to the central part of the compression molded piece, and the viscosity of the binding agent solution needs to be 20 mPas or lower, preferably 10 mPas or lower. This viscosity is lower than that of normal resin by one order or more. To achieve this viscosity, it is necessary to control the amount of hydrolysis of the alkoxyl group in alkoxysiloxane that is a precursor of SiO₂ and to suppress the molecular weight of alkoxysiloxane. That is, when an alkoxyl group is hydrolyzed, a silanol group is generated. However, the silanol group has a tendency of undergoing a dehydration condensation reaction, and the dehydration condensation reaction means higher molecular weight of alkoxysiloxane. Further, since hydrogen bonds are formed between the silanol groups, the viscosity of alkoxysiloxane solution, which is the precursor of SiO₂ increases. In particular, it is necessary to control added amount of water against an equivalent amount of the hydrolysis reaction of alkoxysiloxane and the condition of the hydrolysis reaction. It is preferable to use alcohol as a solvent for the binding agent solution because the dissociation reaction of the alkoxyl group in alkoxysiloxane is fast. Methanol, ethanol, n-propanol and isopropanol are preferably used as a solvent alcohol because the boiling point is lower than that of water and the viscosity is low. However, any solvent, which does not permit the increase in the viscosity of the binding agent solution within a few hours and has a boiling point lower than that of water, can be used for the production of the magnet according to the present invention.

For the adhesiveness between the binding agent and the magnetic powder after setting, if the surface of the magnetic powder is covered by natural oxide film, adhesiveness between the surface of the magnetic powder and SiO₂ is great, because after heat treatment the product of the SiO₂ precursor, which is the binding agent of the present invention, is SiO₂. When a rare-earth magnet, which uses SiO₂ as the binding agent, is subjected to tension fracture, most of the surf ace is covered by the magnetic powder or aggregated fracture face of SiO₂. On the other hand, when a resin was used as a binding agent, the adhesiveness between the resin and the magnetic powder is generally weaker when compared with that between the surface of the magnetic powder and SiO₂. Thus, in a bond magnet using the resin, the surface of the fractured magnet contains both the boundary surface between the resin and the magnetic powder or aggregated fracture face of the resin. Therefore, it is advantageous to use SiO₂ as the binding agent to improve the strength of the magnet than to use the resin as the binding agent.

When the content of the rare-earth magnetic powder in a magnet is 75 vol % or greater, a compression molded type rare-earth magnet is to be used, and the strength of the rare-earth magnet after setting of the binding agent is greatly influenced by whether the continuous body of the binding agent is generated after setting. This is because the fracture strength per unit area of the binding agent alone is greater than that of the boundary of adhesion surface. When using a resin such as epoxy resin and the ratio of the resin volume in whole solid mass being 15 vol % or less, the resin in the magnet does not form a continuous body after setting but is distributed like islands due to poor wettability of the resin with the rare-earth magnetic powder. On the other hand, since wettability of the SiO₂ precursor with the rare-earth magnetic powder is good as described earlier, the SiO₂ precursor spreads continuously on the surface of the magnetic powder, and the precursor is set by the heat treatment to become SiO₂ while spreading continuously. When the strength of the binding agent after setting as a material is expressed by the flexural strength, SiO₂ has a greater flexural strength than resins by 1 to 3 orders of magnitude. Therefore, the strength of the rare-earth magnet after setting of the binding agent is far greater by using the SiO₂ precursor as the binding agent than using a resin.

Next, materials for magnet will be described which are more suitable for the magnet according to the present invention. The rare-earth magnet powder includes a ferromagnetic main phase and other components. In the case of the rare-earth magnet being Nd—Fe—B magnet, the main phase is Nd₂Fe₁₄B phase. Considering for improving the magnetic characteristic, it is preferable that the rare-earth magnet powder is prepared using the HDDR method and a hot plasticity process. The rare-earth magnet powder includes, apart from NdFeB magnets, Sm—Co magnet. Considering the magnetic characteristics of rare-earth magnets to be obtained and production costs, NdFeB magnets are preferred. However, the rare-earth magnet of the present invention is not limited to the NdFeB magnets. Optionally, the rare-earth magnet may contain 2 or more rare-earth magnet powders as a mixture. That is, 2 or more of NdFeB magnets having different composition ratios may be present and NdFeB magnets and Sm—Co magnets may be present as a mixture.

In the present description, the concept of “NdFeB magnet” includes a form in which a part of Nd or Fe is substituted with other elements. Nd may be substituted with other rare-earth elements such as Dy and Tb. One of these may be used for the substitution or both of them may be used. The substitution can be carried out by controlling the amount of the combination of the material alloy. The coercivity of NdFeB magnets may be improved by such a substitution. The amount of Nd to be substituted is preferably 0.01 atom % or more and 50 atom % or less to Nd. The effect of substitution may possibly be insufficient at less than 0.01 atom %. If it is over 50 atom %, residual magnetic flux density may not be maintained at a high level. Therefore, it is desirable to pay attention to the purpose of the magnet usage.

Fe may be substituted by other transition metals such as Co. Such a substitution can raise the Curie Temperature (Tc) of NdFeB magnets and expand the range of usable temperature. The amount of Fe to be substituted is preferably 0.01 atom % or more and 30 atom % or less to Fe. The effect of substitution may possibly be insufficient at less than 0.01 atom %. If it is over 30 atom %, the coercivity may be lowered greatly. Therefore, it is desirable to pay attention to the purpose of the magnet usage.

The average particle diameter of the rare-earth magnet powder in rare-earth magnets is preferably 1 μm to 500 μm. When the average particle diameter of the rare-earth magnet powder is less than 1 μm, the specific surface area of the magnet powder becomes large, which has a big influence on deterioration from oxidation, and the rare-earth magnet using this powder may possibly demonstrate poor magnetic characteristics. Therefore, it is desirable to pay attention to the usage state of the magnet.

On the other hand, when the average particle diameter of the rare-earth magnet powder is 500 μm or larger, the magnet powder is broken down by the pressure applied in the production process, and it is difficult to obtain sufficient electric resistance. In addition, when anisotropic magnets are produced from anisotropic rare-earth magnet powder, it is difficult to align the orientation of the main phase (Nd₂Fe₁₄B phase in NdFeB magnet) in rare-earth magnet powder along the over 500 μm size. The particle diameter of rare-earth magnet powder may be regulated by controlling the particle diameter of material rare-earth magnet powder for producing magnets. The average particle diameter of the rare-earth magnet powder can be calculated from SEM images.

The present invention can be applied to any of the isotropic magnets prepared from isotropic magnet powder, isotropic magnets prepared from anisotropic magnet powder by orienting randomly and anisotropic magnets prepared from anisotropic powder by orienting to a fixed direction. When magnets having a high energy product are needed, anisotropic magnets which are prepared from anisotropic magnet powder oriented in magnetic field are preferably used.

Rare-earth magnet powder is produced by mixing materials according to the composition of the rare-earth magnet to be produced. When NdFeB magnets, in which the main phase is the Nd₂Fe₁₄B, are produced, the predetermined amounts of Nd, Fe and B are mixed. Rare-earth magnet powder may be produced by a publicly known method, or commercial products may be used. Such rare-earth magnet powder consists of aggregates of many crystalline particles. It is preferable for improving the coercivity that the average particle diameter of the crystalline particles composing rare-earth magnet powder is below the critical particle diameter of a single magnetic domain. In particular, the average particle diameter of the crystalline particles is preferably 500 nm or below. Here, HDDR method means a method by which the main phase, Nd₂Fe₁₄B compound, is degraded into 3 phases of NdH₃, α-Fe and Fe₂B by hydrogenating NdFeB alloy and then Nd₂Fe₁₄B is regenerated by forceful dehydrogenation. UPSET method is a method by which NdFeB alloy that is produced by the ultra rapid cooling method is ground and temporally molded, and then subjected to hot plasticity process.

When a magnet is used under the condition that it is applied with a high frequency magnetic field containing harmonic components, it is preferable that inorganic insulating film is formed on the surface of rare-earth magnet powder. That is, high specific resistance of the magnet is required to reduce eddy current loss in the magnet. Such inorganic insulating film is preferably a film formed by using a phosphatization process treatment solution containing phosphoric acid, boric acid and magnesium ion as described in JP-A-10-154613, and it is desirable to use a surfactant and antirust agent together to guarantee homogeneity of the film thickness and the magnetic characteristics of the magnet powder. In particular the surfactant preferably includes perfluoroalkyl surfactants, and the antirust agent preferably includes benzotriazole antirust agents.

Further, a fluoride coat film is desirable as the inorganic insulating film that is to improve insulation and magnetic characteristics of the magnetic powder. The treating solution for forming such fluoride coat film is desirably a solution in which fluoride of rare-earth or fluoride of alkaline earth metal is swollen in a solvent, the main component of which is alcohol, and the fluoride of rare-earth or the fluoride of alkaline earth metal is broken down to the average particle diameter of 10 μm or below and dispersed in the solvent containing an alcohol as a main component, forming a sol. To improve the magnetic characteristics, the magnetic powder, on the surface of which the fluoride coat film is formed, is preferably heat treated under the atmosphere of 1×10⁻⁴ Pa or below and at the temperature of 600 to 700° C.

The present invention relates to a magnet in which magnetic materials are bound by a binding agent and a method for producing the same. The magnet according to the present invention is suitable for using as a permanent magnet. The magnet according to the present invention can be applied to fields where conventional magnets are used and is suitable to use, for example, in rotating machines.

By using the present invention, magnetic characteristics can be improved in magnets in which magnetic material is bound by a binding agent. The present invention provides the following.

(1) A rare-earth magnet wherein a rare-earth magnetic powder is bound with SiO₂.

(2) A rare-earth magnet wherein a rare-earth magnetic powder is bound with SiO₂ containing an alkoxyl group.

(3) A rare-earth magnet as described in (1) above, wherein SiO₂ binds a rare-earth magnetic powder with inorganic insulative film formed at a thickness of 10 μm to 10 nm on surfaces thereof.

(4) A rare-earth magnet as described in (2) above, wherein SiO₂ containing an alkoxyl group binds a rare-earth magnetic powder with inorganic insulative film formed at a thickness of 10 μm to 10 nm on surfaces thereof.

(5) A rare-earth magnet as described in (3) or (4) above, wherein the SiO₂ binding agent contains water and at least one SiO₂ precursor selected from a group consisting of alkoxysiloxane, alkoxysilane, hydrolysate thereof, and dehydration condensation products thereof, and is formed with a hydrolyzing catalyst and alcohol if necessary.

(6) A rare-earth magnet as described in (5) above, wherein a neutral catalyst is present as a hydrolyzing catalyst.

(7) A rare-earth magnet as described in (6) above, wherein the neutral catalyst is a stannic catalyst.

(8) A rare-earth magnet as described in (5) above, wherein a total volume fraction of alkoxysiloxane, alkoxysilane, hydrolysates thereof, and dehydration condensation products thereof in the SiO₂ binding agent is at least 5% by volume and no more than 96% by volume.

(9) A rare-earth magnet as described in (5) above, wherein water content in the SiO₂ binding agent is 1/10 to 1 of a hydrolysis reaction equivalent amount relative to a total amount of alkoxysiloxane, alkoxysilane, hydrolysates thereof, and dehydration condensation products precursors alkoxysiloxane and alkoxysilane.

(10) A rare-earth magnet as described in (3) above, wherein the inorganic insulative film is a rare-earth fluoride or alkaline earth metal fluoride coat film, or a phosphatized film.

(11) A rare-earth magnet as described in (10) above, wherein the rare-earth fluoride or alkaline earth metal fluoride coat film contains at least one component selected from a group consisting of Mg, Ca, Sr, Ba, La, Ce, Pr, Sm, Eu, Gd, Tb, Dy, Ho, Er, Tm, Yb, and Lu fluorides.

(12) A rare-earth magnet as described in (10) above, wherein a rare-earth fluoride or an alkaline earth metal fluoride is bloated in a solvent having alcohol as a main component, the rare-earth fluoride or the alkaline earth metal fluoride is crushed from a sol state to a average particle diameter of no more than 10 μm, and is formed using a treatment liquid in which a solvent having alcohol as its main component is mixed.

(13) A rare-earth magnet as described in (12) above, wherein the alcohol is methanol, ethanol, n-propanol, or isopropanol.

(14) A rare-earth magnet as described in (10) above, wherein the phosphatized film contains phosphoric acid, boric acid, and at least one component selected from a group consisting of Mg, Zn, Mn, Cd, Ca, Sr, and Ba.

(15) A rare-earth magnet as described in (10) above, wherein the phosphatized film is formed from an aqueous solution containing phosphoric acid, boric acid, and at least one component selected from a group consisting of Mg, Zn, Mn, Cd, Ca, Sr, and Ba.

(16) A rare-earth magnet as described in (10) above, wherein the phosphatized film is formed from an aqueous solution containing phosphoric acid, boric acid, and at least one component selected from a group consisting of Mg, Zn, Mn, Cd, Ca, Sr, and Ba and also contains a surfactant and an antirust agent.

(17) A rare-earth magnet as described in (16) above, wherein the surfactant is perfluoroalkyl-based, alkylbenzenesulfonic acid based, dipolar ion based, or polyether-based.

(18) A rare-earth magnet as described in (16) above, wherein the antirust agent is an organic compound containing at least one of sulfur and nitrogen with lone-pair electrons.

(19) A rare-earth magnet as described in (18) above, wherein the organic compound antirust agent containing at least one of sulfur and nitrogen with lone-pair electrons is a benzotriazole expressed by Chemical Formula 3 below:

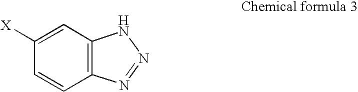

In Chemical Formula 3 above, X is any of H, CH₃, C₂H₅, C₃H₇, NH₂, OH, and COOH.

(20) A method of manufacturing a rare-earth magnet comprising the steps of: pressure molding a rare-earth magnetic powder; infiltrating an SiO₂ binding agent solution to the pressure-molded shaped body of the rare-earth magnetic powder; extracting the pressure-molded shaped body from the SiO₂ binding agent solution; and heating the rare-earth magnetic powder infiltrated with the SiO₂ binding agent solution at a predetermined temperature.

(21) A method of manufacturing a rare-earth magnet comprising the steps of: pressure molding a rare-earth magnetic powder with an inorganic insulative film 10 μm to 10 nm thick formed on surfaces of the rare-earth magnetic powder; infiltrating an SiO₂ binding agent solution to the pressure-molded shaped body of the rare-earth magnetic powder; extracting the pressure-molded shaped body from the SiO₂ binding agent solution; and heating the rare-earth magnetic powder infiltrated with the SiO₂ binding agent solution at a predetermined temperature.

(22) A method of manufacturing a rare-earth magnet as described in (20) or (21) above, wherein the SiO₂ binding agent solution contains water and at least one SiO₂ precursor selected from a group consisting of alkoxysiloxane, alkoxysilane, hydrolysates thereof, and dehydration condensation products thereof, and is formed with a hydrolyzing catalyst and alcohol if necessary.

(23) A method of manufacturing a rare-earth magnet as described in (20) or (21) above, wherein viscosity of the SiO₂ binding agent solution at 30° C. is 0.52 to 100 mPas.

(24) A rare-earth magnet as described in (22) above, wherein a neutral catalyst is present as the hydrolyzing catalyst.

(25) A method for manufacturing a rare-earth magnet as described in (24) above, wherein the neutral catalyst is a stannic catalyst.

(26) A method for manufacturing a rare-earth magnet as described in (22) above, wherein a total volume fraction of alkoxysiloxane, alkoxysilane, hydrolysates thereof, and dehydration condensation products thereof in the SiO₂ binding agent is at least 5% by volume and no more than 96% by volume.

(27) A method for manufacturing a rare-earth magnet as described in (22) above, wherein water content in the SiO₂ binding agent is 1/10 to 1 of a hydrolysis reaction equivalent amount relative to a total amount of alkoxysiloxane, alkoxysilane, hydrolysates thereof, and dehydration condensation products precursors alkoxysiloxane and alkoxysilane.

(28) A method for manufacturing a rare-earth magnet as described in (21) above, wherein the inorganic insulative film is a rare-earth fluoride or alkaline earth metal fluoride coat film, or a phosphatized film.

(29) A method for manufacturing a rare-earth magnet as described in (28) above, wherein the rare-earth fluoride or alkaline earth metal fluoride coat film contains at least one component selected from a group consisting of Mg, Ca, Sr, Ba, La, Ce, Pr, Sm, Eu, Cd, Tb, Dy, Ho, Er, Tm, Yb, and Lu fluoride.

(30) A method for manufacturing a rare-earth magnet as described in (28) above, wherein a rare-earth fluoride or an alkaline earth metal fluoride is bloated in a solvent having alcohol as a main component, the rare-earth fluoride or the alkaline earth metal fluoride is crushed from a sol state to a average particle diameter of no more than 10 μm, and is formed using a treatment liquid in which a solvent having alcohol as its main component is mixed.

(31) A method for manufacturing a rare-earth magnet as described in (30) above, wherein the alcohol is methanol, ethanol, n-propanol, or isopropanol.

(32) A method for manufacturing a rare-earth magnet as described in (28) above, wherein a rare-earth fluoride or an alkaline earth metal fluoride is bloated in a solvent having alcohol as a main component, the solvent having alcohol as a main component having a concentration of 200 g/dm³ to 1 g/dm³, and a coat film with a thickness of 10 μm to 10 nm being formed on surfaces of the rare-earth magnetic powder.

(33) A method for manufacturing rare-earth magnet as described in (28) above, wherein, in the rare-earth fluoride or the alkaline earth metal fluoride, a solution for forming a rare-earth fluoride or an alkaline earth metal fluoride coat film is mixed with a magnetic powder with average particle diameter of 500 μm to 0.1 μm at a proportion of 10 ml to 300 ml to per kg, and then heated at a predetermined temperature.

(34) A method for manufacturing rare-earth magnet as described in (28) above, wherein the phosphatized film is formed from an aqueous solution containing phosphoric acid, boric acid, and at least one component selected from a group consisting of Mg, Zn, Mn, Cd, Ca, Sr, and Ba.

(35) A method for manufacturing rare-earth magnet as described in (28) above, wherein the phosphatized film is formed from an aqueous solution containing phosphoric acid, boric acid, and at least one component selected from a group consisting of Mg, Zn, Mn, Cd, Ca, Sr, and Ba, and also contains a surfactant and an antirust agent.

(36) A method for manufacturing rare-earth magnet as described in (35) above, wherein the surfactant is perfluoroalkyl-based, alkylbenzenesulfonic acid based, dipolar ion based, or polyether-based.

(37) A method for manufacturing rare-earth magnet as described in (35) above, wherein the antirust agent is an organic compound containing at least one of sulfur and nitrogen with lone-pair electrons.

(38) A method for manufacturing rare-earth magnet as described in (37) above, wherein the organic compound antirust agent containing at least one of sulfur and nitrogen with lone-pair electrons is a benzotriazole expressed by Chemical Formula 3:

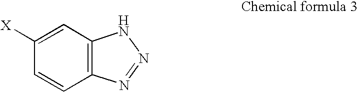

In Chemical Formula 3 above, X is any of H, CH₃, C₂H₅, C₃H₇, NH₂, OH, and COOH.

(39) A method for manufacturing rare-earth magnet as described in (35) above, wherein, in the aqueous solution forming the phosphatized film, there is 0.01 to 1% by weight of the surfactant and 0.01 to 0.5 mol/dm3 of the antirust agent.

(40) A method for manufacturing rare-earth magnet as described in (28) above, wherein, in the phosphatized film, a solution for forming the phosphatized film is mixed with a magnetic powder with average particle diameter of 500 μm to 0.1 μm at a proportion of 25 ml to 300 ml per kg, and then heated at a predetermined temperature.

According to the embodiments described above, a permanent magnet fabricated by molding magnetic particles bound with a SiO-based material is mounted in an electric rotating machine. The precursor of SiO₂ serves a binding agent that has good wettability with the magnet material of the permanent magnet, so that the ratio of the magnetic material in the magnet can be increased. As a result, reduction in magnetic characteristics can be minimized and good characteristics can be maintained with the permanent magnets according to the embodiment of the present invention as compared with the permanent magnet fabricated by using an epoxy resin as the binding agent for binding magnetic particles. Since the permanent magnets according to the embodiments of the present invention are made of materials having low electroconductivity and generating less eddy current, they can suppress generation of eddy current therein particularly when mounted in a motor with a stator of a concentrated winding structure, thus achieving high efficiency, high speed, and high output.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An electric rotating machine comprising:
a stator having a stator core provided with a teeth unit and a coil wound around each tooth in the teeth unit in a concentrated fashion; and
a rotor rotatably supported with air gap against the teeth unit of the stator, the rotor having a rotor core and a plurality of permanent magnets held by the rotor core,
wherein the permanent magnet is a rare earth magnet made of rare earth magnetic particles bound with SiO₂.

2. An electric rotating machine according to claim 1, wherein the rare earth magnet is made of rare earth magnetic particles bound with SiO₂ containing an alkoxyl group.

3. An electric rotating machine according to claim 1, wherein
the permanent magnet is embedded in the rotor core.

4. An electric rotating machine according to claim 1, wherein
the permanent magnet includes a plurality of permanent magnets any adjacent two of which arranged in the circumferential direction have reversed magnetization directions one from another.

5. An electric rotating machine according to claim 1, wherein
the stator core is constituted by a plurality of divided cores.

6. An electric rotating machine according to claim 1, wherein
the stator core is constituted by an assembly of T-shaped divided cores arranged in the form of an annulus.

7. An electric rotating machine according to claim 1, wherein
the coil has a square cross-section.

8. An electric rotating machine according to claim 1, wherein
the coil is wound around a bobbin provided in the teeth unit and the bobbin is divided into two parts that sandwich the coil therebetween.

9. An electric rotating machine according to claim 1, wherein
the stator core includes an integral annular core back and a plurality of linear teeth fitted in the core back.

10. An electric rotating machine according to claim 1, wherein
the permanent magnet is hog-backed and held on the surface of the rotor core.

11. An electric rotating machine according to claim 1, wherein
the rotor has in a space inside thereof a built-in transmission that decelerates a rotation speed of the rotor.

12. An electric rotating machine according to claim 11, wherein
the permanent magnet has sixteen poles.

13. An automobile comprising:
an engine;
an electric rotating machine having a stator and a rotor with a permanent magnet;
a transmission that transmits rotating torque to an axle at a predetermined change gear ratio based on the engine and the electric rotating machine;
a battery connected to the rotting electrical machine; and
a power conversion system that converts power from the battery and transmits the converted power to the electric rotating machine,
wherein the permanent magnet in the rotor is a rare earth magnet made of rare earth magnetic particles bound with SiO₂, and
wherein the stator in the electric rotating machine has a stator core provided with a teeth unit and a coil wound around each tooth in the teeth unit in a concentrated fashion.

14. An automobile according to claim 13, wherein
an axis of the electric rotating machine provided with the rare earth permanent magnet is arranged in the same direction as the direction of the axle of the automobile.
